(19) United States
(12) Patent Application Publication
(10) Pub. No.: US 2015/0025917 A1
(43) Pub. Date: Jan. 22, 2015

(54) System and method for determining an underwriting risk, risk score, or price of insurance using cognitive information

(71) Applicant: Jeffrey Stempora, Erie, PA (US)

(72) Inventor: Jeffrey Stempora, Erie, PA (US)

(73) Assignee: ADVANCED INSURANCE PRODUCTS & SERVICES, INC., Erie, PA (US)

(21) Appl. No.: 14/463,326

(22) Filed: Aug. 19, 2014

Related U.S. Application Data
(63) Continuation-in-part of application No. 14/224,248, filed on Mar. 25, 2014.
Application No. 14/224,248 is a continuation-in-part of application No. 14/182,002, filed on Feb. 17, 2014.
(60) Provisional application No. 61/846,521, filed on Jul. 15, 2013.
(60) Provisional application No. 61/914,125, filed on Dec. 10, 2013.

(51) Int. Cl. G06Q 40/08

(52) U.S. Cl. CPC G06Q 40/08
USPC 705/4

(57) ABSTRACT

In one embodiment a system for determining a level of risk associated with an individual for underwriting purposes comprises at least one sensor that provides information, such as a camera providing one or more images or video for example, used to determine one or more properties of the individual. The individual information, such as eye related information, can be processed to generate cognitive information for the individual, which can be used to determine the level of risk associated with the individual. The cognitive information can be compared to baseline cognitive information for the individual to determine the level of risk. In another embodiment, a method for determining a level of risk or price of insurance includes obtaining information from a sensor, generating cognitive information from the sensor information, and generating a level of risk or price of insurance using at least the first cognitive information.

### RELATED APPLICATIONS

The present application is a continuation-in-part of and claims priority to U.S. patent application Ser. No. 14/224,248, filed Mar. 25, 2014, which claims priority to provisional Patent Application No. 61/846,521, filed Jul. 15, 2013, is a continuation-in-part of and claims priority to U.S. patent application Ser. No. 14/182,002, filed Feb. 17, 2014, and claims priority to provisional Patent Application No. 61/914,125, filed Dec. 10, 2013, the entire contents of all of which are hereby incorporated by reference.

### TECHNICAL FIELD

The subject matter disclosed herein generally relates to systems and methods for determining the level of risk associated with at least one individual and underwriting or generating a risk score, a cost of insurance, or a cost of insurance and a risk score for at least one individual.

### BACKGROUND

New methods are needed that can more accurately assess and price risk. A method is needed that can better predict losses to appropriately assess risk and assign equitable pricing. These risk assessments could be used to provide risk scores, underwriting guidance, a cost of insurance, or a combination of any of the above.

### SUMMARY

In one embodiment, a system for determining a level of risk associated with an individual comprises determining cognitive information for the individual and basing the level of risk at least in part on the cognitive information for the individual. In another embodiment, a system for modifying the behavior of an individual includes determining cognitive information for the individual, basing a level of risk at least in part on the cognitive information for the individual, and providing input or external stimuli to the individual to directly or indirectly encourage, promote, teach, entrain, train, entertain or otherwise provide resources or to influence or modify the risk-related behavior of the individual to reduce the risk. In one embodiment a system for determining a level of risk associated with an individual comprises a sensor that provides information related to the individual performing an activity. For example in one embodiment, the system comprises a camera providing one or more images or video used to determine one or more properties of the individual, such as the properties of one or more eyes of the individual (and optionally identification information) that is used to help determine risk. In another example, the system comprises one or more sensors that determine facial or heart rate or circadian rhythm information. The system may comprise one or more combinations of sensors and/or cameras. The sensor (such as a camera) may be mounted or built into a vehicle, a portable device, or an accessory for the vehicle or portable device, or worn by the individual. The properties related to one or more eyes include one or more selected from the group: pupil size or dilation, eyelid state/motion (incl. sleepy eyelid movement, blinking rate, closed eyelids, etc.), microsaccade amplitude, frequency or orientation, vergence, eye orientation, eye movement or fixation, gaze direction, gaze duration, details of the iris, symptoms of eye fatigue, and details of the retina. The details of the iris or retina (and/or information from an image of the face of the individual) may be used to provide operator identification information. The eye related information can be processed to generate first cognitive information for individual, which can be used at least in part to generate the level of risk associated with the individual performing the activity. Facial and/or hear rate and/or circadian rhythm information, separately or used in combination with one or more other sensors, may be used to improve identification of cognitive states in some instances. In another embodiment, the first cognitive information is compared to baseline cognitive information for the individual. In another embodiment, the first cognitive information is related to cognitive load and the baseline cognitive information is related to cognitive capacity.

The level of risk associated with the individual may be associated with the individual performing the physical or mental activity or associated with the individual more generally or in a different context. For example, the cognitive information may be used to assess whether a person is a risk taker or risk avoider in general or whether the person is a risk taker or risk avoider under certain conditions or scenarios.

In another embodiment, one or more processors analyze the first cognitive information relative to baseline cognitive information for the individual to be used at least in part to generate the level of risk associated with the individual. In one embodiment, the baseline cognitive information is the cognitive capacity for the individual and the first cognitive information is the cognitive load for the individual while performing one or more physical and/or mental activities. In another embodiment, information from the sensor is used at least in part to determine the baseline cognitive information and the first cognitive information.

In another embodiment, a non-transitory computer-readable storage medium includes instructions that, when accessed by a processing device, cause the processing device to perform operations comprising: storing first cognitive information for an individual determined at least in part from information related to properties of one the individual derived from one or more sensors while the individual is performing one or more physical and/or mental activities; and determining a level of risk associated with the individual for underwriting purposes using at least the first cognitive information. In a further embodiment, the instructions further comprise generating a risk score, a cost of insurance, or a risk score and a cost of insurance for the individual performing the activity based at least in part on the level of risk.

In one embodiment, a system for determining a level of risk associated with an individual for underwriting purposes comprises: a device including a sensor, one or more processors, and one or more non-transitory computer-readable storage mediums operatively connected and collectively comprising the instructions, said instructions direct the one or more processors to process input information from the sensor while the individual is performing a physical or mental activity; generate information related to properties of the individual; process the information related to the properties of the individual and generate first cognitive information for the individual; and generate the level of risk associated with the individual performing a primary or goal state activity using at least the first cognitive information and store the level of risk on the one or more non-transitory computer-readable storage mediums. In one embodiment, the properties of the individual include properties of one or more eyes of the individual. In another embodiment, the properties of the individual include facial information or heart rate or circadian rhythm information of the individual. In a further embodiment, facial information and/or heart beat rate and/or circadian rhythm information is used in combination with the properties of one or more eyes of the individual at least in part to determine the first cognitive information.

In one embodiment, the sensor is a camera and the information derived from one or more images or video from the camera is used to determine the first cognitive information for the individual and the corresponding level of risk associated with the individual. The information related to the level of risk associated with the individual may be used to generate a risk score or cost of insurance for the individual performing the activity, such as an automobile insurance premium for a vehicle operator. In one embodiment, the first cognitive information is related to a cognitive load for the individual when performing a physical or mental activity. In another embodiment, the first cognitive information is related to a use of a reflexive decision making process or analytical decision making process by the individual when performing the physical or mental activity. In one embodiment, the first cognitive information is related to the attention or cognitive focus of the individual performing the primary or goal state physical or mental activity. In another embodiment, an attention score that is directly related to an amount of attention the individual is devoting to the primary or goal state activity is derived at least in part by from the first cognitive information.

In another embodiment, a method for determining underwriting risk, risk score, or price of insurance using cognitive information comprises: obtaining information from a sensor related to properties of an individual while the individual is performing a physical or mental activity; generating first cognitive information for the individual by analyzing at least the information from the sensor related to properties of the individual; and generating a level of risk or price of insurance associated with the individual using at least the first cognitive information. In another embodiment, obtaining information from a sensor related to properties of an individual includes obtaining facial information, skin information, or heart rate information for an individual.

### BRIEF DESCRIPTION OF THE DRAWINGS

FIG. 1 is a data flow diagram of view of one embodiment of a vehicle operation performance analysis system for a vehicle operator operating a portable device while operating a vehicle.

FIG. 2 is a data flow diagram view of one embodiment of a method of calibrating a first sensor to generate movement information in a portable device.

FIG. 3 is a diagram of one embodiment of a portable device comprising a processor that can load and execute one or more algorithms stored on a non-transitory computer-readable storage medium.

FIG. 4 is a flow diagram of one embodiment of a method of generating risk related information for an operator of a vehicle using a cognitive analysis algorithm.

FIG. 5 is a data flow diagram of one embodiment of a system for transferring information to a second party or third party.

FIG. 6 is a flow diagram of one embodiment of a method of generating risk related information for an operator of a vehicle using a risk assessment algorithm.

FIG. 7 is an information flow diagram view of one embodiment of a method of determining a risk assessment, risk score, underwriting, or cost of insurance for an individual.

FIG. 8 is an information flow diagram view of one embodiment of a method of determining a risk assessment, risk score, underwriting, or cost of insurance for an individual and providing feedback or behavior modification information, methods, or activities for the individual.

FIG. 9 is an information flow diagram view of one embodiment of a system for determining a level of risk associated with an individual comprising one or more sensors.

FIG. 10 is an information flow diagram view of one embodiment of a system for determining risk related information including providing modifications, alerts, or information.

### DETAILED DESCRIPTION

The features and other details of the invention will now be more particularly described. It will be understood that particular embodiments described herein are shown by way of illustration and not as limitations of the invention. The principal features of this invention can be employed in various embodiments without departing from the scope of the invention. All parts and percentages are by weight unless otherwise specified.

### Risk Assessment, Risk Scores, Underwriting, and Cost of Insurance

In one embodiment, a risk assessment, a risk score, an underwriting, or a cost of insurance is determined by examining information related to decisions made by one or more individuals, cognitive information, environmental or contextual information, and/or operational performance information. The decision information may include decision-making processes used, decisions made, outcomes of the decisions, circumstances under which the decisions are made, and other information. Correlations between the risk-related decision-making processes and the decisions with the resulting decision outcomes can be used to provide information for a risk assessment, risk score, underwriting or the cost of insurance. A predictive model can be used to assess the proper risk premium to charge for underwriting activities is critical for fair and equitable distribution of the cost of risk. Information related to an individual's propensity to take risks relative to a given context or set of conditions can be used to determine the risk assessment, risk score, underwriting or the cost of insurance. Cognitive information includes information related to cognition. Cognition is the set of all mental abilities and processes related to knowledge: attention, memory and working memory, judgment and evaluation, reasoning and computation, problem solving and decision making, comprehension and production of language. As used herein, cognitive information includes information related to mental processing or capacity for mental processing that includes focus or (selective) attention, memory, working memory, decision making and decision making processes, reasoning, judgment, evaluation, calculating or computation, comprehension, problem solving, production of language, decision making, assessment of chance or probabilities, activities of System 1 and System 2 of the brain, cognitive capacity, perception capacity, and cognitive load. Cognitive information can include information related to one's ability to maintain proper levels of cognitive capacity in the processing of cognitive activities or anticipation thereof (such as solving a problem, adding numbers, driving a vehicle, etc.) or to maintain selective attention on a physical or mental task or activity until it is completed (which can include the ability to ignore distraction and maintain focus). In one embodiment, cognitive information includes cognitive neuroscience information or factors that relate to the biological substrates underlying cognition which may include neural substrates of mental processes. These neural substrates indicate a part of the nervous or brain system that underlies a specific behavior or psychological state. Cognitive information can include information related to how accurately a person understands their cognitive capability and its importance in making decisions in the current situation or near future situations that have a probability of occurrence. Information from sensors, eye related information, facial information (such as facial expressions), working memory, and heart beat information can be used to help determine the cognitive information. Cognitive information may be obtained from external data sources, from internal data sources, from one or more sensors, or derived using a cognitive information algorithm that processes information from one or more sensors, individual information, environmental information, contextual information, operator performance information, and individual property information such as eye related information, heart rate or pulse information, etc.

In one embodiment, a cognitive map is generated that includes the correlations between risk-related decision-making processes and the decisions made by the at least one individual in different risk-related situations. In one embodiment, a cognitive map may be for an individual, a group of individuals, or both individuals and groups of individuals.

One or more decision-making processes for an individual may include a heuristic. The heuristics that exist within an individual can inherently bias that individual toward risk taking behavior. By identifying these heuristics, not only can an underwriting entity determine the proper relative risk score, and therefore the proper premium to charge, but also has the opportunity to provide feedback on the use of these heuristics and how they can lead to errors in judgment. In such a manner, individuals can be conditioned to adopt new and better heuristics and establish lower risk profiles in areas such as auto insurance, life insurance, homeowners insurance, medical insurance, financial loans, investments, etc.

### Frequency of Adjustment

In one embodiment, an initial underwriting profile for an individual comprises an initial risk assessment, an initial risk score, an initial underwriting, or an initial cost of insurance. In another embodiment, the initial underwriting profile is subsequently adjusted based upon one or more decisions, decision-making processes, and/or decision outcomes for the individual. In one embodiment, the risk assessment, risk score, underwriting or the cost of insurance is adjusted in one or more time intervals selected from the group: real-time, within a minute, within an hour, within a day, within a week, within a month, within a quarter, twice a year, yearly, every two years, and within a multi-year timespan. In one embodiment, the adjustment is made or triggered after identification of data from one or more specific events, a change in environmental or individual conditions, a change in actual or perceived risk or loss exposure information, individual decisions, individual decision outcomes, input from external sources, or specific contextual information. In another embodiment, the adjustment is made at one or more specific times determined by the individual, underwriter, or third-party.

### Initial Underwriting Profile Generation

In one embodiment, the initial underwriting profile is generated through traditional means, such as credit scoring, that serves as an underwriting baseline or constant upon which discounts are applied based on a different underwriting method. In one embodiment, the initial underwriting profile comprises information received from the individual or other data sources and/or the results of processing the information received from the individual or other data sources. In one embodiment, the information received from the individual is obtained through a survey, test, or initial monitoring. In one embodiment, a survey, test, or initial monitoring infers or monitors one or more decision-making processes and decision outcomes for one or more decisions in one or more contextual situations. In another embodiment, one or more initial correlations are made between the risk-related decision-making processes and the decisions with the resulting decision outcomes. In one embodiment, an initial underwriting profile is generated subsequent to monitoring and analyzing information from the individual related to one or more decisions made in one or more risk-related situations. In another embodiment, the individual is rated on a scale ranging from a very risk-seeking individual to a very risk-averse individual. In another embodiment, the individual is initially segmented according to one or more risk scores, risk scales, or risk-related categories.

### Risk-Related Situations and Decisions

In one embodiment information related to risk-related decisions made by an individual in one or more risk-related situations is analyzed to provide information for the risk assessment, the risk score, the underwriting, or the cost of insurance. Risk-related situations are situations wherein an individual may make a decision or choice among multiple courses of action (including inaction) that involve various levels of risk whether real, imagined, or contrived. The risk level may range from a very low level of risk to a very high level of risk.

### Risk-Related Decisions and Decision-Making Processes

Decision-making processes are the processes by which an individual or group of individuals makes a selection between possible courses of action (including inaction). Generally, the processes may be classified as analytical in nature (referred to as System 2) or autonomic/habitual in nature (referred to as System 1). Heuristics are examples of decision-making processes that often are autonomic in nature. The decision may be a risk-related judgment or evaluation and the risk-related decision information may be used for the judgment.

### Risk-Related Decision Information

Risk-related decision information can include one or more of the following: the cognitive map for the individual; information on one or more decision-making processes used to make one or more decisions (including reflexive or heuristic decision-making processes, analytical or reflective decision-making processes, the preference, dominance, or relative proportion of use of reflexive or heuristic decision-making processes relative to analytical or reflective decision-making processes); the decision outcome (including negative, positive, or neutral properties); contextual information for the decision; risk and loss exposure information; one or more negative or positive correlations between one or more decision-making processes and one or more decision outcomes; and one or more positive predictive factors or negative predictive factors for predicting one or more positive decision outcomes or negative decision outcomes, respectively.

In one embodiment, the risk-related decision information obtained from data sources is used to determine one or more of the following: when one or more risk-related decisions were made; which decision-making heuristic processes were used in the one or more risk-related decisions; the classification of the individual into one or more groups (based on common or similar risk-related decision information, contextual information, traits, physical or mental condition, personalities, level of the risk behavior from risk-seeking to risk-averse, social connections with other individuals, or other demographic information); contextual information for the decision; risk and loss exposure information; the characterization of the use of a specific decision-making process in a specific situation (either generally, by a specific individual, or a group of individuals) as risk-seeking, risk-averse or a level of risk between risk-seeking and risk-averse; the identification of a decision outcome; if the outcome is positive, neutral, or negative; the preference, dominance, or relative proportion of System 1 decision-making processes to System 2 decision-making processes; and the correlation between one or more decision-making processes with one or more decision outcomes.

### Reflexive or Heuristic Decision-Making Processes

In one embodiment, a method of generating a risk score, a cost of insurance, or a risk score and a cost of insurance for at least one individual is based at least in part on the use by an individual of one or more risk-related heuristic decision-making processes. As used herein, a heuristic is a decision-making method or method of making a choice whereby the decision or choice is based on a subset of the information or only certain aspects of the situation under consideration. Heuristics simplify the decision process relative to a full analytical decision-making process. Heuristics can be thought of as short cuts, rules-of-thumb, or simplified judgments and they generally require less cognitive resources than a fully analytical process, but can often lead to errors. Heuristics are consistent with the bounded rationality model of decision-making where the ability of individuals to be rational in a decision is limited by cognitive capacity, the amount of contextual information related to the decision, and time available to make the decision. Examples of heuristics include reflexive decision-making processes, which refer to the process of making decisions or choices purely based on gut instinct. In reflexive decision-making processes the decision-maker makes a choice based on intuition or how it feels to him or her. As used herein, reflexive or automatic decision-making processes are referred to as System 1 decision-making process. Other examples of heuristics include, but are not limited to: anchoring, representativeness, base rate fallacy, conjunction fallacy, dilution effect, misperception of randomness, ignorance of sample size, affect, control, effort, scarcity, attribute substitution, consensus, confirmation bias, and overconfidence. Other heuristics or cognitive impairments, such as those related to PTSD and those known and unknown in the science of cognitive psychology, may be used in a method of generating a risk score, a cost of insurance, or a risk score and a cost of insurance.

### Analytical or Reflective Decision-Making Processes

In one embodiment, a method of generating a risk score, a cost of insurance, or a risk score and a cost of insurance for at least one individual is based at least in part on the use by an individual of one or more risk-related analytical or reflective decision-making processes. As used herein, an analytical, reflective, or high level of concentration decision-making process is referred to as a System 2 decision-making process and is a rational-economic process of judgment or decision-making whereby an individual considers all available information relating to the decision process, analyzes it, and comes to a rational conclusion or choice based on the process. Analytical decision-making takes more time and requires more cognitive capacity and concentration than heuristics or reflexive decision-making

### Primary Task Decisions

In one embodiment, information related to one or more primary decisions is used to determine the risk assessment, the risk score, the underwriting, or the cost of insurance. Primary task decisions include decisions whose resulting decision outcomes are directly associated with risk for the assessment, underwriting, or insurance. For example, an individual's actions operating an automobile are decision outcomes of primary task decisions associated with the risk for automobile insurance.

### Secondary or Tertiary Task Decisions

In one embodiment, information related to one or more secondary and/or tertiary decisions is used to provide information for determining the risk assessment, the risk score, the underwriting, or the cost of insurance. Secondary task decisions include decisions secondary to the primary task decisions and the resulting decision outcomes of the secondary task decisions are indirectly associated with risk for the assessment, underwriting, or insurance. For example, an individual's actions operating a cellphone (secondary task) are decision outcomes of secondary task decisions if the individual is simultaneously operating an automobile (primary task). Similarly, tertiary task decision information may be used to provide the risk assessment, the risk score, the underwriting, or the cost of insurance. Tertiary task decisions, for example, include choosing to listen to the radio (tertiary task decision) while choosing to operating a vehicle (primary task decision) and choosing to talk on a cellphone (secondary task decision), wherein information related to each of these decisions may provide information associated with the risk for automobile insurance. In this example, the decision processes used to decide why to answer a phone call while driving a vehicle, the decision processes used to decide not to turn down the radio, and other information related to these decisions, such as contextual information (such as the caller identified as the mother of the individual) can be used to help determine the cost of automobile insurance. Similarly, decision information with positive outcomes, such as in the context of the previous example, turning down the radio before answering the phone and/or stopping the vehicle before answering the phone can be used to help determine the cost of automobile insurance.

### Contextual Information

In one embodiment, the risk assessment, the risk score, the underwriting, or the cost of insurance is determined using contextual information related to the decisions made by at least one individual. Contextual information, as used herein, refers to data regarding the surroundings, environment, circumstances, background, reasoning, or settings that determine, specify, interpret, or clarify the meaning of an event or other occurrence. In one embodiment, the contextual information directly or indirectly provides information related to the decision-making process. In one embodiment, the contextual information provides supporting information that increases the probability of occurrence, or confirms an occurrence or the conditions of a specific decision or decision-making process. Contextual information can include the conditions surrounding an event such as a decision and can include the physical or mental state of the individual. In another embodiment, historical contextual information may be used to provide decision related information or information that can be used to deduce other decision related information.

For example, in the context of automobile insurance, contextual information may be used to determine that a vehicle operator is late for work. In this example, context information could include historical data of normally leaving the home 10 minutes prior, a text message including the phrase “I'm late for work,” or an irregularity in a normal routine (such as turning on the vehicle 10 minutes later than normal). In this example, the fact that the vehicle operator is running late (such as direct admission in a text message or inferred from the deviation from a normal time leaving their home) is contextual information relating to the decision of whether or not to speed to work or run a yellow light (risk-seeking behavior) or calling work to move a meeting (risk-averse). In another example, a vehicle operator who is normally sleeping and inactive between 11 pm and 5:30 am that is driving a vehicle at lam (as determined through GPS, mobile device, road infrastructure, or telematics information in conjunction with vehicle driver identification) may be considered risk-seeking in the decision to drive at that hour. As is clear from these examples, contextual information from a plurality of sources may be used to confirm or increase the accuracy of the decision related information. In one embodiment, a pattern of behavior is identified through contextual information, wherein the deviation from the pattern is identified and used to confirm or increase the accuracy of the decision information.

### Risk or Loss Exposure Information

In one embodiment, the risk assessment, the risk score, the underwriting, or the cost of insurance is determined using risk or loss exposure information related to the decisions made by at least one individual. As used herein, the risk exposure information related to a decision or judgment made by an individual is the information related to the exposure of the individual to one or more risks that could affect the decision-making process or the judgment process. As used herein, the loss exposure information related to a risk-related decision or judgment made by an individual comprises information related to the asset (such as a vehicle, for example), information related to the peril or covered risk (as opposed to non-covered risk), and information related to the consequences of the loss (such as getting a scratch on a vehicle that leads to a reduced valuation, for example).

The risk exposure information can include information related to the actual or perceived overall effect (such as a loss or a negative outcome) of identified risks and the actual or perceived probability of the risk occurring. The risk exposure information can include information related to the actual or perceived impact (financial impact, intangible impact, time impact, etc.) if the risk were to occur. For example, if a driver has a separate umbrella insurance policy covering automobile collisions in addition to standard automobile insurance policy covering collisions, the actual (and/or perceived) financial risk (or impact) in the event of a collision could be reduced. In this example, information related to the standard automobile insurance coverage and the umbrella insurance policy is risk exposure information that can affect the decisions or judgments made by the individual. Similarly, the financial wealth (or lack thereof) of an individual can affect the actual or perceived financial impact if the risk were to occur. Other risk exposure information can include actual or perceived information selected from the group: the amount of the loss covered by an insurance policy; the health of the individual; the ability to recover from the loss or event; and the financial, mental, or physical condition of the individual or property.

The risk exposure information can affect the use of one or more decision-making heuristics in a risk-related decision or judgment. In one embodiment, a correlation between risk exposure information and the use of one or more heuristics is used to determine the risk assessment, the risk score, the underwriting, or the cost of insurance for an individual

### Decision Outcomes

A decision outcome includes the results of a decision process and a decision made. In one embodiment, information related to one or more decision outcomes is acquired and/or monitored and used to help in determining the risk assessment, the risk score, the underwriting, or the cost of insurance. In one embodiment, the data related to a decision outcome is used to determine the decision made by an individual and/or to help identify one or more decision processes used by the individual to make the decision. For example, monitoring the telematics data from a vehicle may help identify a decision by the driver to change lanes, a decision to drive in the snow, or a decision to drive below the speed limit in raining conditions. One or more decision outcomes may be classified as positive, negative, or neutral. Neutral decision outcomes are those deemed to not have an inherent favorable or unfavorable nature, to not be relevant to the risk, or have little relevancy to the risk associated with a primary task. In one embodiment, decision outcomes that are neutral for one type of insurance may be negative or positive for a different type of insurance or risk, for example. In one embodiment, the decision outcome is a judgment or evaluation made using one or more decision-making processes (such as heuristics or analytical processes).

### Negative Decision Outcomes

In one embodiment, information related to negative decision outcomes is used to help determine the risk assessment, the risk score, the underwriting, or the cost of insurance. Negative decision outcomes include outcomes from a decision which are unfavorable or undesirable in nature especially as they pertain to risk. For example, data relating to a car crash can be negative decision outcome information (such as in the case of a driver's decision to pass a car around a curve in the road identified using telematics and geographical information) in the context of automobile insurance rates.

### Positive Decision Outcomes

In one embodiment, information related to positive decision outcomes is used to help determine the risk assessment, the risk score, the underwriting, or the cost of insurance. Positive decision outcomes include outcomes from a decision which are favorable or desirable in nature especially as they pertain to risk. For example, data relating to a successful trip completion (such as vehicle location determined to be at target destination) and vehicle speed information (such as acquired by the vehicle's On-board-Diagnotistics-2 (OBD2) device) by a vehicle operator can be information related to a positive decision (such as a decision not to drive over the speed limit) in the context of automobile insurance rates.

### First Decisions Affecting Second Decisions

In one embodiment, a risk assessment, a risk score, an underwriting, or a cost of insurance is determined at least in part on a relationship or a correlation between a first decision or first decision outcome and a second decision or second decision outcome. In another embodiment, a first decision or decision outcome affects (directly or indirectly) a second decision or decision outcome. For example, in the context of determining the cost of automobile insurance, the first decision of a driver running late for work to speed can affect a second decision to pass through a red light. A first risk-related decision may be associated with a low or high level of risk and a second risk-related decision related or correlated with the first risk-related decision may have low or high level of risk. In one embodiment, a first decision with a low level of risk has a high correlation with a second decision with a high level of risk. In one embodiment, the first risk-related decision, the first risk-related decision outcome, the first and second risk-related decisions, and/or the correlation between the first and second risk-related decisions may be used to determine a risk assessment, a risk score, an underwriting, or a cost of insurance.

In another embodiment, a risk assessment, a risk score, an underwriting, or a cost of insurance is determined at least in part on a first risk-related judgment decision of an individual that affects a second risk-related decision. In one embodiment, a first decision or first decision outcome is contextual information for a subsequent second decision. For example, in the context of determining the cost of automobile insurance, a driver who frequently judges a distance to be much further or closer than the actual distance may use the incorrect judgments to make other risk-related decisions. In this example, a driver's judgment of a distance required to stop, a distance from another vehicle in front of the driver, or a distance till the next highway off-ramp can affect a subsequent risk-related decision such as when to stop the vehicle, or when to change lanes.

### Identifying Risk-Related Situations

In one embodiment, one or more risk-related situations are identified using decision information from one or more data sources. In one embodiment, contextual decision information is used to identify risk-related situations where there is a possibility of a loss such as injury or death, property damage, vehicle damage, missing one or more loan payments, loss of job or income, or other real or perceived loss of value of a tangible or intangible item (such as a loss in company brand approval).

### Decision-Making Process Algorithm

In one embodiment, a decision-making process algorithm is executed on one or more processors in a system to determine or process decision information for determining the risk assessment, the risk score, the underwriting, or the cost of insurance for an individual. In one embodiment, the decision-making algorithm performs one or more of the tasks selected from the group: identifies a risk-related decision; determines decision information; determines (with or without a degree of certainty or probability) contextual decision related information (such as the framework for the decision); determines (with or without a degree of certainty or probability) risk exposure information; determines (with or without a degree of certainty or probability) the use of one or more decision-making processes by the individual; determines (with or without a degree of certainty or probability) the use of one or more heuristic decision-making processes by the individual; determines the decision outcome; determines whether it is a negative, positive, or neutral decision outcome; correlates the actual or perceived risk exposure information with one or more decision-making processes (such as a heuristic); identifies the decision and/or the individual on a scale from risk-seeking to risk-avoiding; analyzes historical decision information to provide decision information for a subsequent decision (such as a vehicle operator frequently choosing a particular decision-making process under a particular set of conditions); compares decision information for an individual with collective decision information from a plurality of individuals; identifies one or more patterns in decision information from a plurality of individuals; applies an identified pattern of decision related information from a plurality of individuals to determine, predict, or estimate the decision information for individual (including an individual within or not within the plurality of individuals). The decision making algorithm may be stored on a non-transitory computer-readable media on or in operable communication with the portable or wearable device, a remote computer or server (such as an insurer's computer or the insured's computer, for example), or an automobile or craft or device operatively connected thereto. The decision making algorithm may be processed by one or more processors on or in operable communication with the portable or wearable device, a remote computer or server (such as an insurer's computer or the insured's computer, for example), or an automobile or craft or device operatively connected thereto.

### Baseline Cognitive Information

In one embodiment, baseline cognitive information may be determined for an individual to determine other cognitive information for the individual in real time (such as determining the cognitive load relative to a baseline cognitive capacity), to predict the likelihood of a specific behavior, decision, or decision outcome for one or more situations, or initially segment or classify an individual into a risk group. The baseline cognitive information may be determined or updated prior, during, or after performing one or more physical or mental activities by analyzing information from one or more sources selected from the group: one or more sensors, computer simulations, questionnaires, self-reporting mechanisms, one or more Cognitive Failure Questionnaires (CFQs), historical measurements of cognitive information (such as historical cognitive load measurements for the individual performing one or more physical and/or mental activities), decision information, decision making process information, cognitive map information, statistical cognitive information for one or more individuals, or other tests or evaluative techniques suitable for determining cognitive information for one or more individuals. The baseline cognitive information may include information related to the individual's general level of inattention and distractibility.

### Baseline Heuristic Patterns and Cognitive Mapping

In one embodiment, the use of one or more decision-making processes under a plurality of situations is analyzed for an individual or group of individuals. In another embodiment, the use of one or more heuristic decision-making processes under a plurality of situations is analyzed for an individual and/or group of individuals. By acquiring (directly or indirectly) baseline decision information or information used to determine decision information for an individual for different risk-related decision situations, the information may be analyzed for patterns and may be used to segment or classify an individual (such as segmenting the individual as risk-seeking, risk-averse, or some intermediate classification); determine a propensity for specific risk-related behavior (generalized or in specific situations); or predict the likelihood for a specific decision or decision outcome for one or more given situations. The baseline decision-making processes may be acquired in the initial underwriting profile generation; prior to underwriting using data sources; during a testing period (such as an electronic questionnaire prior to underwriting or during an initial evaluation for the underwriting); or in a trial or initial data capture phase prior to or in conjunction with the underwriting process. For example, initial baseline decision information may be captured to determine which baseline heuristic decision-making processes are used by an individual in specific conditions. The frequency, use in situations with similar characteristics, patterns of use, or use of a combination or likely combination of one or more heuristic decision-making processes may be used to provide risk-related information for determining the risk assessment, the risk score, the underwriting, or the cost of insurance for the individual.

Similarly, the baseline heuristics used by a plurality of individuals may be analyzed (possibly in conjunction with other information such as demographics, geographical information, or other information within an underwriting profile) to provide insight or guidelines for determining the baseline heuristic decision-making processes used by a specific individual in specific situations. For example, for a specific demographic of individuals (or individuals with similar characteristics), the use of a specific heuristic decision-making process may be identified as being the dominant decision-making process used in specific situations. Information that may be used to construct a baseline heuristic pattern for one or more individuals may include decision information provided by the individual; decision information derived or inferred from information provided by the individual; contextual information; actual or perceived risk exposure information; decision information from one or more data sources; decision information derived from analysis of decision information from other individuals; patterns or relationships inferred from decision information analyzed for a plurality of individuals; or historical information from one or more of the aforementioned sources. Computer implemented tests such as a CFQ or other tests may be used to provide baseline cognitive information that can provide a baseline indication of whether a person: 1) is prone to using System 1 and heuristic methods when assessing risk situations, 2) is prone to inattentiveness and distractibility, 3) has a lazy System 2 (does not intervene), or 4) determine the working memory capacity such as determining if the individual has a small or large working memory capacity.

### Cognitive Map for an Individual

As used herein, a cognitive map is a map or catalogue of an individual's cognitive information or data including cognitive capacity, current cognitive load, cognitive skills, cognitive speed, and/or cognitive processes especially as they pertain to making decisions. The cognitive map comprises cognitive information and the cognitive map may be represented by one or more data sets, one or more arrays of data, one or more databases, or other collection of data stored on a non-transitory computer-readable media.

The cognitive processes include decision-making processes such as heuristic or analytical decision-making processes. The cognitive information may be mapped for different situations and may include statistical information related to the probability of use of one or more cognitive processes in specific (or generalized) situations. For example, the cognitive map may include information indicating that the individual uses the heuristic decision-making process of overconfidence 80% of the time when they are operating a vehicle and running late for an event. The cognitive map may further include statistical information that correlates one or more decision-making processes and decision outcomes for one or more situations. This correlated information may further include an assessment of the level of risk associated with the one or more decision-making processes or a generalized risk assessment (from risk-seeking to risk-averse, for example) of the individual based on the correlations. The cognitive map may include statistical information indicating the number, probability, propensity, or percentage of the risk-related decisions made by the individual that fall into risk-seeking or risk-averse categories.

In one embodiment, the cognitive map includes historical cognitive information such as cognitive capacity, cognitive skills, cognitive speed, cognitive load, or cognitive processes. The historical cognitive information may be used, for example, to determine which heuristic decision-making processes the individual uses in risk-related situations in general or in specific situations. In another embodiment, the historical cognitive information is analyzed to determine correlations, patterns, or relationships between risk-related decision-making processes and the resulting decision outcomes. In this embodiment, the historical cognitive information can be used to identify or categorize decision information for a specific current situation, predict decision information for a specific future situation (real or hypothetical), or determine a propensity for a specific risk-related decisions for a specific future situation (real or hypothetical). New information may be added to the cognitive map in one or more time intervals selected from the group: real-time, within a minute, within an hour, within a day, within a week, within a month, within a quarter, twice a year, yearly, every two years, and within a multi-year timespan. In one embodiment, new information is added to the cognitive map after identification of new information from one or more specific events; new environmental or individual condition information; new individual decisions, new individual decision outcomes, new input information from external sources, new information from a particular data source, new risk or loss exposure information, or new specific contextual information. As used in this context, “new information” refers to information not previously in the cognitive map and may include information that has recently changed, recently acquired information from recent events, historical information acquired from a new data source, or new prediction or calculated information, for example. In another embodiment, the adjustment is made at one or more specific times determined by an individual, an underwriter, or a third-party.

In one embodiment, cognitive information in a cognitive map for an individual is adjusted or changed by providing feedback information, providing direction or guidance, providing encouragement, or directly modifying the behavior of an individual such that for one or more situations their behavior changes, choice of using one or more risk-related decision process changes, or more decisions result in a positive decision outcomes or fewer negative decision outcomes.

### Cognitive Maps for Multiple Individuals

In one embodiment, a method of generating a risk score, a risk assessment, a cost of insurance, or a risk score and a cost of insurance for at least one individual based at least in part on risk-related decision-making processes and resulting decision outcomes comprises correlating the risk-related decision-making processes and the decisions with the resulting decision outcomes using a plurality of cognitive maps. The cognitive maps for multiple individuals comprising cognitive information may be represented by one or more data sets, one or more arrays of data, one or more databases, or other collection of data stored on a non-transitory computer-readable media.

In this embodiment, a collection of cognitive maps may be analyzed to determine statistical correlations between the probabilities of use of one or more cognitive processes in specific (or generalized) situations by a specific group of individuals. For example, by analyzing 5,000 cognitive maps, one may determine a statistically high correlation between the use of the “group think” heuristic decision-making process (where decisions conform to the opinion of the group) and members of a socially interconnected group with very active postings on social networking websites suggesting risk-seeking preferences or behavior. In this example, by further statistically correlating the “group think” heuristic decision-making process (in general or for a particular group of individuals) with a statistically high probability of negative decision outcomes, the cost of automobile insurance for an individual within this group may be increased to reflect the increased risk. In this example, the data sources for decision related information could include testing or survey data from the group members, telematics data from the group members, portable or wearable device use information, external data sources such as social networking websites (such as Google+ or Facebook), publicly available external data sources (including police records, credit reporting agencies, and internet resources), and other data sources.

In another embodiment, the plurality of cognitive maps may be used to determine the probability for an individual of using one or more specific decision-making processes (such as one or more specific heuristic decision-making processes) in a specific situation. In this embodiment, risk-related decision information in a plurality of cognitive maps can be analyzed to determine the probability, such as for example, based on patterns, correlations, or relationships for decision information.

In another embodiment, the plurality of cognitive maps may be used to classify one or more individuals into groups. The classification may be based on one or more selected from the group: risk information, individual information, behavioral information, decision information such as common or similar risk-related decision information, contextual information, risk exposure information, cognitive information, traits, physical or mental condition, personalities, preferences, personal characteristic information, level of the risk behavior from risk-seeking to risk-averse, social connections with other individuals, location, credit score, or other demographic information.

In another embodiment, the plurality of cognitive maps may be used to characterize the level of risk associated with the use of one or more specific risk-related decisions (such as one or more specific heuristic risk-related decision-making processes). In this embodiment, decision information (such as the use of one or more specific risk-related decisions) may be correlated with the corresponding decision outcomes from multiple cognitive maps to determine the risk associated with the decision information. For example, an 85% correlation of the use of an affect heuristic decision-making process with a negative decision outcome for a specific group of individuals in specific conditions can characterize the affect heuristic decision-making process as a high risk decision-making process and can contribute to the classification of the individual as a risk-seeking individual and increase their rates for insurance.

In one embodiment, the cognitive information for a group of individuals is stored in a single cognitive map or a collection of cognitive maps. A cognitive map for a single individual, a collection of cognitive maps for a group of individuals, or a single cognitive map for a group of individuals comprises cognitive information that may be stored on one or more non-transitory computer-readable media that are connected or in communication with one or more devices (including portable devices, wearable devices, desktops, laptops, servers, etc.), or that are in operable communication via wired (internet protocol, etc.) or wireless formats (Wi-Fi, Bluetooth™, IEEE 802.11 formats, cellular communication data formats (GPRS, 3G, 4G (Mobile WiMAX, LTE, etc.), or optical, etc.) with one or more devices or processors. In one embodiment, one or more of the devices (such as a portable device for example) communicates cognitive information from one or more cognitive maps to another device (such as a server). The cognitive maps comprise cognitive information that may be stored on a non-transitory computer-readable media on or in operable communication with the portable or wearable device, a remote computer or server (such as an insurer's computer or the insured's computer, for example), or an automobile or craft or device operatively connected thereto.

Correlating the Risk-Related Decision-Making Processes and the Decisions with the Resulting Decision Outcomes

In one embodiment, a method of generating a risk assessment, a risk score, an underwriting, or a cost of insurance comprises correlating the risk-related decision-making processes and the decisions with the resulting decision outcomes for an individual. In one embodiment, the risk-related decision information for decisions made by one or more individuals is examined and statistical relationships are determined between decision-making processes, decisions, and the decision outcomes. In one embodiment, correlations may be determined using cognitive information or decision information from one or more cognitive maps, which may include a cognitive map for the individual. The correlation may be performed prior as part of a process for generating an initial risk assessment, risk score, underwriting, or cost of insurance. In another embodiment, the correlation is performed after the generation of an initial underwriting profile, after the generation of baseline heuristic patterns, or after the generation of an initial cognitive map.

In on embodiment, an algorithm that correlates the risk-related decision-making processes and the decisions with the resulting decision outcomes for an individual is stored on a non-transitory computer-readable media on or in operable communication with the portable or wearable device, a remote computer or server (such as an insurer's computer or the insured's computer, for example), or an automobile or craft or device operatively connected thereto. The algorithm that correlates the risk-related decision-making processes and the decisions with the resulting decision outcomes for an individual may be executed by one or more processors on or in operable communication with the portable or wearable device, a remote computer or server (such as an insurer's computer or the insured's computer, for example), or an automobile or craft or device operatively connected thereto.

Using Statistical Data from Cognitive Maps to Determine Probabilities, Associations, and Correlations

In one embodiment, the cognitive information and decision information from one or more cognitive maps is used to create statistical data for determining which decision-making process (such as which heuristic decision-making process) is more accurate (or less accurate) for predicting negative and/or positive decision outcomes. In one embodiment, the statistical correlation for a plurality of decision-making processes is analyzed correlations that are associated with loss, negative decision outcomes, lack of loss, or positive decision outcomes is used to generate the risk assessment, the risk score, the underwriting, or the cost of insurance. In one embodiment, predictive analytics are used to analyze the information. The correlations may be negative correlations or positive correlations.

### Negative Correlations

In one embodiment, the cognitive information and decision information from one or more cognitive maps is used to create statistical data for determining which decision-making processes are more accurate for predicting a negative correlation. As used herein, a negative correlation for a decision-making process is where the increased use of one or more decision-making processes correlates with decrease in positive outcomes (or an increase in negative decision outcomes). The use by an individual of one or more decision-making processes with a negative correlation can increase the risk and result in an increased risk assessment, increased risk score, an underwriting with more negative terms, or a an increase in the cost of insurance.

### Positive Correlations

In one embodiment, the cognitive information and decision information from one or more cognitive maps is used to create statistical data for determining which decision-making processes are more accurate for predicting a positive correlation. As used herein, a positive correlation for a decision-making process is where the increased use of one or more decision-making processes correlates with increase in positive outcomes (or a decrease in negative decision outcomes). The use by an individual of one or more decision-making processes with a positive correlation can decrease the risk and result in an decreased risk assessment, decreased risk score, an underwriting with more positive terms, or a an decrease in the cost of insurance.

### Risk-Seeking or Risk-Averse Profile

In one embodiment, a method of generating the risk assessment, the risk score, the underwriting, or the cost of insurance for an individual comprises profiling the individual such that they are categorized on a scale from very risk-seeking individual to a very risk-averse individual. In one embodiment, decision information such as contextual information is used to determine the level of risk associated with one or more risk-related decisions made by the individual. In one embodiment, the individual risk profile includes risk-related information, such as a characterization of the individual on a scale from very risk-seeking to very risk-averse for one or more individuals and may be generated for different situation (where for example, the individual may be categorized on a risk scale differently for different situations or conditions). In one embodiment, the risk profile for one or more individuals is classified as either being more type one (automatic) or type two (reflective) for the types of risks being underwritten and scales can be developed based on the varying degree to which an individual uses one type of decision system over the other. Additional risk profile categories can be created based on variations in heuristic collections and cognitive maps for greater segmentation and risk scoring ability.

For example, over a period of a year, risk-related decision information for an individual obtained from one or more data sources is compiled into a cognitive map and analyzed. If from this analysis it is determined through numerous scenarios that when a first individual is running late for work, they tend to seek risk, they may be categorized in a risk profile as risk-seeking for the purpose of calculating a cost of automobile insurance.

Similarly, in another example, over a period of a year, risk-related decision information for an individual obtained from one or more data sources is compiled into a cognitive map and analyzed. If from this analysis it is determined through numerous scenarios that when a first individual is under a significant amount of pressure (physiological and/or mental pressure) they tend to seek risk, they may be categorized in a risk profile as risk-seeking for the purpose of calculating a cost of automobile insurance.

### Monitoring or Inferring the Decision-Making Process

In one embodiment, information related to the decision-making process is directly monitored or inferred. Inferring the risk-related decision-making processes includes using decision outcomes from known or inferred related decisions to statistically deduce or infer the decision-making process that led to the decision and its outcomes. In another embodiment, contextual information related to the decision is acquired and used to help identify one or more decision-making processes or the statistical probability of using one or more decision-making processes. In a further embodiment, risk exposure information related to the decision is acquired and used to help identify the use of one or more decision-making processes or the statistical probability of using one or more decision-making processes.

Information related to the decision-making process may be obtained from one or more data sources and may be processed by a decision-making processes algorithm to help identify one or more decision-making processes or statistical correlations with other decision information for the same individual in similar risk-related situations, the same individual in different risk-related situations, other individuals in similar risk-related situations as the individual, or other individuals in different risk-related situations. In another embodiment, the decision information is compiled in a cognitive map for the individual. In one embodiment, heuristic decision-making techniques for the individual are monitored directly or indirectly through analyzing the decision information (which can include contextual information, cognitive information, or risk and loss exposure information). In this embodiment, monitoring one or more of the heuristic decision-making techniques used by the individual can be used to determine a propensity to take risks which could be used to provide information to help determine the risk assessment, the risk score, the underwriting, or the cost of insurance. In one embodiment, a probability of using one or more decision-making processes by the individual for one or more decisions is calculated using decision information for the individual and optionally using decision information from other individuals in similar or different risk-related situations.

For example, decision information that can help identify or increase the probability of identifying the decision-making process used by the individual for one or more decisions can include: sampling data from numerous similar events, using contextual information to determine correlations of instances of speeding or driving through a yellow or red light with being late for work (as determined via contextual information) on multiple occasions (in the context of automobile insurance); or instances of distracted driving determined through contextual information from a cellphone and telematics information from the vehicle operated by the individual.

In one embodiment, one or more decision-making processes for the individual is identified or the probability of using one or more decision-making processes is determined using one or more processes selected from the group: correlating decision information for the risk-related situation with decision information for previous situations for the individual where the decision process used is known (or known with a high probability); correlating decision information for the risk-related situation with decision information from other individuals previously in similar or different risk-related situations where the decision process used is known (or known with a high probability); correlating decision information from one or more decisions from one or more individuals; and comparing the cognitive map from the individual with one or more cognitive maps from one or more other individuals.

In another embodiment, one or more decision-making processes for the individual is identified or the probability of using one or more decision-making processes is determined using information from one or more data sources selected from: the initial underwriting profile, external data sources, third-party data sources, a wearable device (smart watch, pulse monitor, contact lens, etc.), a portable device (cellphone, etc.), a telematics device, a medical device (magnetoencephalography (MEG) device, etc.), a computing device (tablet computer, laptop computer, desktop computer, etc.), and other electronic device.

In another embodiment, decision information for one or more risk-related situations is used to help identify conditions where the individual uses (or has a statistical likelihood of using) a reflexive or heuristic decision-making technique, or an analytical or reflective decision-making process technique. In one embodiment, a method of determining the risk assessment, the risk score, the underwriting, or the cost of insurance for an individual includes identifying conditions where the individual uses (or has a statistical likelihood of using) a reflexive or heuristic decision-making process, identifying or inferring the reflexive or heuristic decision-making process used; and correlating the reflexive or heuristic decision-making process and the decisions with the resulting decision outcomes.

### Data Capture and Sources

In one embodiment, information related to individual health or performance, operational performance of an activity (such as operating a vehicle), individual identification or security, environmental or contextual information, decision information, information used to generate decision information, cognitive information, or neurophysiological information is obtained from one or more data sources selected from the group: data supplied by the individual; a portable or wearable device; a telematics device or vehicle or craft comprising a telematics device, data recorder or one or more sensors; a building or structure system (such as an alarm system or automation system for a home or building); a medical device; a magnetoencephalography device; government data sources; industrial control systems; one or more sensors or one or more devices comprising one or more sensors; and external data providers, external data sources, or external networks. This information may be received directly or indirectly from the data source and information from the data source may be processed (such as by a processor executing a decision-making process algorithm, cognitive information algorithm, cognitive analysis algorithm, or distraction algorithm) to generate other information. The information used to generate additional information, the situation information, the propensity model algorithm, the predictive model algorithm, the cognitive maps of individuals, the risk score, the cost of insurance information, the algorithms used to generate the risk score or cost of insurance, the feedback or the behavior modification algorithms, or the other algorithms or information discussed herein may be stored on one or more non-transitory computer-readable media that are connected or in communication with one or more devices (including portable devices, wearable devices, desktops, laptops, servers, etc.), or that are in operable communication via wired (internet protocol, etc.) or wireless formats (Wi-Fi, Bluetooth™, IEEE 802.11 formats, cellular communication data formats (GPRS, 3G, 4G (Mobile WiMAX, LTE, etc.), or optical, etc.) with one or more devices or processors. In one embodiment, one or more of the devices (such as a portable device for example) communicates this information to another device (such as a server). The information or information used to generate the information may be stored on a non-transitory computer-readable media on or in operable communication with the portable or wearable device, a remote computer or server (such as an insurer's computer or the insured's computer, for example), or an automobile or craft or device operatively connected thereto.

In one embodiment, the aforementioned information may be obtained using one or more sensors and used to develop cognitive based predictive models for automobile insurance. For example, in one embodiment one or more sensors on a portable device captures information (such as camera image) that can be processed to determine information related to the individual's use of reflexive or analytical decision making processes. One or more sensors (such as the same camera) may also capture distracted driving information and identity information for the individual operating the automobile. By capturing and storing cognitive information for the individual, a cognitive map for the individual can be created that illustrates the type of thought processes used by the individual and may be used to develop propensity models for the individual or predict the thought process used (and possibly the likely outcome). This cognitive information may, for example, be used to determine an individual's propensity to take risks, an individual's habit, and can be monitored to determine or predict that a person is going to behave a particular way (or use a particular thought process or decision making process) if the individual's cognitive load is high or when the individual is making risk related decisions, for example. In one embodiment, one or more sensors, such as a camera and heart rate monitor, may allow a company to measure the cognitive capacity of an individual (such as how many things the individual can think about or do at once). In this embodiment, the camera can also be used to identify the individual and the system can add, retrieve, or process information indexed to the identified individual's cognitive profile or map. Additionally, in one embodiment, the system comprising the sensor and processor analyzing the cognitive information for a vehicle operator, such as an automobile driver, may further comprise an output device (such as a speaker or display on a portable device) or be in communication with an output device (such as an automobile display or audio system) and warn the vehicle operator when they are approaching situations where cognitive capacity is reduced to unsafe levels or provide other feedback.

Data from the Individual

In one embodiment, decision information or information used to generate decision information is supplied by the individual. In this embodiment, the individual may supply the decision information or information used to generate decision information in one or more of the following situations: during the creation of the initial underwriting profile (such as an initial test or survey), subsequent to the creation of the initial underwriting profile (such as a subsequent test or survey); upon request by the underwriter for information directly or indirectly related to one or more aspects of the decision information; and by allowing the underwriter access to one or more data providers (such as postings by the individual on a social networking website or text, image, or video messages sent using the individual's portable or wearable device or an email account).

### Portable or Wearable Device

In one embodiment, decision information or information used to determine decision information is obtained from a portable device or wearable device. In one embodiment, the portable device or wearable device is a device readily transported by a single person and capable of providing computing operations. In one embodiment, the portable device or wearable device is a cellular phone, smartphone, personal data assistant (PDA), personal navigation device (PND) such as a GPS system, tablet computer, watch (such as a smart watch), a wearable computer, a personal display system, a personal portable computer, a laptop, head-mounted display, eyeglass display, eyewear display, contact lens with sensors, pocket computer, pocket projector, miniature projector, wireless transmitter, microprojector, headphone device, earpiece device, mobile health device or fitness band capable of storing, receiving, or transmitting health related information, handheld device, a vehicle accessory or portable device accessory such as an aftermarket device in communication with a vehicle or portable device; accessory of another portable device; or other computing device that can be transported or worn by a person.

In one embodiment, the portable or wearable device comprises one or more functional features. The one or more functional features include one or more selected from the group: display, spatial light modulator, indicator, projector, touch interface, touchscreen, finger print reader, eye tracking sensor, keyboard, keypad, button, roller, sensors, radio transceiver or receiver, speaker, microphone, camera, user interface component, headphones, and wireless or wired communication feature (such as wireless headphone, Bluetooth™ headset, wireless user interface, or other device or vehicle wirelessly communicating with the portable device).

### Sensors and Components

In one embodiment, the portable device, wearable device, vehicle or craft (such as an aircraft, watercraft, or land craft), building, structure, or computing device operatively connected to a network directly or indirectly communicates to the individual, a second device, or the underwriter decision information or information that can be used to generate decision information obtained stored on one or more non-transitory computer-readable media obtained from one or more sensors.

In another embodiment, the portable device, wearable device, vehicle, craft, building, structure, or computing device operatively connected to a network comprises one or more devices selected from the group: antenna, a Global Positioning System (GPS) sensor (which may include an antenna tuned to the frequencies transmitted by the satellites, receiver-processors, and a clock), accelerometer (such as a 3D accelerometer), gyroscope (such as a 3D gyroscope), touch screen, button or sensor, temperature sensor, humidity sensor, proximity sensor, pressure sensor, blood pressure sensor, heart rate monitor, ECG monitor, magnetoencephalography device, body temperature sensor, blood oxygen sensor, body fat percentage sensor, stress level sensor, respiration sensor, biometric sensor (such as a fingerprint sensor or iris sensor), facial recognition sensor, eye tracking sensor, acoustic sensor, security identification sensor, altimeter, magnetometer (including 3D magnetometer), digital compass, photodiode, vibration sensor, impact sensor, free-fall sensor, gravity sensor, motion sensor (including 9 axis motion sensor with 3 axis accelerometer, gyroscope, and compass), IMU or inertial measurement unit, tilt sensor, gesture recognition sensor, eye-tracking sensor, gaze tracking sensor, radiation sensor, electromagnetic radiation sensor, X-ray radiation sensor, light sensor (such as a visible light sensor, infra-red light sensor, ultraviolet light sensor, photopic light sensor, red light sensor, blue light sensor, and green light sensor), microwave radiation sensor, back illuminated sensor (also known as a backside illumination (BSI or BI) sensor), electric field sensor, inertia sensor, haptic sensor, capacitance sensor, resistance sensor, biosensor, barometer, barometric pressure sensor, radio transceiver, Wi-Fi transceiver, Bluetooth™ transceiver, cellular phone communications sensor, GSM/TDMA/CDMA transceiver, near field communication (NFC) receiver or transceiver, camera, CCD sensor, CMOS sensor, surveillance camera, thermal imaging camera, microphone, voice recognition sensor, voice identification sensor, gas sensor, smoke detector, carbon monoxide sensor, electrochemical gas sensor (such as one calibrated for carbon monoxide), gas sensor for oxidizing gases, gas sensor for reducing gases, breath sensor (such as one detecting the presence of alcohol), glucose sensor, environmental sensor, and pH sensor. The information from one or more sensors may be stored on a non-transitory computer-readable media on or in operable communication with the portable or wearable device, a remote computer or server (such as an insurer's computer or the insured's computer, for example), or an automobile or craft or device operatively connected thereto. The output information from one or more of the aforementioned sensors or devices may be used to determine neurophysiological information for one or more individuals. This neurophysiological information can be used to determine physical properties for one or more parts of the nervous system of the individual or to generate cognitive information for the one or more individuals.

Data from External Sources

In one embodiment, decision information or information used to determine decision information is obtained from an external data provider, an external data source, or an external network. External sources include data sources external to the individual such as social networks, cellular service provider networks, internet connection suppliers, email hosting service providers, website hosting service providers, government networks (such as police or homeland security networks), security camera networks, weather data networks or providers, credit card companies, geographic data providers or networks, healthcare provider network, Internet audience data aggregator or provider, internet-based services provider (such as Google Inc., Microsoft Inc., Yahoo Inc., Apple Inc., etc.), an online or brick-and-mortar merchant (such as Apple, a chain of liquor stores, a grocery store, Amazon.com, etc.), and other networks or data sources comprising information related to the individual, decision information, or information used to determine decision information.

### Portable Device

In one embodiment, a system or method for analyzing vehicle operation performance comprises a portable device. In one embodiment, the portable device is a device readily transported by a single person and capable of providing computing operations. In one embodiment, the portable device is a cellular phone, smartphone, personal data assistant (PDA), personal navigation device (PND) such as a GPS system, tablet computer, watch (such as a smart watch), a wearable computer, a personal display system, a personal portable computer, a laptop, head-mounted display, eyeglass display, eyewear display, pocket computer, pocket projector, miniature projector, wireless transmitter, microprojector, headphone device, earpiece device, mobile health device capable of storing, receiving, or transmitting health related information, handheld device, accessory of another portable device; or other computing device that can be transported or worn by a person.

In one embodiment, the portable device comprises one or more functional features. The one or more functional features include one or more selected from the group: display, spatial light modulator, indicator, projector, touch interface, touchscreen, keyboard, keypad, button, roller, sensors, radio transceiver or receiver, speaker, microphone, camera, user interface component, headphones, and wireless or wired communication feature (such as wireless headphone, Bluetooth™ headset, wireless user interface, or other device or vehicle wirelessly communicating with the portable device).

### Portable Device or Vehicle Sensors

In one embodiment, the portable device and/or vehicle comprises one or more sensors selected from the group: antenna, a Global Positioning System (GPS) sensor (which may include an antenna tuned to the frequencies transmitted by the satellites, receiver-processors, and a clock), accelerometer (such as a 3D accelerometer), gyroscope (such as a 3D gyroscope), magnetometer, touch screen, button or sensor, temperature sensor, humidity sensor, proximity sensor, pressure sensor, blood pressure sensor, heart rate monitor, ECG monitor, body temperature, blood oxygen sensor, body fat percentage sensor, stress level sensor, respiration sensor, biometric sensor (such as a fingerprint sensor or iris sensor), facial recognition sensor, eye tracking sensor, security identification sensor, altimeter, magnetometer (including 3D magnetometer), digital compass, photodiode, vibration sensor, impact sensor, free-fall sensor, gravity sensor, motion sensor (including 9 axis motion sensor with 3 axis accelerometer, gyroscope, and compass), IMU or inertial measurement unit, tilt sensor, gesture recognition sensor, eye-tracking sensor, gaze tracking sensor, radiation sensor, electromagnetic radiation sensor, X-ray radiation sensor, light sensor (such as a visible light sensor, infra-red light sensor, ultraviolet light sensor, photopic light sensor, red light sensor, blue light sensor, and green light sensor), microwave radiation sensor, back illuminated sensor (also known as a backside illumination (BSI or BI) sensor), electric field sensor, inertia sensor, haptic sensor, capacitance sensor, resistance sensor, biosensor, barometer, barometric pressure sensor, radio transceiver, WiFi transceiver, Bluetooth™ transceiver, cellular phone communications sensor, GSM/TDMA/CDMA transceiver, near field communication (NFC) receiver or transceiver, camera, CCD sensor, CMOS sensor, microphone, voice recognition sensor, voice identification sensor, gas sensor, electrochemical gas sensor (such as one calibrated for carbon monoxide), gas sensor for oxidizing gases, gas sensor for reducing gases, breath sensor (such as one detecting the presence of alcohol), glucose sensor, environmental sensor, sensors that can detect or provide information related to the blood alcohol level of the vehicle operator or the alcohol level in the air within the vehicle, and pH sensor. In another embodiment, the portable device and/or the vehicle comprise one or more sensors that monitor pulse, heartbeat, or body temperature of the individual operating the vehicle and/or portable device. In one embodiment, the portable device and/or vehicle comprise one or more sensors, such as a camera or heart rate monitor, that provides information that can be used to determine cognitive information. In this embodiment, the sensors could be used, for example, to monitor the pupil size and heart rate to help determine if the individual is using a reflexive or analytical decision making process at a particular time. If, for example, information derived from the sensor determines that the individual used a reflexive decision making process, further information from the sensor or a different sensor (or historical, environmental, or other information such as from the cognitive map of the individual) may be used to determine or determine a probability that the individual is using a particular heuristic decision making process.

The sensor providing information, such as cognitive information or information from which cognitive information may be derived, may be a component of the portable device, the vehicle, an aftermarket or accessory item of the vehicle or portable device, such as a sensor on a wireless phone (such as a smart phone), a sensor on a bracelet with a Bluetooth™ transceiver, a sensor built into the steering wheel of a vehicle (such as pulse monitor, for example) or as an aftermarket add-on to the vehicle or vehicle steering wheel, for example.

### Accelerometer Sensor

In one embodiment, the portable device and/or vehicle comprise one or more accelerometers. In one embodiment, the one or more accelerometers are selected from the group: micro electromechanical system (MEMS type accelerometer), single axis accelerometer, biaxial accelerometer, tri-axial accelerometer, 6 axis accelerometer, multi-axis accelerometer, piezoelectric accelerometer, piezoresistive accelerometer, capacitive accelerometer, gravimeter (or gravitometer), bulk micromachined capacitive accelerometer, bulk micromachined piezoelectric resistive accelerometer, capacitive spring mass base accelerometer, DC response accelerometer, electromechanical servo (Servo Force Balance) accelerometer, high gravity accelerometer, high temperature accelerometer, laser accelerometer, low frequency accelerometer, magnetic induction accelerometer, modally tuned impact hammers accelerometer, null-balance accelerometer, optical accelerometer, pendulous integrating gyroscopic accelerometer (PIGA), resonance accelerometer, seat pad accelerometers, shear mode accelerometer, strain gauge, surface acoustic wave (SAW) accelerometer, surface micromachined capacitive accelerometer, thermal (sub-micrometer CMOS process) accelerometer, IMU (inertial measurement unit), and vacuum diode with flexible anode accelerometer. In one embodiment, the portable device and/or vehicle comprise two or more different types of accelerometers. Accelerometers are sensitive to the local gravitational field and linear acceleration and can be recalibrated for linear acceleration readings and orientation using data from one or more portable device sensors, one or more vehicle sensors, and/or other external data or input, for example.

### Positioning System

In one embodiment, the portable device and/or vehicle comprises one or more sensors or components that can provide information for determining a global position or location (such as longitudinal and latitudinal coordinates), relative position or location (such as determining that the location of the portable device is near the driver's seat, the driver's left hand, or within a pocket or purse, for example), or local position or location (on a freeway, in a vehicle, on a train). In one embodiment, the portable device and/or vehicle comprise one or more Global Positioning System receivers that provide position information. In another embodiment, the portable device comprises one or more radio transceivers wherein triangulation or time signal delay techniques may be used to determine location information. Example radio transceivers that can be used to determine a position or location include radio transceivers operatively configured to transmit and/or receive radio signal in the form of one or more channel access schemes (such as Time Division Multiple Access (TDMA), Code division multiple access (CDMA), Frequency Division Multiple Access (FDMA), Global System for Mobile Communications (GSM), Long Term Evolution (LTE), packet mode multiple-access, Spread Spectrum Multiple Access (SSMA). In another embodiment, one or more radio transceivers, such as one operatively configured for Bluetooth™ or an IEEE 802.11 protocol (such as WiFi), is used to triangulate or otherwise provide information used to determine the global, local, or relative position or location information of the portable device. Other techniques which may be utilized to determine the location or position of the portable device or vehicle include computing its location by cell identification or signal strengths of the home and neighboring cells, using Bluetooth™ signal strength, barometric pressure sensing, video capture analysis, audio sensing, sensor pattern matching, video pattern matching, and thermal sensing.

### Gyroscope

In one embodiment, the portable device and/or vehicle comprise one or more sensors providing orientation information and/or angular momentum information. In one embodiment, the portable device and/or vehicle comprise one or more gyroscopes selected from the group: MEMS gyroscope, gyrostat, fiber optic gyroscope, vibrating structure gyroscope, IMU (inertial measurement unit) and dynamically tuned gyroscope.

### Compass

In one embodiment, the portable device and/or vehicle comprises an instrument that provides direction information in a frame of reference that is stationary relative to the surface of the earth. In one embodiment, the portable device and/or vehicle comprises a compass selected from the group: magnetic compass, digital compass, solid state compass, magnetometer based compass, magnetic field sensor based compass, gyrocompass, GPS based compass, Hall effect based compass, and Lorentz force based compass.

### Camera or Imaging Sensor

In one embodiment, the vehicle or portable device (or an accessory or add-on in communication with the portable device or vehicle) comprises a camera or imaging sensor that captures images that can be processed to monitor or determine (directly or in combination with other information) information such as one or more selected from the group: cognitive information for an individual, cognitive load for an individual, cognitive capacity of an individual, decision making process used by an individual, individual distraction information, identity information for the individual, use of reflexive or analytical decision making process, cognitive map information, cognitive or other information profile for an individual, environmental or contextual information, activity information, operational performance information, vehicle information, individual health or status information, location information, dangerous conditions information, and safety information.

In one embodiment, the vehicle or portable device (or an accessory or add-on in communication with the portable device or vehicle) comprises a camera that captures images or information related to the eyes, which may include, for example, pupil size, microsaccades amplitudes or frequency, eye orientation, vergence, gaze direction or duration, or an image of the iris or retina. In one embodiment, the vehicle or portable device (or accessory in communication with the portable device or vehicle) comprises one or more sensors that monitor the eyes of the vehicle operator to provide images that can be analyzed to provide cognitive information such as cognitive load, cognitive capacity, or levels of selective attention. In one embodiment, wearable glasses, eyewear, head-mounted display, or headwear comprises one or more sensors (such as a camera, or electrodes that monitor brain activity) that provide information related to cognitive information for the individual. In another embodiment, one or more eye contact lenses worn by the individual provide information related to the cognitive information for the individual. In another embodiment, a camera mounted in the vehicle, a camera built-into a phone, a camera built into a portable device, or an accessory or add-on camera in communication with a vehicle or portable device captures images that provide information related to cognitive information for the individual.

In one embodiment, the portable device, vehicle, or an accessory or add-on in communication with the portable device or vehicle, comprises a camera that captures images or information related to the portable device operator's eyes or the vehicle operator's eyes, which may include, for example, pupil size or dilation, eyelid state or motion properties (such as droopy or sleepy eyelid movement, blinking rate, or closed eyelids), microsaccades information (amplitude, frequency, or direction), eye orientation, gaze direction, an image of the iris or retina, or eye movement or fixation. One or more of these components of eye information may be used to determine that the operator is using a reflexive decision making process or analytical decision making process directly or in combination with other information such as the heart rate information for the individual or environmental information, for example. In one embodiment, the portable device, vehicle, or an accessory or add-on in communication with the portable device or vehicle comprises an imager that monitors and/or captures eye movement (or fixation) or gaze direction information that can be used directly or in combination with other information (such as environmental information) to determine a level of distracted driving which may be used directly or indirectly (such as through cognitive analysis) to determine a level of risk and or insurance premium, for example. In one embodiment, the portable device, vehicle, or an accessory or add-on in communication with the portable device or vehicle comprises an imager that monitors and/or captures pupil size or dilation information that is analyzed to determine cognitive information such as the use of reflexive or analytical decision making processes or level of attention. In one embodiment, the portable device, vehicle, or an accessory or add-on in communication with the portable device or vehicle comprises an imager that monitors and/or captures images representing the eyelid state or eyelid motion properties (such as droopy or sleepy eyelid movement, blinking frequency or speed, or closed eyelids) that can be analyzed to determine cognitive information for the individual or level of sleepiness or alert. The blinking rate, for example could also be used to identify or provide information for determining the use of reflexive or analytical decision making processes. In one embodiment, for example, the vehicle comprises a camera that captures images that are processed to determine the level of alertness for long haul truck operators and to monitor the activities of the operator, such as driving time or vehicle operational performance.

In another embodiment, the portable device, vehicle, or an accessory or add-on in communication with the portable device or vehicle comprises an imager that monitors and/or captures images that upon analysis provide microsaccade direction, amplitude and/or frequency information that can be used to determine the level of alertness or cognitive information.

In one embodiment, the camera provides identification information such as identifying the vehicle or portable device operator using facial recognition or iris recognition. In one embodiment, a system for providing insurance underwriting includes a camera that captures images that are analyzed by a processor directly or in combination with other information (such as fingerprint or other biometrics) to identify an individual operating a vehicle and associate activity information, cognitive information, performance information (such as vehicle operational performance information), environmental information, or other information disclosed herein with the individual such that information can be recorded separately for each individual.

### Pulse or Heartrate Monitor

In one embodiment, the portable device, vehicle, or an accessory or add-on in communication with the portable device or vehicle, comprises a pulse monitor or heart rate monitor. The pulse or heart rate information may be analyzed directly, or in combination with other information such as environmental information or information derived from one or more images taken by a camera, determine cognitive information (such as the use of a reflexive or an analytical decision making process), determine level of alertness or distraction/selective attention, or other information disclosed herein such as operator health information. In one embodiment, properties of the individual may be analyzed by a cognitive information algorithm and/or a distraction algorithm to generate cognitive information that may include distraction or selective attention cognitive information. In one embodiment, the pulse monitor or heart rate monitor is attached to or built-into the steering wheel of a vehicle. In another embodiment, a portable device, eyewear, headwear, head-mounted display, wrist wear (such as a watch, bracelet, or band), or other wearable device comprises the pulse monitor or heart rate monitor.

### Communication Component

In one embodiment the vehicle or portable device (or an accessory or add-on in communication with the portable device or vehicle) communicates with the vehicle's internal sensors and systems, a remote server or processor, or a second portable device using a wired connection. In another embodiment, the vehicle or portable device (or an accessory or add-on in communication with the portable device or vehicle) receives information from one or more sensors, devices, or components related to the vehicle operator's cognitive information, such as cognitive capacity, using a RF (radio frequency) transmitter or transceiver built into a driver's license, wallet or purse, portable device, wireless phone (such as a smartphone with Bluetooth™, a keychain fob, or the vehicle's wireless communication system (such as an IEEE 802.11 standard communication protocol). In this embodiment, the information received may be used to send auditory or visual information to one or more speakers or display on the vehicle or portable device (or an accessory or add-on in communication with the portable device or vehicle) to warn or inform the driver of the risk, danger, or lack thereof.

In another embodiment, the connection between portable device and the vehicle, a remote server or processor, or a second portable device is one or more selected from the group of a serial connection, asynchronous serial connection, parallel connection, USB connection, radio wave connection (such as one employing an IEEE 802 standard, an IEEE 802.11 standard, Wi-Fi connection, Bluetooth™ connection, or ZigBee connection).

In one embodiment, the portable device communicates with the vehicle, a remote server or processor, or a second portable device using one or more communication architectures, network protocols, data link layers, network layers, network layer management protocols, transport layers, session layers, or application layers.

In one embodiment, the portable device employs at least one serial communication architecture selected from the group of RS-232, RS-422, RS-423, RS-485, I²C, SPI, ARINC 818 Avionics Digital Video Bus, Universal Serial Bus, FireWire, Ethernet, Fibre Channel, InfiniBand, MIDI, DMX512, SDI-12, Serial Attached SCSI, Serial ATA, HyperTransport, PCI Express, SONET, SDH, T-1, E-1 and variants (high speed telecommunication over copper pairs), and MIL-STD-1553A/B.

In another embodiment, the portable device and/or vehicle communicates with a second device using one or more protocols selected from the group of Ethernet, GFP ITU-T G.7041 Generic Framing Procedure, OTN ITU-T G.709 Optical Transport Network also called Optical Channel Wrapper or Digital Wrapper Technology, ARCnet Attached Resource Computer NETwork, ARP Address Resolution Protocol, RARP Reverse Address Resolution Protocol, CDP Cisco Discovery Protocol, DCAP Data Link Switching Client Access Protocol, Dynamic Trunking Protocol, Econet, FDDI Fiber Distributed Data Interface, Frame Relay, ITU-T G.hn Data Link Layer, HDLC High-Level Data Link Control, IEEE 802.11 WiFi, IEEE 802.16 WiMAX, LocalTalk, L2F Layer 2 Forwarding Protocol, L2TP Layer 2 Tunneling Protocol, LAPD Link Access Procedures on the D channel, LLDP Link Layer Discovery Protocol, LLDP-MED Link Layer Discovery Protocol-Media Endpoint Discovery, PPP Point-to-Point Protocol, PPTP Point-to-Point Tunneling Protocol, Q.710 Simplified Message Transfer Part, NDP Neighbor Discovery Protocol, RPR IEEE 802.17 Resilient Packet Ring, StarLAN, STP Spanning Tree Protocol, VTP VLAN Trunking Protocol, ATM Asynchronous Transfer Mode, Frame relay, MPLS Multi-protocol label switching, X.25, Layer 1+2+3 protocols, MTP Message Transfer Part, NSP Network Service Part, CLNP Connectionless Networking Protocol, EGP Exterior Gateway Protocol, EIGRP Enhanced Interior Gateway Routing Protocol, ICMP Internet Control Message Protocol, IGMP Internet Group Management Protocol, IGRP Interior Gateway Routing Protocol, IPv4 Internet Protocol version 4, IPv6 Internet Protocol version 6, IPSec Internet Protocol Security, IPX Internetwork Packet Exchange, SCCP Signalling Connection Control Part, AppleTalk DDP, IS-IS Intermediate System-to-Intermediate System, OSPF Open Shortest Path First, BGP Border Gateway Protocol, RIP Routing Information Protocol, ICMP Router Discovery Protocol: Implementation of RFC 1256, Gateway Discovery Protocol (GDP), Layer 3.5 protocols, HIP Host Identity Protocol, Layer 3+4 protocol suites, AppleTalk, DECnet, IPX/SPX, Internet Protocol Suite, Xerox Network Systems, AH Authentication Header over IP or IPSec, ESP Encapsulating Security Payload over IP or IPSec, GRE Generic Routing Encapsulation for tunneling, IL Internet Link, SCTP Stream Control Transmission Protocol, Sinec H1 for telecontrol, SPX Sequenced Packet Exchange, TCP Transmission Control Protocol, UDP User Datagram Protocol, 9P Distributed file system protocol, NCP NetWare Core Protocol, NFS Network File System, SMB Server Message Block, SOCKS “SOCKetS”, Controller Area Network (CAN), ADC, AFP, Apple Filing Protocol, BACnet, Building Automation and Control Network protocol, BitTorrent, BOOTP, Bootstrap Protocol, CAMEL, Diameter, DICOM, DICT, Dictionary protocol, DNS, Domain Name System, DHCP, Dynamic Host Configuration Protocol, ED2K, FTP, File Transfer Protocol, Finger, Gnutella, Gopher, HTTP, Hypertext Transfer Protocol, IMAP, Internet Message Access Protocol, Internet Relay Chat (IRC), ISUP, ISDN User Part, XMPP, LDAP Lightweight Directory Access Protocol, MIME, Multipurpose Internet Mail Extensions, MSNP, Microsoft Notification Protocol, MAP, Mobile Application Part, NetBIOS, File Sharing and Name Resolution protocol, NNTP, News Network Transfer Protocol, NTP, Network Time Protocol, NTCIP, National Transportation Communications for Intelligent Transportation System Protocol, POP3 Post Office Protocol Version 3, RADIUS, Rlogin, rsync, RTP, Real-time Transport Protocol, RTSP, Real-time Transport Streaming Protocol, SSH, Secure Shell, SISNAPI, Siebel Internet Session Network API, SIP, Session Initiation Protocol, SMTP, Simple Mail Transfer Protocol, SNMP, Simple Network Management Protocol, SOAP, Simple Object Access Protocol, STUN, Session Traversal Utilities for NAT, TUP, Telephone User Part, Telnet, TCAP, Transaction Capabilities Application Part, TFTP, Trivial File Transfer Protocol, WebDAV, Web Distributed Authoring and Versioning, DSM-CC Digital Storage Media Command and Control, and other protocols known by those in the art for digital communication between two devices.

In one embodiment, the portable device and/or vehicle comprises one or more communication components selected from the group: radio transceivers, radio receivers, near field communication components, radio-frequency identification RFID components, and optical communication components (such as laser diodes, light emitting diodes, and photodetectors).

In one embodiment, one or more communication components are used to provide location information, speed location, acceleration, average acceleration, or other movement information or location information for the portable device or a vehicle transporting the portable device.

### Information Transfer Medium for Portable Device and Operator

In one embodiment, the portable device and/or vehicle comprises an information transfer medium that provides information to the operator of the vehicle, such as an alert or driving feedback. In one embodiment, the information transfer medium for transmitting information from the portable device to the operator (or from the vehicle to the operator or from the portable device to the operator via the vehicle) is one or more selected from the group: display (such as liquid crystal display, organic light emitting diode display, electrophoretic display, projector or projection display, head-up display, augmented reality display, head-mounted display, or other spatial light modulator), speaker, visible indicator (such as a pulsing light emitting diode or laser, or a light emitting region of the portable device or vehicle), and mechanical indicator (such as vibrating the portable device, a seat, or a steering wheel). In one embodiment, the portable device performs a risk assessment and provides an alert to the operator using one or more information transfer media.

### Multi-Sensor Hardware Component

In one embodiment, the portable device and/or vehicle comprises a multi-sensor hardware component comprising two or more sensors. In one embodiment, the two or more sensors measure two or more fundamentally different properties, such as a multi-sensor hardware component comprising an accelerometer and gyroscope to measure acceleration and orientation simultaneously or sequentially. In another embodiment, the two or more sensors measure properties at different times, at different portable device locations or positions, at different portable device orientations, or along different axes or directions. For example, in one embodiment, the portable device and/or vehicle comprise a multi-sensor hardware component comprising: multiple gyroscopes; multiple accelerometers; one or more accelerometers and one or more gyroscopes; one or more gyroscopes and a digital compass; or one or more gyroscopes, one or more accelerometers, and a compass. In another embodiment, one or more sensors, processors, gyroscopes, digital compasses, or global positioning systems are combined into a single hardware component (such as an integrated component that can be placed on a rigid or flexible circuit board). In one embodiment, the speed of re-calibration of the portable device movement is increased by integrating the one or more sensors (and optionally a processor) into a single multi-sensor hardware component. In one embodiment a sensor is combined with a processor in a single hardware component. In one embodiment, a portable device comprises a multi-sensor hardware component comprising a digital compass, an accelerometer, and a gyroscope.

### Software

In one embodiment, the portable device and/or vehicle comprise one or more processors operatively configured to execute one or more algorithms on input information. One or more algorithms disclosed herein may be executed on one or more processors of the portable device, the vehicle, or a remote device (such as a remote server). In one embodiment, the portable device comprises software or software components executing one or more algorithms. The software and/or data may be stored on one or more non-transitory computer-readable storage media. The software may be the operating system or any installed software or applications, or software, applications, or algorithms stored on a non-transitory computer-readable storage medium of the portable device and/or vehicle. One or more software components may comprise a plurality of algorithms, such as for example, a cognitive capacity algorithm, a cognitive load algorithm, a communication algorithm, a movement isolation algorithm, an algorithm that monitors the use of one or more software applications accessible using the portable device, an algorithm that monitors the use of one or more functional features of the portable device, an algorithm that processes data received from the vehicle, an algorithm that processes information received from a server, and an algorithm that processes information received from one or more sensors or input devices, an algorithm that analyzes or generates risk related information and/or risk scoring, an algorithm that determines risk associated with the use of one or more software applications accessible using the portable device while operating the vehicle, an algorithm that determines the risk associated with the use of one or more functional features of the portable device while operating the vehicle, an algorithm that determines levels of distracted driving, an algorithm providing an appropriate form of alert or form of information based on an increased risk or potential increased risk, an algorithm that evaluates vehicle operation performance, an algorithm that determines the location or position of the operator of the portable device, an algorithm that determines whether or not the operator of the portable device is operating the vehicle or in a position to operate the vehicle, an algorithm that determines mental or physical health condition of the operator of the portable device, an algorithm that determines the field of vision of the driver (using information derived from a camera, for example), a portable device function modification algorithm, a portable device software restriction algorithm, a legal analysis algorithm, a third party portable device restriction algorithm, and an insurance information providing algorithm.

On or more algorithms may be executed within the framework of a software application (such as a software application installed on a portable cellular phone device) that may provide information to an external server or communicate with an external server or processor that executes one or more algorithms or provides information for one or more algorithms to be executed by a processor on the portable device. One or more static or dynamic methods for providing or generating risk assessment, risk scoring, loss control, risk information, evaluating vehicle operation performance, monitoring vehicular operator behavior, monitoring portable device use behavior, providing insurance related information or adjusting the price of insurance, responding to increased operational risk for an operator of a vehicle, evaluating cognitive ability of a driver, evaluating level of distraction while driving, or other operations performed by other algorithms disclosed herein may be executed by one or more algorithms, software components, or software applications on one or more processors of the portable device and/or vehicle, a processor remote from the portable device and/or vehicle, or a processor in operative communication with the portable device and/or vehicle.

In one embodiment, the software is built into the portable device and/or vehicle; installed on the portable device and/or vehicle; second party software (such as software installed by the communication service provider for the portable device); third party software, software use monitoring software; portable device functional use monitoring software; an insurance software application; a safety application; a risk analysis application; a risk scoring application; an insurance rate calculation or indication application; a loss control assessment application; software indicating, providing an alert, or providing information related to an increased or potentially increased risk or danger for operating a vehicle; a third party restrictive software application (such as an insurance provider application restricting functions or applications while driving or a parental restriction application restricting use of applications or features); physical and/or mental health or condition monitoring software; or environmental monitoring software (such as software that analyzes weather, road conditions, traffic, etc.).

In another embodiment, the portable device and/or vehicle comprises a processor that executes one or more algorithms and/or a non-transitory computer-readable storage medium comprises one or more algorithms that analyzes data, separates data (such as an algorithm separating vehicle movement information from portable device movement information from movement information received from one or more sensors), receives data, transmits data, provides alerts, notifications or information, communicates to an insurance company or underwriter, communicates with an analysis service provider or other third party service or data provider, communicates with a data aggregator, communicates with a third party, performs risk assessments, or communicates with a second party (through an insurance carrier for example), or third party (third party risk assessor), or communicates with another vehicle or vehicle infrastructure network.

### Third Party Software

In one embodiment, the portable device and/or vehicle comprises third party software such as communication software, entertainment software, analysis software, navigation software, camera software, information gathering software, internet browsing software, or other software that provides information to the operator of the portable device by executing one or more algorithms. Other software may be installed, configured to be used on a portable device, or accessible using the portable device, such as software known in the industry to be suitable for use on a smart phone, tablet, personal computer, in a vehicle, or on a portable or wearable electronic device. In one embodiment, second party or third party software use is monitored by a monitoring algorithm.

### Monitoring Algorithm

In one embodiment, a portable device and/or vehicle comprises a processor or is in communication with a processor that executes a monitoring algorithm that performs one or more functions selected from: recording data from sensors, camera, microphone, or user interface components (touchscreen, keypad, buttons, etc.) of the portable device and/or vehicle, recording the use of portable device functions, recording the use of vehicle functions, interpreting the data recorded from sensors, and recording portable device and/or vehicle features, software, or application use.

### Vehicle

A vehicle is a mobile device or machine that transports passengers and/or cargo. The vehicle may be, for example, an automobile, an aircraft, a watercraft, a land craft, a bicycle, a motorcycle, a truck, a bus, a train, a ship, a boat, a military vehicle, a commercial vehicle, a personal vehicle, a motorized vehicle, a non-motorized vehicle, an electric vehicle a combustion powered vehicle, a hybrid combustion-electric vehicle, a nuclear powered vehicle (such as a submarine), a skateboard, a scooter, or other human or cargo transportation device or machine known to be suitable to mechanically transport people or objects.

### Vehicle Sensors

In one embodiment, the vehicle comprises one or more sensors that provide vehicle performance information, vehicle status information, operator or occupant information, situational information, or environmental information. In one embodiment, the vehicle comprises one or more sensors selected from the group: temperature sensors measuring the temperature of a location (such as the engine) or vehicle material (cooling fluid), ambient air pressure, pressure sensors, barometric pressure sensors, oxygen sensors, crankshaft position sensor, microphone, accelerometer, positioning system sensor, gyroscope, compass, magnetometer, communication sensor, turbocharger boost sensor, engine position sensor, engine speed timing sensor, synchronous reference sensor, oil pressure sensor, oil level sensor, coolant level sensor, starter lockout sensor, vehicle speed sensor, electronic foot pedal assembly, throttle position sensor, air-temperature sensor, fuel restriction sensor, fuel temperature sensor, fuel pressure sensor, crankcase pressure sensor, coolant pressure sensor, speedometer, garage parking sensor, knock sensor, video camera (visible light, infrared light, or visible and infrared light), light-detection-and-ranging LIDAR, radar, ultrasonic sensor, seat belt sensor, seat occupancy sensor, body mass sensor, occupant position sensors, airbag deployment sensor, collision sensor, face tracking sensor, gaze tracking sensor, water sensor, occupant sensor, mobile phone sensor, portable communication device sensor, blind spot sensor, lane departure sensor, ultrasonic low-speed collision avoidance sensor, photosensors (infrared, visible, and/or ultraviolet), voltage sensors, current sensors, rain sensors, fog sensors, road obstruction sensors, touch sensors, buttons, dials, levers, switches, and wireless distributed sensors.

In one embodiment, the vehicle comprises an on-board diagnostics (OBD) system. In one embodiment, the vehicle OBD system wired or wirelessly communicates information to the portable device and/or from the portable device. In another embodiment, the vehicle comprises a communication system that communicates diagnostic, environmental, operator, occupant, vehicle status, or situational information to the portable device, to a server, or to a second party or third party directly (or indirectly using another device) using a communication component of the portable device.

### Vehicle Communication Component

In one embodiment, the vehicle comprises a radio transceiver and communicates directly with a wireless communication access provider such as a cellular telephone and data service provider. In one embodiment, the vehicle comprises a communication device selected from the group: radio transceiver, radio receiver, WiFi transceiver, Bluetooth™ transceiver, near field communication device (such as RFID), optical communication component, and wired communication component. In one embodiment, the vehicle communication component is used to determine location of the operator and/or one or more occupants within vehicle, provide a communication link to a portable device, provide a communication link to an external party, provide a communication link to a vehicle infrastructure network or exchange, or provide a communication link to a communication tower for cellular voice or data communication. In one embodiment, the portable device is paired with a Bluetooth™ device that connects to the OBD II port (or other diagnostic communication port) on the vehicle. In another embodiment, pairing of the portable device and the Bluetooth™ device is automated via near field communications technology that allows the vehicle operator to simply place the portable device near the Bluetooth™ device to pair it and identify the Vehicle Identification Number (VIN) of the vehicle. In another embodiment, the portable device scans a Quick Response code (QR code) or bar code within the vehicle that pairs the portable device with the vehicle Bluetooth™ and provides the vehicle VIN.

### Information Transfer Medium for Vehicle and Operator

In one embodiment, the vehicle comprises an information transfer medium that provides information to the operator of the vehicle, such as an alert. In one embodiment, the information transfer medium for transmitting information from the vehicle to the operator is one or more selected from the group: display (such as liquid crystal display, organic light emitting diode display, electrophoretic display, head-up display, augmented reality display, head-mounted display, or other spatial light modulator), speaker, visible indicator (such as a pulsing light emitting diode or laser, or a light emitting region of the portable device or vehicle), and mechanical indicator (such as vibrating the portable device, a seat, or a steering wheel). In one embodiment, the portable device performs a risk assessment and provides an alert to the operator using one or more information transfer media.

### External Intermediate Device

In one embodiment, the system comprises a device that physically and/or wirelessly connects to the vehicle and communicates with the vehicle and the portable device. In one embodiment, the external intermediate device plugs into a vehicle or vehicle information port such as an OBD II port or has connectivity to a vehicle infrastructure network or exchange.

### Portable Device and Vehicle Movement

In one embodiment, the portable device records temporal and/or spatial movement information received from one or more portable device sensors on a non-transitory computer-readable storage medium. As used herein, “movement information” refers to information relating to the position, orientation, tilt, pitch, rotation, yaw, velocity, and/or acceleration of an object in one or more directions, such as a velocity of 60 miles per hour in a due North direction. As used herein “temporal movement information” refers to the time indexed movement information, such as temporal movement information of two meters per second in a direction due North at 1:13:25 pm Jan. 2, 2012, for example). In one embodiment, temporal and/or spatial movement related information (such as position, orientation, tilt, rotation, speed, and/or acceleration measured at specific times or intervals, for example) from one or more sensors on the portable device and/or one or more sensors on the vehicle is processed to isolate information correlating to temporal and/or spatial vehicle movement and information correlating to temporal and/or spatial movement of the portable device relative to the vehicle. In one embodiment, the isolated information correlating to temporal and/or spatial movement of the portable device is used to provide information related to temporal and/or spatial functional use or operation of the portable device (such as detecting whether the operator is viewing the screen or dropped the portable device in the vehicle at a specific time such as the time of an accident, for example). In another embodiment, the isolated information correlating to temporal and/or spatial vehicle movement is used to evaluate vehicle operation performance (such as determining the speed of the vehicle around a corner, for example). In one embodiment, the isolated information correlating to temporal and/or spatial vehicle movement and the isolated information correlating to temporal and/or spatial movement of the portable device relative to the vehicle is obtained using only sensor temporal and/or spatial movement information obtained from portable device sensors.

### Movement Isolation Algorithm

In one embodiment, the portable device comprises a processor executing a movement isolation algorithm that isolates or separates the temporal and/or spatial vehicle movement information and the temporal and/or spatial movement information of the portable device relative to the vehicle from the temporal and/or spatial movement information received from the one or more portable device sensors (and optionally from temporal and/or spatial vehicle movement information from one or more vehicle sensors). In another embodiment, the isolation algorithm isolates or separates the temporal and/or spatial vehicle movement information and the temporal and/or spatial movement information of the portable device relative to the vehicle using an external reference framework, such as the earth for example. In this embodiment, the temporal and/or spatial vehicle movement information is acquired or calculated (by a movement isolation algorithm, for example) relative to a reference framework, such as determining the vehicle speed relative to the earth in a first direction using information from one or more portable device sensors (or sensors in a vehicle or from other external devices). The temporal and/or spatial movement information of the portable device relative to an external framework (such as the earth) can be acquired or calculated (by a movement isolation algorithm, for example) and the temporal and/or spatial movement information of the portable device relative to the vehicle can be determined using the movement isolation algorithm by analyzing the temporal and/or spatial movement information of the portable device and the vehicle relative to the external framework.

In one embodiment, the movement isolation algorithm compares temporal and/or spatial movement information from one or more portable device sensors with temporal and/or spatial movement information received from one or more vehicle sensors to isolate the temporal and/or spatial portable device movement. In another embodiment, the portable device communicates the temporal and/or spatial movement information received from the one or more portable device sensors (and optionally temporal and/or spatial vehicle movement information from one or more vehicle sensors) to a processor remote from the portable device that executes the movement isolation algorithm that isolates or separates the temporal and/or spatial vehicle movement information and the temporal and/or spatial movement information of the portable device relative to the vehicle.

In one embodiment, the movement isolation algorithm removes sensor noise and contextual noise from the movement information received from the one or more portable device sensors and/or vehicle sensors. In another embodiment, the portable device orientation and movement is recalibrated frequently. In another embodiment, the portable device or vehicle comprises one or more sensors, cameras, microphones, or human interface components that determine if the portable device operator is the operator of the vehicle. In one embodiment, the movement isolation algorithm receives temporal and/or spatial movement or position related information or other information input from one or more selected from the group: portable device sensors; vehicle sensors; vehicle GPS sensors; portable device GPS sensors; external or internal data sources (such as map data stored on the portable device or obtained from a remote server); diagnostic information, human interface information, and/or sensor information received from the vehicle; diagnostic information, human interface information, and/or sensor information received from one or more portable device sensors, portable device human interface components, portable device software applications or algorithms, or a portable device software or functional use monitoring algorithm; the vehicle; a portable device processor, a vehicle processor, radio transceivers or receivers providing position and/or movement information directly or indirectly using triangulation; radio transceivers or receivers providing position and/or movement information directly or indirectly using signal delay, radio transceivers or receivers providing position and/or movement information directly or indirectly using cellular tower location information; and vehicle radio transceivers or receivers providing position and/or movement information directly or indirectly using triangulation or signal delay from wireless communication with the portable device and the vehicle radio transceivers or receivers and vehicle infrastructure networks or exchanges.

For example, in one embodiment, the movement isolation algorithm receives input from the portable device touch screen human interface device that the screen was touched at a specific time and the brief downward movement of the portable device can be isolated as portable device movement and not vehicle movement (such as when a vehicle would hit a bump in the road). In another example, GPS position information from the portable device's or vehicle's GPS sensors is analyzed and correlated to or combined with other sensor readings to correct for position errors due to sensor drift.

In another embodiment, the movement isolation algorithm applies one or more adjustments selected from the group: dynamic orientation correction, motion correction, motion compensation, motion filtering, frequency filtering, temporal filtering, spatiotemporal filtering, spatial filtering, and noise removal to the temporal and/or spatial motion information using portable device hardware, a portable device processor executing an algorithm (such as a noise removal algorithm), and/or an external processor executing an algorithm; and the motion isolation algorithm may further take into account other temporal and/or spatial movement or position related information input.

### Removing Sensor Noise

In one embodiment, the movement isolation algorithm removes sensor drift by frequently recalibrating the gyroscope and accelerometers to the direction of gravity and earth framework, compass north, and/or distance traveled (such as indicated by GPS sensors, for example). In another embodiment the movement isolation algorithm removes intrinsic high and low frequency noise due to mechanical noise, sensor noise, and thermally dependent electrical noise. In a further embodiment, the movement isolation algorithm removes contextual noise such as vehicle vibrations.

### Recalibration of Portable Device Movement

In one embodiment the portable device gyroscope and/or the vehicle gyroscope is recalibrated using hardware recalibration, software recalibration, a combination of hardware and software recalibration, or hardware accelerated recalibration. In one embodiment, the movement information from one or more portable device sensors, isolated information correlating to temporal and/or spatial portable device movement using the movement isolation algorithm, or isolated information correlating to temporal and/or spatial vehicle movement using the movement isolation algorithm is compared to the vehicle movement information obtained from one or more vehicle sensors to improve accuracy, to provide additional information for isolation or noise filtering, verify the accuracy of the isolated information, to provide correlation information or data points, or to provide information for recalibration. The orientation of the device can be recalibrated by recalibrating the data (such as providing a correction factor to the data, for example) received from one or more sensors (such as a gyroscope) or by recalibrating the sensor such that it provides recalibrated data to the one or more device components, sensors, processors, or algorithms.

### Frequency of Recalibration

In one embodiment, the portable device measures speed, position, orientation, and/or acceleration using one or more portable device sensors and if the results of the measurements are above, below, or equal to a threshold value, one or more portable device sensors (such as the gyroscope and/or the accelerometer) are recalibrated. In another embodiment, the portable device compares the current speed, position, orientation, and/or acceleration movement information using one or more portable device sensors with a previous measurement of the same movement information and the if the difference between the measured values is above, below, or equal to a threshold, the orientations of the portable device, gyroscope, and/or accelerometers are recalibrated. For example in one embodiment, when the orientation change measured using the portable device gyroscope is less than a 0.5 degree threshold from the previous measurement, the device orientation is recalibrated using a compass, gyroscope, and/or accelerometer of the device.

In one embodiment, the portable device gyroscope and/or the vehicle gyroscope is recalibrated when the portable device has a speed of zero and/or the vehicle has a speed of zero. In another embodiment, the portable device gyroscope and/or the vehicle gyroscope is recalibrated at a fixed or variable frequency when the portable device has a speed greater than zero and/or the vehicle has a speed greater than zero.

In one embodiment, the device orientation is recalibrated at a fixed or variable frequency. In one embodiment, the device orientation is calibrated at a fixed frequency (or at an average frequency during the instance of operating the vehicle and portable device simultaneously) greater than one selected from the group 0.5 Hz, 1 Hz, 2 Hz, 5 Hz, 10 Hz, 50 Hz, 100 Hz, 200 Hz, 500 Hz, 800 Hz, 1000 Hz, 1500 Hz, 2000 Hz, 5000 Hz, and 10,000 Hz.

In one embodiment, the frequency of the gyroscope recalibration is increased when portable device use is detected or based on an algorithm that calculates optimal recalibration based on prior activity history. In another embodiment, the gyroscope is recalibrated at a fixed frequency or at a portable device transition event, and the frequency is increased when a portable device operational movement event is detected. As used herein, a portable device operational movement event occurs when there is a measurement or estimation that the portable device is in motion or use. A portable device transition event occurs when the measurement or estimation of the speed of the portable device is estimated to be substantially zero (i.e. the vehicle and portable device are not moving) and the portable device is estimated or measured to not be in use. In one embodiment, the recalibration frequency is increased by a factor greater than one selected from the group: 2, 5, 10, 50, 100, 500, and 1000 when use of the portable device while operating the vehicle is detected.

In one embodiment, the portable device comprises a multi-component sensor and the time required to be moving in a constant direction is less than one selected from the group 5 seconds, 1 second, 0.5 seconds, 0.1 seconds, 0.05 seconds, 0.01 seconds, 0.005 seconds, and 0.001 seconds for a device orientation calibration accuracy greater than one selected from the group 1 degree, 0.5 degrees, 0.01 degrees along one or more axes.

### Dynamic Vehicle Movement and Portable Device Movement Isolation and Recording

In one embodiment, the vehicle movement information and portable device movement information are isolated and recorded dynamically during operation of the vehicle and portable device. The portable device and vehicle often have movement information that occurs on different time scales (different time-frequency domains) such as turning a corner or placing a speaker on the portable device up to the operator's ear. In one embodiment, the movement isolation algorithm isolates movement information correlating to movement of the portable device relative to the vehicle and/or movement information correlating to movement of the vehicle by separating the at least a portion of the movement information from one or more portable device sensors in the time domain. In one embodiment, the movement isolation algorithm separates movement information correlating to movement of the portable device relative to the vehicle from movement information correlating to movement of the vehicle; isolates the movement information correlating to movement of the portable device relative to the vehicle; isolates movement information correlating to movement of the vehicle; or filters out movement information or noise not relevant to isolating the movement information correlating to movement of the vehicle and/or movement information correlating to movement of the portable device relative to the vehicle. In one embodiment, the movement isolation algorithm selectively isolates particular movement information relative to the portable device or vehicle. In one embodiment, the movement isolation algorithm separates relevant portable device movement information from non-relevant portable device movement information. For example, an operator of an automobile slowly moving a portable device by about 1 inch left and right while not viewing the portable device (such as determined by a vehicle or portable device camera) may be filtered out of the portable movement information since it is not indicative of portable device movement while viewing the device. In another embodiment, the movement isolation algorithm separates relevant vehicle device movement information from non-relevant vehicle device movement information. For example, movement information correlating to constant speed vehicle movement in a substantially constant direction, such as a vehicle operator driving on a long, open, straight highway, may be removed from the relevant movement information or condensed to shortened representation.

In one embodiment, the movement isolation algorithm utilizes wavelet based time-frequency analysis to isolate the information in the time-frequency domain. In another embodiment, the movement isolation algorithm uses one or more mathematical filters, analysis methods, or processing methods selected from the group: Bayesian networks, Kalman filters, hidden Markov models, wavelet frequency analysis, low pass filters, high pass filters, Gaussian high pass filters, Gaussian low pass filters, and Fourier Transforms. In one embodiment, the movement isolation algorithm utilizes a plurality of mathematical filters, analysis methods, or processing methods to determine the relevant movement information. In another embodiment, one or more algorithms executed by the portable device processor performs dynamic reorientation compensation and calibration of one or more sensors (such as a gyroscope) and/or the device such that portable device does not have to be stationary relative to the vehicle to accurately monitor driving performance. In a further embodiment, one or more algorithms executed by the portable device processor performs real-time dynamic reorientation compensation and calibration of one or more sensors (such as a gyroscope) and/or the portable device.

In one embodiment, the temporal and/or spatial movement information from one or more portable device sensors or one or more vehicle sensors or other temporal and/or spatial movement information (including position information such as map information) is analyzed to estimate the type of vehicle operation (such as riding a bicycle, bus, automobile, train, plane, etc.) or operator movement (such as walking).

In one embodiment, one or more algorithms within an application (or on embedded hardware/software) executed by a processor on the portable device allow it to differentiate between vehicle movement and human use of the portable device, or movement of the portable device relative to the vehicle.

### Vehicle Operation Performance Analysis Related to Portable Device Movement, Portable Device Function Use, and Portable Device Application Use

In one embodiment, a method of analyzing risk comprises correlating driving performance with the operation of a portable device; correlating driving performance with operation of a specific application, software or function on the portable device; or analyzing the individual cognitive effort required to operate the portable device while operating the vehicle. The vehicle operation performance may be analyzed using a vehicle operation performance algorithm. The vehicle operation performance algorithm input can include information originating from one or more vehicle sensors, vehicle human interface components, portable device sensors, portable device human interface components, or devices external to the vehicle (such as speeding cameras, traffic violation reports, external map information, another vehicle, vehicle infrastructure network or exchange, or weather information, for example). For example, the vehicle operation performance analysis performed by the vehicle operation performance algorithm may include input such as accident information, speeding data, swerving information, safe driving, unsafe driving, location, route choice, parking violations, average cognitive load during a trip, or traffic information. In one embodiment, the vehicle operation performance algorithm correlates the temporal movement information with other vehicle operation performance algorithm input information to evaluate the vehicle operator performance.

In one embodiment, the vehicle operation performance analysis, risk assessment analysis, and/or risk scoring is performed by a vehicle operation performance algorithm executed on a portable device processor or a remote processor in communication with the portable device. In one embodiment, the sensor input information for the vehicle operation performance algorithm comprises sensor input information obtained exclusively from portable device sensors or movement information obtained exclusively from portable device sensors. In another embodiment, the sensor input information for the vehicle operation performance algorithm comprises sensor input information from one or more portable device sensors and one or more vehicle sensors. For example, if a vehicle operator drops the portable device while simultaneously operating the portable device and a vehicle, subsequently reaches for the device and has an accident, a movement isolation algorithm executed on the portable device could isolate the temporal and/or spatial movement information correlating to the temporal and/or spatial movement of the portable device (the acceleration of the portable device in the direction of gravity's pull corresponding to the drop of the portable device) from the temporal and/or spatial movement information correlating to the temporal and/or spatial movement of the vehicle. The vehicle operation performance algorithm could then analyze this isolated temporal and/or spatial movement information for the portable device and correlate the time of the drop to a time just prior to the accident (where the time of the accident may be determined by the algorithm by identifying the time of a sudden deceleration due to a collision or spatial collision sensor information provide from the vehicle OBD system). By estimating the causal relationship, probable causal relationship, or estimating the risk due to the occurrence (or lack of occurrence) of a positive event (no crash, safe driving behavior, etc.) or negative event (collision, speeding violation, legal infraction, etc.), the vehicle operation performance algorithm can provide risk related information for the vehicle operator that could be used, for example, to provide real-time, dynamic, event-based, irregular, or regular vehicle operation risk assessment, risk scoring, and/or insurance pricing for the operator.

### Software or Portable Device Function Monitoring

In one embodiment, the portable device comprises a processor that executes a monitoring algorithm that monitors and/or analyzes and detects the functional use of the portable device using portable device sensors (such as a motion sensors) or portable device user interface features (display, user interface accessory or wired or wirelessly connected user interface device, headset, touchscreen, keypad, buttons, etc.). In another embodiment, the portable device comprises a processor that executes a monitoring algorithm that records the use of one or more software components or algorithms accessible using the portable device. For example, in one embodiment, the monitoring algorithm analyzes the isolated information correlating to the temporal and/or spatial movement of the portable device from the movement isolation algorithm and proximity sensor and determines that the portable device has moved to a location near the ear of the operator, indicating a high likelihood of functional use of the portable device. In another embodiment, the monitoring algorithm records information corresponding to the time a first software application was started on the portable device, information corresponding to the stopping, starting, or closing of the application, interactive use of the application, background use of the application, non-interactive use of the application, duration of the use of the application, quality of application use (which can be evaluated based on a previous measurement of quality (number of typographical errors for example) or efficiency of application use (number of seconds required to input 10 words using an SMS texting application, for example). In another embodiment, the monitoring algorithm monitors vehicle sensor information (such as information from a camera processed to provide the field of view of the driver, gaze tracking, or eye-tracking) or the use of one or more vehicle operation functions (throttle position sensor, brake pedal sensor, etc.), vehicle features (windshield wiper use, turn signal use, audio system use, navigation system use, etc.) or vehicle user interface devices (display touchscreen, audio system volume dial, heated seat temperature dial, etc.) by communicating with one or more sensors or user interface components of the vehicle (such as by a wireless Bluetooth™ connection to the OBD system of the vehicle).

In another embodiment, the monitoring algorithm differentiates between voice activated software or device feature use (such as voice activated calling, texting, or navigation using the portable device or the vehicle, or using a voice active wired or wireless accessory in communication with the portable device and/or vehicle) and physical interaction with the portable device (such as by using a touchscreen), vehicle (such as by using a console), or wired or wireless accessory in communication with the portable device and/or vehicle for feature use or for use of the software application executed by a processor on the portable device and/or vehicle.

### Vehicle Operator Identification

In one embodiment, the portable device, vehicle, or system determines or estimates the probability or determines if the portable device operator is simultaneously operating the vehicle, or estimates the probability or determines if the operator of the vehicle is simultaneously operating a portable device using a vehicle operator identification algorithm. In one embodiment, the system uses proximity or location sensing to determine the location within the vehicle of the portable device while the portable device is in use and the vehicle is being operated. The proximity or location information for the portable device relative to the vehicle can be used in combination with the layout of the vehicle or system parameters for the operating position for the vehicle and the state or movement information of the vehicle and/or portable device to determine or estimate the probability that the operator of the portable device is operating the vehicle or that the operator of the vehicle is operating the portable device.

The proximity or location sensing of the portable device relative to the vehicle (or more specifically relative to the operator's seat or position for the vehicle) can be determined using radio waves, acoustic techniques, ultrasonic techniques, lidar techniques, radar techniques, imaging techniques, triangulation, signal delay methods, seat occupancy sensors, near field communications device, camera, microphone, using third party devices, a docking device or station, operator admission, operator verification or questionnaire, operator voice identification, devices or methods external to the vehicle (such as street light cameras, police cameras, police reports, etc.) or devices or methods that are part of the vehicle (such as biometric sensors, voice identification, etc.).

In one embodiment, one or more devices such as a computer chip (such as an RF sensor chip or GSM identification chip) or non-transitory computer readable media comprises electronic identification information for the vehicle operator (and optionally profile information). This information could be transmitted to or read by the vehicle, portable device or accessory in communication with the vehicle or portable device and used to identify when the vehicle operator has reached or exceeded a particular level of risk or danger, such as exceeding the driver's cognitive capacity for safe vehicle operation. In this embodiment, the vehicle, portable device, or add-on may perform an action based on the operator specific information obtained from the computer chip or non-transitory computer readable media, such as closing a particular application on a portable device, terminate a functionality on the portable device, provide a visual or auditory warning using the portable device or vehicle speaker, display, or other indicator. In one embodiment, the action is performed automatically without intervention from the vehicle operator.

### Cognitive Capacity

In one embodiment, a system processor, a portable device processor, a vehicle processor, or a processor external to the vehicle and portable device but in communication with the vehicle and/or portable device executes a cognitive capacity algorithm that estimates or measures the cognitive capacity of the individual, such as the vehicle operator and/or portable device operator. The cognitive capacity for an individual is the total amount of cognitive processing ability or mental effort a person has to expend on mental tasks at an instance in time. The cognitive capacity can be evaluated using a measurement, metric, or quantitative neurophysiological expression. In one embodiment, the cognitive capacity is estimated or determined using a cognitive capacity algorithm executed on a portable device processor, a vehicle processor, or a processor on a remote device using input information from one or more sensors and/or user interface components (on the device and/or vehicle) and optionally information from other sources (such as maps, statistical data or functions, historical vehicle operation performance data for the vehicle operator or other vehicle operators, for example). In one embodiment, the cognitive capacity of the vehicle operator and/or portable device operator is determined by measuring the heart rate (such as by one or more sensors on the steering wheel, other vehicle control device, or wearable device such as a smart watch) and blood pressure (such as by using an optical sensor on a smart watch portable device that measures the systolic and diastolic blood pressure of the wearer) and evaluating the product of the heart rate and systolic blood pressure (heart rate-blood pressure product (RPP)).

In one embodiment, the cognitive capacity for an individual is determined, at least in part, by analyzing cognitive information not derived while the individual is performing the primary or goal state activity for which the cognitive load is evaluated. For example, in one embodiment, cognitive capacity is determined using a computer test, written test, standardized test, a self-reporting mechanism, historical cognitive load measurements performing one or more physical and/or mental activities, or using cognitive map information, and the cognitive load is evaluated using eye related information (and optionally facial information) obtained from a camera while the individual is performing a primary or goal state activity such as operating a vehicle.

The cognitive capacity measurement or estimation for the individual can be made prior to performing the primary or goal state activity such as operating a vehicle. In one embodiment, the cognitive capacity is measured or estimated in a controlled environment with the operator performing one or more selected physical and/or mental tasks or activities such as may be presented by a software program and/or one or more devices. In another embodiment, the cognitive load and/or cognitive capacity is evaluated over a period of time (such as over a period of 2 weeks or 5 vehicle operations or trips) and the cognitive capacity is determined by analyzing recorded data from one or more sensors. In another embodiment, the cognitive capacity is measured or estimated by the cognitive capacity algorithm using input information from one or more selected from the group: self-report scales, response time to secondary visual monitoring task, eye deflection monitoring, difficulty scales, cognitive ability test, brain imaging techniques, magnetoencephalography (MEG), simulation performance measurements, empirical measurements of successful performances of tasks requiring cognitive loads, using a detection response task, measuring reaction time and miss rate (or other measurement of unsuccessful task completion) of a primary task while simultaneously performing a secondary task. In one embodiment, computer-based tests are used to build an initial cognitive map and cognitive capacity profile for an individual.

In one embodiment, data from one or more measurements (and optionally information from sources internal or external to the portable device and/or vehicle) is extrapolated to determine the cognitive capacity of the operator. The cognitive capacity may be evaluated based on a threshold such as a reaction time less than a first reaction time threshold and a successful response rate higher than first successful response rate (such as 90% accurate completion) or an unsuccessful response rate less than a threshold unsuccessful response rate. In one embodiment, the portable device and/or vehicle initiate a test or measurement of one or more primary and/or secondary tasks (using one or more sensors, internal or external information) to determine, estimate, and/or extrapolate the cognitive capacity of the vehicle operator and/or portable device operator. In one embodiment, the cognitive capacity algorithm measures or estimates the cognitive capacity of the operator using a historical analysis of the vehicle operation performance by the operator. In this embodiment, the analysis may include analysis of one or more successful task metrics, unsuccessful task metrics, task quality metrics, and/or vehicle operation performance task completions while operating the portable device.

In one embodiment, the cognitive capacity algorithm receives cognitive capacity input information and measures or estimates the cognitive capacity of the operator. The cognitive capacity input information may include current or historical information: received from one or more vehicles, portable devices, or external device sensors; received from one or more user interface features of the vehicle and/or portable device; received from an external server or device; related to the mental or physical condition of the operator; or related to the age, education, or health of the operator. In one embodiment, the cognitive capacity algorithm updates the estimation or measurement of the cognitive capacity of the operator at regular intervals, at irregular intervals, before operation of the vehicle or portable device, during the operation of the vehicle and/or portable device, or at times between operations of the vehicle. For example, in one embodiment, the cognitive capacity algorithm is executed on a portable device processor when one or more sensors indicate a change in physical or mental condition of the vehicle operator (such as sensors that determine sleepiness such as cameras, eye tracking software, or sensors that detect or provide information related to the blood alcohol level of the vehicle operator or the alcohol level in the air within the vehicle). In one embodiment, the cognitive load of the operator for a series of historical vehicle operation events is analyzed to estimate the cognitive capacity. In one embodiment, statistical data from measurements of the cognitive load and/or cognitive capacity of other portable device and/or vehicle operators is used to estimate or extrapolate the cognitive capacity of the vehicle operator in question. For example, the success rate or accuracy data and data corresponding to the use of one or more portable device features for a current vehicle operator simultaneously operating a portable device may be compared with similar historical data from other vehicle operators (where the cognitive capacity may be known, estimated, or validated) to estimate the cognitive capacity of the current operator. In this example, an application on a portable device may transmit current sensor, vehicle, user interface or device information to a server comprising historical cognitive load and/or cognitive capacity data correlated with a plurality of users wherein the server provides the current cognitive load, cognitive capacity, historical information, or related information (such as a new insurance rate based on the current conditions) to the portable device.

The cognitive capacity algorithm may utilize current data, historical data, empirical data, and/or predictive data to perform the analysis and generate the cognitive capacity. In one embodiment the cognitive capacity algorithm estimates or measures the cognitive capacity of the vehicle operator based on a requirement of safe operation of a vehicle. The requirement for safe operation of the vehicle may contribute a safety factor in the calculation or estimation of the cognitive capacity (the cognitive capacity for safe vehicle operation). For example, in one embodiment, the cognitive capacity algorithm applies a 90% safety factor to the current cognitive capacity value for the vehicle operator to result in a cognitive capacity value for safe vehicle operation that is 90% of the value of the cognitive capacity without accounting for a safety factor. The safety factor may be a value estimated or statistically shown to be a factor that correlates with safe vehicle operation performance when applied to a cognitive capacity value for the cognitive analysis algorithm to use to determine the risk, danger, information transfer, or response from the portable device and/or vehicle.

### Cognitive Load

In one embodiment the portable device or system comprising the portable device measures the cognitive load for vehicle operation and/or the cognitive load for portable device use (portable device feature use and/or use of one or more software applications or software components accessible using the portable device). The cognitive load for a given task refers to the amount of cognitive processing or mental effort imposed on a person's cognitive ability at an instance in time for the given task or set of tasks (such as the task of operating a vehicle or the task of operating an application or functional feature of a portable device).

The cognitive load can be evaluated using a measurement, metric, or quantitative neurophysiological expression. In one embodiment, the cognitive load is estimated or measured using a cognitive load algorithm executed on a portable device processor, a vehicle processor, or a processor on a remote device using input information from one or more sensors and/or user interface components (on one or more devices and/or the vehicle) and optionally information from other sources (such as maps, statistical data or functions, historical vehicle operation performance data for the vehicle operator or other vehicle operators, for example). In one embodiment, the cognitive load for operating the vehicle or phone use is determined or estimated by the cognitive load algorithm by measuring the operator's heart rate (such as by one or more sensors on the steering wheel, other vehicle control device, or a wearable device such as a smart watch) and the operator's blood pressure (such as by using an optical sensor on a smart watch portable device that measures the systolic and diastolic blood pressure of the wearer) and evaluating the product of the heart rate and systolic blood pressure (heart rate-blood pressure product (RPP)).

In another embodiment, the cognitive load is measured or estimated by the cognitive load algorithm from input information from one or more selected from the group: self-report scales, response time to secondary visual monitoring task, difficulty scales, cognitive ability test, brain imaging techniques, magnetoencephalography, eye deflection sensing, simulation performance measurements, empirical measurements of successful performances of tasks requiring cognitive loads, using a detection response task, measuring reaction time and miss rate (or other measurement of unsuccessful task completion) of a task. In one embodiment, the cognitive load estimation is based in part on sensor information (such as information from cameras or gaze or attention tracking systems monitoring the gaze or attention of the operator of the vehicle such as a set of glasses that monitors eye movement, and/or portable device).

In one embodiment, the cognitive load algorithm measures perceived mental effort and uses the perceived mental effort as an index for cognitive load. In another embodiment, the cognitive load algorithm measures or receives performance information related to the operational task, such as for example, the cognitive load algorithm receiving vehicle operation performance information from the vehicle operation performance algorithm. The cognitive load algorithm may utilize current data, historical data, empirical data, and/or predictive data from one or more algorithms disclosed herein to perform the analysis and generate the cognitive load.

In one embodiment, the system for evaluating risk or evaluating vehicle operation performance comprises one or more sensors that provide information to a cognitive load algorithm that provides cognitive load information for analysis (such as analysis by a cognitive analysis algorithm).

### Cognitive Load for Vehicle Operation

In one embodiment, the cognitive load for an operator operating a vehicle is measured or estimated by the cognitive load algorithm from current or historical input information from one or more selected from the group: historical cognitive load information for the operator; sensor information from portable device sensors (such as the isolated speed of the vehicle determined by a GPS sensor on the portable device, the movement isolation algorithm executed on the portable device processor, information from a portable device camera processed to determine that the operator is looking at the portable device at the current instant or for a period of time, or eye tracking or gaze sensors in a portable or wearable device), vehicle sensors (such as the vehicle GPS and accelerometer sensors, speed sensor, eye tracking sensor, rain sensors, vehicle interior temperature sensor, or information from a vehicle camera processed to determine that the operator is looking at the portable device at the current instant or for a period of time, for example), or sensors external to the vehicle and portable device (such as traffic information, weather information, or speed camera information, map information (route, topography, speed limits, etc.) obtained from a server remote from the vehicle; vehicle user interface or vehicle function feature information (such as information from the vehicle OBD system that the switch or button was pressed to roll down the windows, the vehicle display touch screen was pressed more than 10 times in a minute, the audio system loudness was selected to be greater than 50 decibels, or a switch was activated to turn on the windshield wipers, for example); vehicle condition information; vehicle operation complexity analysis; reaction time information; and historical operation performance data (such as the operator of an automobile historically drifting from their lane when answering a phone call). In one embodiment, the cognitive load algorithm correlates the temporal movement information with other cognitive load input information to determine the cognitive load.

The vehicle operation complexity analysis comprises information that relates to the current context and complexity of performing successful operation of the vehicle and may include one or more factors selected from the group: environmental factors (such as rain, condition of the road, or traffic, for example); condition of the vehicle; lane choice; route choice; statistical accident data for the vehicle; statistical accident data for the route segment; statistical accident data for time period chosen for the trip (such as a holiday weekend, rush hour, etc.); operator health information (such as vehicle operator requires glasses or contacts for safe driving); operator experience level; and trip properties (duration, distance, number of stops, start time, end time, etc.).

Two or more of the aforementioned current or historical information input used to measure or estimate cognitive load for vehicle operation or operation of a portable device while operating a vehicle may be used in combination to measure, estimate, or provide more accurate cognitive load information. For example, second input information may provide contextual information for the first task and the cognitive load may be adjusted by the cognitive analysis algorithm. For example, current vehicle operation performance information may be combined with current sensor data from the vehicle indicating that it is raining (such as windshield wiper use or rain sensors) such that the cognitive load is adjusted higher since the operator is operating the vehicle in the rain.

As an example, the cognitive load estimated by the cognitive load algorithm for operating a 1 year old vehicle on a clear sunny day at noon with no traffic on a straightaway section of a four lane highway while travelling 45 miles per hour with the radio off would be much lower than the cognitive load for operating a 15 year old vehicle in disrepair at 65 miles per hour with a high volume of traffic at night when it is raining on a curvy highway with the radio on with other factors being substantially equal.

In one embodiment, the cognitive load for operation of the vehicle is measured or estimated over a period of time (such as over a period of 2 weeks or 5 vehicle operations or trips) and the cognitive load for current operation of the vehicle is determined by analyzing the data from one or more sensors and/or user interface features and comparing the data with the historical measurements.

### Cognitive Load for Portable Device Use

In one embodiment, the cognitive load for an operator operating a software application or a functional feature of a portable device is measured or estimated by the cognitive load algorithm from current or historical input information from one or more selected from the group: historical cognitive load information for the operator (such as historically slow button pressing for text input from the keypad); sensor information from portable device sensors (such as the orientation of the portable device, number of times the touchscreen is pressed or swiped in a 30 second period, location of the portable device (in a dock, in the lap of the operator, off to the side, near the top of the steering wheel of a car, etc.); isolated speed or temporal and/or spatial movement information of the portable device determined by the movement isolation algorithm executed on a processor (portable device processor, vehicle processor, or other device processor) with input from sensors such as accelerometers, digital compass, and gyroscope sensors on the portable device; sensor information from one or more vehicle sensors (such as sensors within the vehicle triangulating the location of the portable device with respect to the vehicle, vehicle interior temperature sensors, cameras detecting the use of the left or right hand for portable device operation or that the user is wearing sunglasses (such as polarized sunglasses which can reduce display visibility for some portable display types); the use or non-use of eye glasses or contact lenses; other vehicle sensor information provided to the portable device (such as to improve or verify the accuracy of a measurement by one or more portable device sensors); portable device user interface or portable device function feature information (such as the portable device display type, display size, display pixel format, display resolution, button, screen, or user interface location on the device, volume level, brightness level, contrast level, communication protocol (such as International Telecommunications Union-Radio communications sector 4G standard or 802.11WiFi communication standard) which can affect the speed of application or feature operation and the time required for task completion or cognitive load, radio communication signal strength for the current location (which may also affect the speed of task completion), memory capacity, plug-in power adapter or docking station in use, current memory usage, maximum memory available, processor speed, sensor accuracy, battery power remaining, data input method (physical keypad, touchscreen, swipe method, etc.), voice input use, portable device display use, portable device speaker use, portable device microphone use, portable device touchscreen use, portable device user interface use; external device or accessory user interface use for interfacing with the portable device such as augmented display use (such as a HUD, wearable display, or head mounted display), user interface accuracy, user interface sensitivity, headset use, headphone use, user interface accessory use, vehicle display use, vehicle microphone use, vehicle speaker use, vehicle touchscreen use, and vehicle user interface use; portable device condition information (scratched or broken screen, sticking buttons, number of operating system failures per week, for example); portable device software complexity analysis information; reaction time information; historical portable device operation performance data (such as the operator of portable device historically driving safely while having phone conversations); historical cognitive load estimations or measurements for the portable device feature or software application for the operator and/or cognitive load data or statistical data from other operators using the same, similar, or different device and the same, similar, or different application or application type. Two or more of the aforementioned current or historical input information may be used in combination to measure, estimate, or provide more accurate cognitive load information for a task such as use of a portable device. For example, second input information may provide contextual information for the first information and the cognitive load may be adjusted by the cognitive analysis algorithm as a result. For example, current portable device operational use information including information such as the portable device set in a fixed low brightness display mode may be combined with photosensor data from the device indicating that it is a very bright ambient environment (the sun shining on the device, for example), such that the cognitive load for operating the portable device is adjusted higher since the display contrast on the portable device is reduced and the display is harder to read. In another example, cognitive load input information indicating that the operator of the portable device is texting may be analyzed with cognitive load input information indicating that the operator of the device is operating a vehicle while texting to increase the estimated cognitive load for operating the vehicle and/or the portable device (or reduce the available cognitive capacity for the operator). In this example, the estimated cognitive load or available cognitive capacity may be further adjusted based on additional cognitive load input information such as input from rain sensors indicating that the vehicle operator is operating the vehicle in the rain.

The portable device software complexity analysis comprises information relating to the degree of complex interaction required to interface with the software or algorithm accessible to the portable device and process information from the software or algorithm. The analysis may include software properties and the user interface used to access the software or software components, such as: software appearance; software font size; software icon size; which software or software components(s) are used; speed of the software execution; graphical complexity; contrast; complexity of information presented; complexity of information processing required (reading an email typically requires a higher cognitive load than viewing pictures, for example); response time required for software interface (playing a game on a portable device or talking on a cellular phone typically requires a faster reaction time than browsing through pictures by swiping the touch interface at the operator's leisure, for example); user interface method used (replying to an email by generating a text response using a portable device touchscreen requires a higher cognitive load than vocally answering a question posed during a phone call using a car's speaker system and microphone connected to a cellular phone via a Bluetooth™ connection, for example); environmental factors (such as ambient luminance levels where the display is more difficult to read on a bright sunny day than at night, ambient temperature, ambient audio loudness, bumpy road or road conditions, vehicle condition (such as windows open and vehicle speed generating interior wind, etc.); estimated, defined, or unknown duration of software use; statistical software cognitive load measurements or estimations from the operator or other operators of the software on the same, similar, or different portable devices; statistical data from the cognitive load estimated or measured for the operator or other operators using the software or function feature under one or more of the aforementioned software properties or user interface methods employed.

The measurement or estimation of cognitive load for portable device use may be measured in real time or at intervals during operation of the portable device. In one embodiment, the cognitive load for operation of the portable device is measured or estimated over a period of time, such as the period of time of the current instance use, over two or more previous use instances, or over the use instances during a period of 1 week, for example. In one embodiment, the cognitive load for current operation of the portable device is determined in part by analyzing the data from one or more sensors and/or user interface features of the portable device and comparing the data with the historical measurements.

### Cognitive Analysis Algorithm

In one embodiment, a cognitive analysis algorithm evaluates the cognitive capacity, the cognitive load for operating the vehicle and the cognitive load for portable device. As a result of the analysis performed by the cognitive analysis algorithm, the portable device or vehicle may respond with an alert or provide information using an information transfer medium; limit or modify one or more functions, features, or the ability to use one or more software or applications of the portable device; or provide information to the operator, a second party, or a third party.

In one embodiment, a system comprising a portable device measures or estimates the cognitive capacity of the operator of the portable device and/or the operator of the vehicle, measures or estimates the cognitive load for operating the vehicle safely, and the cognitive load required to operate one or more functions, features or software components or applications accessible using the portable device. In this embodiment, warnings, alerts, information, or notifications may be provided to the operator for a net deficit of cognitive attention where the result of the cognitive load for operating the portable device subtracted from the cognitive capacity of the operator is less than the cognitive load for safe operation of the vehicle. Similarly, restrictions on the use of the portable device may be implemented by the portable device based on this equation and optionally the legal status of operating the portable device while operating the vehicle for the location of the vehicle. The cognitive analysis algorithm may utilize current data, historical data, empirical data, and/or predictive data to perform the analysis.

In one embodiment, the cognitive analysis algorithm evaluates the risk associated with vehicle operation by subtracting the cognitive load for operating the portable device from the cognitive capacity of the operator and comparing the result to the cognitive load required to safely operate the vehicle simultaneously under current conditions. In this embodiment, if the result is less than the cognitive load required for safe operation of the vehicle, the portable device may provide an alert or information, the vehicle may provide an alert or information, the portable device may limit a feature or function of the portable device (such as the ability to make, receive or continue a telephone call), the portable device may limit features or functionality within the vehicle, and/or the portable device may transmit the cognitive information, related information, or other information to a remote server (such as a wireless communication service provider server or an insurance company server where the insurance rate may increase due to the indication of unsafe driving).

In one embodiment a method of generating risk related information at a first time for an operator of a vehicle comprises estimating a cognitive capacity of the operator of the vehicle; estimating a first cognitive load required for the operator to operate the vehicle; estimating a second cognitive load required for the operator to use one or more software applications accessible using a portable device or to use one or more functional features of a portable device; and generating a first risk assessment based on the difference between the cognitive capacity and a sum of the first cognitive load and the second cognitive load.

In one embodiment, a system for generating risk related information provides a response or risk related information for providing insurance to an operator of the vehicle. In one embodiment, a system for generating risk related or underwriting information for providing insurance to an operator of a vehicle comprises: a portable device comprising at least one accelerometer and a non-transitory computer-readable storage medium comprising accelerometer information received from the at least one accelerometer; a first processor executing an algorithm on the accelerometer information extracting first information correlating to the movement of a vehicle and second information correlating to the movement of the portable device relative to the vehicle; a second processor estimating a first cognitive load for the operator to operate the vehicle using the first information; a third processor estimating a second cognitive load for the operator to use one or more software applications accessible using the portable device or to use one or more functional features of the portable device; and a fourth processor estimating a cognitive capacity of the operator of the vehicle, wherein when the combination of the first cognitive load and the second cognitive load is greater than the cognitive capacity of the operator, the portable device: provides an alert to the operator; provides the first cognitive load to an external server; provides the second cognitive load to an external server; provides the cognitive capacity to an external server; modifies the functionality of the portable device; or modifies an ability of the operator to use the one or more software applications.

In one embodiment, using the cognitive analysis algorithm, the portable device and/or vehicle responds to an increased vehicle operation risk or the potential for increased vehicle operation risk. In this embodiment, the method for responding to increased operational risk for an operator of a vehicle comprises estimating a cognitive capacity of the operator of the vehicle; estimating a first cognitive load required for the operator to operate the vehicle; estimating a second cognitive load required for the operator to use one or more software applications accessible using a portable device or to use one or more functional features of a portable device; and performing an analysis of the first cognitive load, the second cognitive load, and the cognitive capacity such that when second cognitive load is greater than the difference between the cognitive capacity and the first cognitive load, an alert is provided to the operator of the vehicle, the portable device communicates information to a remote server, use of the one or more software applications is limited, or use of the one or more functional features of the portable device is limited.

In one embodiment, a method for evaluating a cognitive ability of a driver for safe operation of vehicle when using a portable device comprises estimating a cognitive capacity of the operator of the vehicle; estimating a cognitive load required for the operator to use one or more software applications accessible using the portable device or to use one or more functional features of the portable device; and deriving a cognitive reserve remaining for the operator of the vehicle to devote to safely operating the vehicle based on the cognitive capacity and the cognitive load.

In one embodiment the cognitive analysis algorithm factors into the analysis a safety factor. For example, while an analysis of the full cognitive capacity of the vehicle operator and the cognitive load for operating the portable device may suggest that there is sufficient cognitive reserve for the cognitive load for operating the vehicle, a safety factor may be applied to increase the likelihood that the vehicle will be operated safely. In one embodiment the safety factor is applied to the cognitive capacity to effectively reduce the cognitive capacity. In another embodiment, the safety factor is added to the cognitive load for operating the vehicle to effectively increase the cognitive load for safely operating the vehicle.

### Cognitive Load for Other Tasks

In one embodiment, the cognitive analysis algorithm input includes cognitive load information for one or more other tasks (such as a third task) performed by the operator at the same time as operating the vehicle and portable device (first and second tasks). In one embodiment, the cognitive load algorithm estimates or measures the cognitive load for the third task. Input information sources for estimating the cognitive load (or risk) from the third task may be from any of the aforementioned cognitive load input information sources. The cognitive load for other tasks measured or estimated by the cognitive load algorithm may be reduced from the cognitive capacity to provide a new cognitive capacity for operating the vehicle and/or portable device. Similarly, operation of the portable device may be restricted due to the cognitive load of the other task summed with the cognitive load for operating the vehicle and the result subtracted from the cognitive capacity being larger than the cognitive load estimated for operating the portable device. The cognitive load for one or more additional tasks (such as a third task) may be analyzed, estimated, or weighted using cognitive load input information for one or two tasks (such as vehicle operation use and mobile device use, for example) and additional cognitive load input information that provides contextual information for one or more tasks. Cognitive load input information related to one task may provide contextual cognitive load input information for a second task different from the first task. For example, the visor light use indicator and analysis of in-car camera images indicates the operator of the vehicle is putting on makeup (third task) with the visor in the down position while driving (first task) and using the vehicle Bluetooth microphone for a phone call (second task) all at the same time. In this example, the cognitive load for driving may be increased (or the cognitive capacity available decreased) due to reduced visibility with the driver's visor in the down position. In this example, the driver's visor in the down position provides contextual information that can increase the cognitive load for operating the vehicle and/or reduce the cognitive capacity available due to the increased cognitive load for operating the vehicle).

In another example, a vehicle mounted interior camera sensor may detect that the vehicle operator is putting on makeup or consuming food while operating the vehicle and on a phone call using the vehicle speaker and headset via a Bluetooth™ connection. In another example, the vehicle OBD system provides information to the portable device cognitive load algorithm that the vehicle operator is operating the touchscreen for the dashboard display at a continuous high rate (such as when performing numerous interactions with a navigation display or searching through numerous radio channels or interacting with a listing of available music files for the audio system).

### Risk Assessment

In one embodiment, a risk assessment is performed by a risk assessment algorithm that may include a predictive algorithm, and may use input from one or more selected from the group: cognitive analysis algorithm, monitoring algorithm, cognitive load algorithm, cognitive capacity algorithm, legal analysis algorithm, one or more other algorithms disclosed herein, information directly or indirectly from one or more devices such as a remote server or sensors or user interface devices of the portable device, vehicle, or other device. In one embodiment, the system provides a risk assessment using a risk assessment algorithm executed on a processor on the portable device, the vehicle, or a remote device. In one embodiment the risk assessment algorithm receives input in the form of historical information, current information, or predicted future information from one or more selected from the group: the vehicle operation performance algorithm; the cognitive analysis algorithm; the movement isolation algorithm; one or more sensors on the vehicle (such as information from a camera processed to provide the field of view of the driver, gaze tracking, or eye-tracking), portable device, and/or a remote device; one or more user interface components of the vehicle and/or portable device; and/or devices or servers external to the vehicle (such as servers providing data from speeding cameras, traffic violation reports, external map information, weather information; vehicle information; vehicle condition information; personal information related to the operator; environmental information; statistical or raw vehicle operation data from the current operator, or statistical or raw vehicle operation data from other vehicle operators).

In one embodiment, a risk profile and/or vehicle operation performance profile for the vehicle operator is generated using the aforementioned input to the risk assessment, the output from the risk assessment algorithm, and/or the vehicle operation performance algorithm output. The risk profile and/or vehicle operation performance profile may be used to assist in the analysis of current operational risk; used by a third party to provide a service or for other purposes (such as alerting a police officer or other drivers of dangerous driving behavior); or to assist in the determination of an appropriate price for insurance for vehicle operation for the operator, for example. In one embodiment, the risk profile comprises information input into vehicle operation performance algorithm (such as speed, acceleration rate, isolated vehicle movement information indicating a swerve, deceleration rate, for example), information output from the vehicle operation performance algorithm (such as a rating) and output from the cognitive analysis algorithm (such as the vehicle operator drives unsafely when sending text messages, receiving calls from a specific individual, or uses a specific software application on a portable device while operating a vehicle). In this embodiment, for example, the output from the cognitive analysis algorithm may be correlated with the output from the vehicle operation performance algorithm to generate a risk assessment or risk related information that can be used for a response, alert, to provide information to a second party or third party. For example, the vehicle operation performance algorithm may determine that the vehicle operator talking on the phone operates the vehicle in an unsafe manner while talking on the phone due to an increase in traffic (increased cognitive load for operating the vehicle). The information in this example, which can be generalized to conclude that the operator operates the vehicle poorly while talking on the phone in heavy traffic, can become part of the risk profile and/or vehicle operation performance profile.

In one embodiment the risk assessment algorithm assesses risk by correlating the use of the portable device (such as information correlating to the use of a function or feature of the portable device or a software component or application accessible using the portable device) with vehicle operation performance. In another embodiment the risk assessment algorithm assesses risk by correlating one or more elements of the cognitive load information (such as cognitive capacity, cognitive load for operating the vehicle, cognitive load for operating the portable device, cognitive deficit, or cognitive surplus) with vehicle operation performance.

In one embodiment, the risk assessment output from the risk assessment algorithm is a risk score, provides information used in the generation of a risk score, provides information used in the generation of insurance underwriting or pricing, provides risk related information to a second or third party, or provides information used to respond to one or more events (such as providing an alert, modifying a portable device function, or restricting the use of one or more software components or applications accessible using the portable device). In one embodiment, the risk assessment algorithm provides feedback information for the vehicle operator to identify safe operating habits (or unsafe operating habits). Similarly, the information may be used as part of a safe driving or driving instructional program or service.

In one embodiment, input information for the risk assessment algorithm comprises one or more current and/or historical information types selected from the group: operator personal information (such as age, gender, or health condition, for example, which may be obtained directly through a third party service, registration process, insurance records, or may be inferred from the cognitive capacity algorithm); environmental information (such as weather conditions, traffic condition, or vehicle condition, for example) which may be obtained directly (such as from a sensor or a remote server) or from a third party service or from the vehicle operation performance algorithm or the cognitive load information algorithm for operating the vehicle, for example; sensor information from the portable device, vehicle, or an external device; externally derived data (second party information or third party information) including empirical or statistical risk related information or vehicle operation performance information accessed from the portable device (and/or vehicle) non-transitory computer readable storage medium or from a remote server that corresponds to one or more other vehicle operators with similar personal information, with similar operational environments, with similar cognitive analyses, and/or with similar vehicle operation performance information; cognitive analysis information from the cognitive analysis algorithm; and vehicle operation performance information which may be obtained directly (such as from one or more sensors or a remote server) or from the vehicle operation performance algorithm.

In one embodiment, a system for dynamically assessing risk comprises: a portable device comprising a plurality of sensors operatively configured to provide movement information related to the movement of the portable device; and a first processor executing risk assessments at a first time and a second time, the risk assessments including the movement information and an estimation of the cognitive capacity of the operator, the cognitive load for operating the vehicle, operating vehicle features and functions, and the cognitive load for using one or more software applications accessible using the portable device or one or more functional features of the portable device.

### Legal Analysis Algorithm

In one embodiment, the system comprises a processor executing a legal analysis algorithm. The legal analysis algorithm receives input from one or more sources and determines the legal restriction for using one or more phone features or functions, one or more software components or applications, and/or one or more vehicle functions or features while operating the vehicle in its current location. In one embodiment, the legal analysis algorithm output provides information to one or more algorithms, devices, or third party devices; provides (or provides information for) an alert, a notification, or response indication information related to the legal restriction; and/or limits or prevents the use of a portable device feature or function, a vehicle feature or function, or a portable device software or software component by the portable device operator while operating the vehicle. The legal analysis algorithm may receive input information from external sources (such as a data server with mapping information and legal jurisdictional boundaries, a data server with legal information related to use of one or more portable device features or functions or a portable device software or software component by the portable device operator while operating the vehicle for one or more jurisdictions); one or more sensors or user interface components of the portable device and/or vehicle (such as a headset use indicator, voice activated dialing indicator, vehicular speaker and microphone use indicator, a touchscreen or accelerometer, for example); or one or more sensors external to the vehicle (such as a speed camera or speed detector, for example). For example, a vehicle operator operating a cellular phone by hand (determined, for example by the isolated portable device movement information from the movement isolation algorithm) in a first jurisdiction is alerted just before entering into a second jurisdiction (known using mapping information and GPS sensors) that the call must be continued using a hands-free device due to legal restrictions in the second jurisdiction (as determined for example from mapping data, GPS sensors, and a database on a remote server with jurisdictional legal restriction information). In another example, the legal analysis algorithm prevents a vehicle operator from operating the portable device without a hands-free device such as a headset or vehicle mounted speaker and microphone system in a jurisdiction that legally requires the use of a hands-free device while operating a portable device (such as a cellular phone) while operating a vehicle (such as an automobile). In another embodiment, the legal analysis algorithm determines that the vehicle operator is operating the vehicle in a dangerous and/or illegal manor and information related to the vehicle identification, location, vehicle movement information, operational performance, etc. may be transmitted to a third party (such as a law enforcement or other governmental organization).

### Predictive Model

In one embodiment, a method of generating the risk assessment, the risk score, the underwriting, or the cost of insurance for an individual comprises using a predictive model. As used herein, a predictive model is a mathematical model used to predict risk outcomes based on a retrospective analysis of factors and their correlations to actual outcomes. In one embodiment, the predictive model uses predictive analytics to determine which decision-making process is better at predicting negative decision outcomes and/or positive decision outcomes. In another embodiment, the predictive model includes one or more processes selected from the group: deriving or acquiring loss information (such as from the decision outcome information); correlating the loss information with the decision-making process and corresponding decision outcomes to derive a correlation coefficient; and generating a weighted model for factoring in more than one correlation between the decision-making process, corresponding decision outcomes, and loss information.

In one embodiment, a method of generating a risk assessment, a risk score, an underwriting, or a cost of insurance for an individual for a specific set of conditions (such as a specific occasion or a specific automobile trip, for example) comprises using a predictive model that includes correlating one or more risk-related decision-making processes and the decisions with the resulting decision outcomes. In another embodiment, a method of generating a risk assessment, a risk score, an underwriting, or a cost of insurance for an individual includes adjusting the risk assessment, the risk score, the underwriting, or the cost of insurance for an individual at a first frequency using a predictive model that includes correlating one or more risk-related decision-making processes and the decisions with the resulting decision outcomes. In a further embodiment, a method of generating a risk assessment, a risk score, an underwriting, or a cost of insurance is updated in real-time, on-demand (from the individual or the underwriter), or when the specific situation changes using a predictive model that includes correlating one or more risk-related decision-making processes and the decisions with the resulting decision outcomes. In one embodiment, the predictive model is incorporated into a predictive model algorithm that is stored on a non-transitory computer-readable media on or in operable communication with the portable or wearable device, a remote computer or server (such as an insurer's computer or the insured's computer, for example), or an automobile or craft or device operatively connected thereto. The predictive model algorithm may be executed by one or more processors on or in operable communication with the portable or wearable device, a remote computer or server (such as an insurer's computer or the insured's computer, for example), or an automobile or craft or device operatively connected thereto. In another embodiment, the predictive model algorithm is incorporated into the decision-making process algorithm.

### Propensity Model

In one embodiment, a method of generating the risk assessment, the risk score, the underwriting, or the cost of insurance for an individual comprises using a propensity model. As used herein, a propensity model is a mathematical model that prospectively determines an outcome or desired outcome given a certain set of conditions or a certain set of conditions in conjunction with a set of influencing factors. In one embodiment, the propensity model prospectively determines specific outcomes based on applying generalized or individualized risk profiles to a set of conditions to calculate the probability of an individual taking a particular action or producing a particular outcome. These probabilities may be used to determine the risk assessment, the risk score, the underwriting, or the cost of insurance

In one embodiment, heuristics and cognitive maps are used to develop propensity models that can predict a person's risk-seeking or risk-averse actions given a set of conditions or particular context. In one embodiment, risk-related decision information (such as contextual information, cognitive information, and/or risk or loss exposure information for a situation) for an individual is input into a propensity model to determine the probability of an individual making a risk-related decision that results in a negative decision outcome or positive decision outcome for the situation. In another embodiment, risk-related decision information (such as contextual information, cognitive information, and/or risk or loss exposure information for a situation) for a group of individuals is input into a propensity model to determine the probability of one or more individuals making a risk-related decision that results in a negative decision outcome or positive decision outcome for the situation. In one embodiment, the propensity model is incorporated into a propensity model algorithm that is stored on a non-transitory computer readable medium on or in operable communication with the portable or wearable device, a remote computer or server (such as an insurer's computer or the insured's computer, for example), or an automobile or craft or device operatively connected thereto. The propensity model algorithm may be executed by one or more processors on or in operable communication with the portable or wearable device, a remote computer or server (such as an insurer's computer or the insured's computer, for example), or an automobile or craft or device operatively connected thereto. In another embodiment, the propensity model algorithm is incorporated into the decision-making process algorithm.

### Predictive Factors

In one embodiment, method of generating the risk assessment, the risk score, the underwriting, or the cost of insurance for an individual comprises using positive and/or negative predictive factors that have a direct or indirect influence on generating positive decision outcomes or negative decision outcomes. In one embodiment, the method of generating the risk assessment, the risk score, the underwriting, or the cost of insurance for an individual comprises includes one or more of the steps using predictive factors selected from the group: identifying one or more positive predictive factors or negative predictive factors from the decision information (such as contextual information); correlating one or more positive predictive factors or negative predictive factors with negative decision outcomes or positive decision outcomes; providing feedback (such as risk-related decision information feedback) related to one or more the predictive factors to the individual; inducing and/or encouraging the individual to modify their behavior or their use of one or more risk-related decision processes (such as through punishment, reward, negative reinforcement, or positive reinforcement) to achieve one or more positive decision outcomes and/or eliminate one or more negative decision outcomes; and providing direction and/or resources for the individual to modify their behavior or their use of one or more risk-related decision processes to achieve one or more positive decision outcomes and/or eliminate one or more negative decision outcomes. In another embodiment, a method of behavior modification uses one or more of the aforementioned steps using predictive factors. In a further embodiment, a method of providing feedback to an individual uses one or more of the aforementioned steps using predictive factors.

### Negative Predictive Factors

In one embodiment, one or more negative predictive factors are identified and used for generating the risk assessment, the risk score, the underwriting, or the cost of insurance for an individual. As used herein, negative predictive factors are factors that are correlated to a negative decision outcome or negative outcome (such as a loss). For example, in the context of providing automobile insurance, running late for work (contextual information that is a negative predictive factor) and deciding to speed may result in the car accelerating beyond the speed limit and having an increased likelihood of having an accident (negative decision outcome) such that the vehicle could crash (negative outcome and loss).

In one embodiment, a method of generating the risk assessment, the risk score, the underwriting, or the cost of insurance for an individual comprises identifying one or more negative predictive factors and correlating the one or more negative predictive factors with one or more negative decision outcomes or negative outcomes. In another embodiment, this method further comprises one or more steps selected from the group: providing feedback to the individual related to the one or more negative predictive factors; inducing and/or encouraging the individual (such as through punishment, reward, negative reinforcement, or positive reinforcement) to modify their behavior or their use of one or more risk-related decision processes to achieve one or more positive decision outcomes and/or eliminate one or more negative decision outcomes; or providing direction and/or resources for the individual to modify their behavior or their use of one or more risk-related decision processes to achieve one or more positive decision outcomes and/or eliminate one or more negative decision outcomes.

For example, in the context of automobile insurance, by analyzing data from portable devices and telematics devices in a vehicle, it is determined that when a specific individual uses a social networking site before leaving home in the morning they have a higher likelihood of being late for work, and that when they are running late for work (contextual information) they have a higher incidence of speeding. In this example, running late for work is identified as a negative predictive factor for a decision to speed and an increased likelihood of having an accident (negative decision outcome). In this example, the individual may be encouraged to change their behavior when the indirect action (using the social networking application in the morning before work) results in the negative factor (running late for work) that results in a higher incidence of deciding to speed and increased likelihood of having an accident (negative decision outcome). For example, software on the individual's portable device may generate a notification (feedback) suggesting that the individual use the application later so that they are not late for work when they try to open a social networking site on the portable device in the morning before leaving for work.

In one embodiment, cognitive information is analyzed to determine one or more correlations between the cognitive information and negative decision outcomes or negative outcomes. These correlations are negative cognitive predictive factors. In one embodiment, the one or more negative cognitive predictive factors are used to provide feedback, encourage behavior, modify behavior, or provide direction and/or resources for the individual to modify their behavior.

### Positive Predictive Factors

In one embodiment, one or more positive predictive factors are identified and used for generating the risk assessment, the risk score, the underwriting, or the cost of insurance for an individual. As used herein, positive predictive factors are factors that are correlated to a positive decision outcome or positive outcome (such as no loss or loss prevention). For example, in the context of providing automobile insurance, a decision to pull over to take a phone call or call a person back instead of answering a call (positive factors) may result in safe operation of a vehicle and reduced likelihood of having an accident (positive decision outcome) such that the vehicle safely completes a trip without incident (positive outcome and no loss).

In one embodiment, a method of generating the risk assessment, the risk score, the underwriting, or the cost of insurance for an individual comprises identifying one or more positive predictive factors and correlating the one or more positive predictive factors with one or more positive decision outcomes or positive outcomes. In another embodiment, this method further comprises one or more steps selected from the group: providing feedback to the individual related to the one or more positive predictive factors; inducing and/or encouraging the individual (such as through punishment, reward, negative reinforcement, or positive reinforcement) to modify their behavior or their use of one or more risk-related decision processes to achieve one or more positive decision outcomes and/or eliminate one or more negative decision outcomes; or providing direction and/or resources for the individual to modify their behavior or their use of one or more risk-related decision processes to achieve one or more positive decision outcomes and/or eliminate one or more negative decision outcomes.

For example, in the context of automobile insurance, by analyzing data from a cellphone and telematics device in a vehicle, one can determine that when an individual operating a vehicle decides to pull over to send a text message on their cellphone (positive predictive factor) they have a decreased likelihood of having an accident (positive decision outcome). In this example, the individual may be encouraged to continue their positive predictive factor behavior of pulling over to send a text message to decrease the likelihood of having an accident. For example, software on the individual's phone may generate a notification (feedback) suggesting that the individual pull over after starting a text message application on a phone while operating a vehicle. Also, after pulling over and completing a text message, a notification (feedback) may appear on the phone thanking the individual for the safe behavior.

In one embodiment, cognitive information is analyzed to determine one or more correlations between the cognitive information and positive decision outcomes or positive outcomes. These correlations are positive cognitive predictive factors. In one embodiment, the one or more positive cognitive predictive factors are used to provide feedback, encourage behavior, modify behavior, or provide direction and/or resources for the individual to modify their behavior. For example, in one embodiment a positive correlation is identified between individuals who tend to be better than most at a specific discipline or skill (such as cognitive capacity or mental focus) and safe driving. In this example, an insurance underwriter may set-up an award or discount program for the cost of automobile insurance for individuals who improve their performance in a specific discipline or skill (such as an improvement cognitive capacity through the use of cognitive enhancement games or puzzles) and expect to see an improvement in safe vehicle operation by the individual over time. In one embodiment, a resource may be provided to the individual to help modify their behavior and/or improve their cognitive ability. The resource may include training (such as risk avoidance training, for example), an application, seminar, instructional media, a game, a puzzle, cognitive enhancement application or tool, behavior modification application or tool, or other resource known to modify behavior and/or facilitate enhancement of cognitive ability. For example, a free mathematical puzzle application for a smartphone (such as a Sudoku application) may be offered to the individual and after installing opening the application, the individual's identity is verified (such as by using the built-in camera and facial recognition), and improved puzzle performance is rewarded by discounts to their automobile insurance.

### Third Party Portable Device Restriction Algorithm

In one embodiment, the system comprises a processor executing a third party portable device restriction algorithm. The third party portable device restriction algorithm receives input from one or more third party sources and restricts or prevents the use of one or more portable device features or functions or one or more portable device software or software components by the portable device operator while operating the vehicle. In one embodiment, the third party portable device restriction algorithm output provides information to one or more algorithms, devices, or third party devices; provides (or provides information for) an alert, notification, or response indication information related to a third party restriction; and/or limits or prevents the use of a portable device feature or function, or the portable device software or software component by the portable device operator while operating the vehicle. The third party portable device restriction algorithm may receive input information from external sources such as a data server with mapping information and third party restrictions (such as a phone feature use restriction while operating the vehicle on a highway according to guardian restrictions); a server providing restricted phone features or software application usage restrictions for a specific automobile insurance plan; or a server providing business entity phone feature, function, or portable device software component or application use restrictions while operating a business entity vehicle, for example. Additionally, the third party portable device restriction algorithm may receive input information from one or more sensors or user interface components of the portable device and/or vehicle (such as a headset use indicator, voice activated dialing indicator, vehicular speaker and microphone use indicator, a touchscreen or accelerometer, for example); one or more sensors external to the vehicle (such as a speed camera or speed detector, for example). For example, a vehicle operator may be restricted from operating a cellular phone by hand (determined, for example by the isolated portable device movement information from the movement isolation algorithm) due to restrictions required to maintain a specific insurance rate. In another example, a minor may be prohibited from using a phone to make or receive a call when the third party portable device restriction algorithm determines that the vehicle is traveling at rate greater than 40 miles per hour and the minor's parents have this restriction as programmed on the device or indicated from information from a remote server.

### Punishment and Reward System

In one embodiment, a punishment system and/or reward system is used to modify the behavior of an individual. A punishment system may be used to modify the behavior of individuals exhibiting risk-seeking behavior and/or a reward system may be used to modify the behavior of individuals exhibiting risk-averse behavior.

In one embodiment, a method of determining or providing a risk assessment, a risk score, an underwriting, a cost of insurance, or a reward or punishment for an individual with insurance comprises one or more punishment systems or reward systems selected from the group: punishment (or negative reinforcement) for continued use of negative predictive factors; punishment (or negative reinforcement) for discontinuing use of positive predictive factors; punishment (or negative reinforcement) for a reduction in activities that lead to positive predictive factors; punishment (or negative reinforcement) for an increase in activities that lead to negative predictive factors; reward (or positive reinforcement) for continued use of positive predictive factors; reward (or positive reinforcement) for discontinuing use of negative predictive factors; reward (or positive reinforcement) for a reduction in activities that lead to negative predictive factors; and reward (or positive reinforcement) for an increase in activities that lead to positive predictive factors.

In one embodiment, the punishment or negative reinforcement includes one or more selected from the group: increase in the cost of insurance, absence of positive feedback, negative feedback, a financial fee or penalty, restriction of one or more activities (such as restricting the use of a specific software application while operating a vehicle or at other times), notification of an individual (such as a parent) of a negative decision outcome, notification of a company or organization (such as the insurance underwriter or government organization) of a decision related information such as a negative decision outcome, cancellation or negative modification of the insurance policy, and requiring specific actions before continuing the insurance policy or before reducing the cost of insurance that may have increased (such as requiring specific training or completion of specific tasks).

In another embodiment, the reward or positive reinforcement includes one or more selected from the group: decrease in the cost of insurance, positive feedback, a financial credit or discount, removal of a restriction of one or more activities (such as allowing the use of a specific software application while operating a vehicle or at other times), notification of an individual (such as a parent) of decision related information such as a positive decision outcome, notification of a company or organization of a positive decision outcome (such as the insurance underwriter or government organization), continuation or positive modification of the insurance policy, and not requiring specific actions before continuing the insurance policy or before reducing the cost of insurance that may have increased (such as not requiring specific training or not requiring completion of specific tasks).

Communication with Remote Server

In one embodiment, a processor on the portable device and/or vehicle sends or receives information from a server remote from the vehicle. In one embodiment, the portable device transmits information to the vehicle and the vehicle transmits information to a remote server, or the vehicle receives information from a remote server and transmits information to the portable device. In one embodiment, the server is a third party server such as a third party risk assessor server, a computing services provider sever (such as a cloud computing server), a remote configuration server, a data aggregator server, a third party risk assessor server, a government server; a local, state, or federal police, law enforcement or security server, a party of interest (such as a parent or guardian), or a second party server (such as an insurance company server, a server of a vehicle lessor, a server of an employer of the vehicle operator or the vehicle owner, the server of a cellular phone voice and/or data server provider, the operating system provider for the portable device, the portable device hardware provider, or the software application provider). In one embodiment, the communication with one or more remote servers is facilitated through the use of radio signals in the form of one or more channel access schemes, data protocols or transmission methods such as packet oriented mobile data service on a cellular communication system (such as general packet radio service GPRS) or a mobile phone mobile communication technology standard (such as 4G or Mobile WiMAX,) or other communication standard such as IEEE 802.11 or WiFi. The form of the data or data packet may include short messaging service, multimedia messaging service, html data, file transfer protocol (FTP), Transmission Control Protocol (TCP) and/or Internet Protocol (IP), or other known communication technology, protocol, method, carrier, or service.

In one embodiment the communication with the server occurs during the operation of the vehicle and/or portable device, in real time, at fixed or irregular intervals (such as once an hour) or periods of time (such as the last day of the calendar month), or before or after a trip or vehicle operation session. In one embodiment, data recorded by the portable device and/or vehicle is recorded and transmitted at a particular event or time interval.

### Insurance Underwriting Based on Driver Performance

In one embodiment, the risk assessment provides information for insurance underwriting for the vehicle operator. In one embodiment, the insurance model is a try before approval for underwriting where information (such as risk assessment information or vehicle operation performance information) is collected from the portable device (and/or vehicle) over a period of time in order to evaluate the risk and/or driver performance before underwriting and/or before setting the price for underwriting. In another embodiment, the vehicle operator may operate the portable device and/or vehicle during a probationary period. In another embodiment, the vehicle operator may operate the portable device and/or vehicle as remediation or as a condition of being able to keep insurance coverage wherein one or more algorithms suggests corrective actions to improve safe vehicle operation (such as by indicating to stop using one or more portable device features or functions, for example) and can report driving performance back to the insurer. In another embodiment, the insurance rate and/or risk information is updated and/or communicated in real-time or adjustments to the insurance rate or risks are performed every minute, hourly, daily, monthly, quarterly, or yearly while operating the vehicle and/or while not operating the vehicle.

### Feedback to the Individual

In one embodiment, a method of generating a risk score, a cost of insurance, or a risk score and a cost of insurance for at least one individual includes providing input or feedback to the individual through one or more methods that make the individual aware of one or more risk-taking behaviors. In one embodiment, the method of providing feedback includes one or more selected from the group: visual notification (such as on a portable device display), auditory notification (such as a portable device providing an audible alert), sensory notification (such as the portable device vibrating), and an indirect notification (such as allowing or disallowing the use of an portable device software application or feature). The form or delivery of the feedback may take many forms, such as an SMS text message; email, pop-up notification; an application changing the display to indicate a representation of feedback; a web based application or a report with results and/or analysis of recent risk-related behavior negative predictive factors, negative decision outcomes, negative outcome information, or other decision information; suggestions or directions for improvement or behavior modification; provided in real-time; provided at regular intervals; or provided after a specific triggering event.

In one embodiment, the feedback to the individual is determined and/or executed using a feedback algorithm that is stored on a non-transitory computer readable medium on or in operable communication with the portable or wearable device, a remote computer or server (such as an insurer's computer or the insured's computer, for example), or an automobile or craft or device operatively connected thereto. The feedback algorithm may be executed by one or more processors on or in operable communication with the portable or wearable device, a remote computer or server (such as an insurer's computer or the insured's computer, for example), or an automobile or craft or device operatively connected thereto. In another embodiment, the feedback algorithm is incorporated into the decision-making process algorithm.

### Portable Device Operator Alert

In one embodiment, the portable device and/or vehicle provide an alert, notification, or information using an information transfer medium. In one embodiment, the alert, notification, or information transfer medium comprises information that alerts the operator of the portable device to increased risk or danger associated with the use of one or more software applications or one or more functional features of the portable device during the operation of the vehicle. In another embodiment, the alert, notification, or information transfer medium comprises information that alerts the operator to allowed, disallowed, legal, or illegal portable device functional features or software applications. In a further embodiment, the alert, notification, or information transfer medium comprises information that alerts the portable device operator (before or during operation of a vehicle) based on a potential danger, risk assessment, third party restriction, insurance rate plan restriction, or illegal activity when entering (or a plan or route suggests entering) an area where the use of one or more software applications or one or more functional features of the portable device during the operation of the vehicle. In a further embodiment, an application executed on the portable device or vehicle alerts, notifies, or provides information through an information transfer medium that indicates permissibility of activities such as texting, emailing, navigating, talking while driving, etc. based on the current location and/or expected route of travel.

In one embodiment, the alert, notification, or information transfer medium comprises information that alerts the operator of the portable device to potentially dangerous vehicle (or portable device) operation based on information received from one or more sensors. Examples of sensor information include a vehicle camera detecting that the vehicle is about to cross the median, sensor information from an onboard vehicle camera suggests the driver may be falling asleep, sensor information from a portable device or vehicle camera that the operator has been viewing the portable device for a long time period, or dangerous swerving detected while texting using a phone. In one embodiment, the alert, notification, or information transfer medium provides information on the occurrence of the dangerous/banned/illegal/restricted activity, suggests a corrective action (displaying the text “Please slow down,” for example), and/or indicates the consequence of the activity (such as an displaying an increased insurance rate or text message notification sent to a third party (such as a guardian) when the operator exceeded a speeding restriction, for example).

In one embodiment, the alert, notification, or information transfer medium is the result of output from one or more algorithms. In one embodiment, the alert, notification, or information transfer medium comprises information that indicates the urgency of incoming communication or information, such as a phone call (for which the cell phone operator may pre-select urgency or priority levels for calls from specific people, groups, or phone numbers, for example), dangerous weather warning from a third party server, or serious traffic problem from a third party server, for example. In one embodiment, the analysis for determining one or more selected from the necessity, the information, and the method of the alert, notification, or information transfer medium is performed by an algorithm executed by a portable device processor, vehicle processor, and/or remote device processor. For example, in one embodiment, an application executed on a cellular phone alerts the vehicle operator to dangerous weather conditions ahead by displaying text information on the dashboard display. In another example, an application executed on a cellular phone: determines the need for an alert indicating that texting while operating the vehicle in the current location is illegal; determines the information to be provided (“Texting while driving is illegal in this county”, for example); and determines the method of delivery (such as a text to voice audio notification delivered from the cellular phone to the speakers of the automobile through a Bluetooth™ connection).

In a further embodiment, the cognitive analysis algorithm, the vehicle operation performance algorithm, the risk performance algorithm, or other algorithm performs a risk assessment and one or more algorithms executed on the portable device or vehicle provides information or a warning of the danger of operating one or more functional features or software components or applications (on the portable device or vehicle) while driving under the current (or future expected) operator or environmental conditions. In this embodiment, one or more of the algorithms may utilize information from the vehicle operator profile that can contain current and historical physical, mental, and cognitive information for the vehicle operator and historical data or statistical data from one or more other vehicle operators operating under similar physical, mental, cognitive, or environmental conditions.

In one embodiment, the vehicle or portable device (or an accessory or add-on in communication with the portable device or vehicle) warns the vehicle operator that they are operating the vehicle while approaching their cognitive capacity and may optionally restrict the use of vehicle or portable device applications or functionality. In one embodiment, the vehicle automatically pulls itself over until such time that the cognitive capacity for the vehicle operator is sufficient.

### Portable Device Function Modification

In one embodiment, portable device functions or portable device software restrictions are controlled at least in part by a third party such as a parent, guardian, insurer, or employer. In this embodiment, the third party may manage the portable device functions or software restrictions directly, indirectly, or using a risk analysis that may utilize a cognitive analysis. The management may be performed directly on the device, remotely through wired or wireless communication, using a web or software application interface, in real-time, automatically, manually, or using instructions, conditions, settings, or algorithms pre-loaded onto the device or transmitted remotely.

In one embodiment, a portable device function modification algorithm executed on a portable device processor modifies (and/or provides information related to) the ability of the portable device operator to use one or more specific portable device functions or portable device features while the portable device operator is operating the vehicle based on a risk assessment, legal restriction, or third party restriction. In one embodiment, the portable device function modification restricts or limits the ability to use; prevents the ability to use; permits use only when criteria are met, prevents or limits the ability to use for a period of time; provides an indicator of one or more primary data sources or data used to determine the risk (such as an indication of the speed, indication of an insurance plan restriction (optional or mandatory), indication of legal restriction, or map indicating the boundary of the legal restriction, for example); suggests one or more actions to reduce or eliminate the restriction; and/or provides an indication of a potential restriction (such as an indicator that a future or current phone call cannot be answered based on the current operator, vehicle, environmental, or third party conditions or restrictions).

In one embodiment, the portable device function modification algorithm is a stand-alone algorithm that may be executed by one or more algorithms or devices. In another embodiment, the portable device function modification algorithm is integrated with one or more other algorithms, such as the risk assessment algorithm, the cognitive analysis algorithm, the monitoring algorithm, the portable device software restriction algorithm, or the vehicle operation algorithm, for example.

In one embodiment, the portable device function modification algorithm is continuously executed when the portable device is turned on. In one embodiment, the portable device function modification algorithm may be running in the background when the portable device is powered on, when the device is in a stand-by mode, and/or when the portable device is being actively operated, for example). In another embodiment, the portable device function modification algorithm begins execution of the restriction when the portable device operator enters or operates a vehicle with the portable device turned on. In a further embodiment, a third party or remote algorithm (such as an algorithm on a remote server or an algorithm on a vehicle processor in communication with the portable device) turns on or instructs the portable device to execute the portable device function modification algorithm. In a further embodiment, the portable device function modification algorithm is executed on a server remote from the vehicle and instructions to modify one or more functions or features of the portable device are sent to the portable device (directly or indirectly).

In one embodiment, the portable device function modification algorithm comprises input in the form of historical information, current information, or predicted future information from one or more selected from the group: the vehicle operation performance algorithm; the cognitive analysis algorithm; the movement isolation algorithm; one or more sensors on the vehicle, portable device, and/or a remote device; one or more user interface components of the vehicle and/or portable device; and/or devices or servers external to the vehicle (such as servers providing data from speeding cameras, traffic violation reports, external map information, weather information, statistical or raw vehicle operation data from the current operator (such as historical vehicle operation performance for the operator), or statistical or raw vehicle operation data from other vehicle operators). In one embodiment, the modification policy or restriction is determined by the operator or owner of the portable device or vehicle, a third party (such as a parent or guardian, a business supervisor, or insurance company) and may be configured on the portable device, controlled by a remote server (such as a third party server for an insurance company), or managed by the operator of the portable device and/or vehicle.

### Portable Device Software Restriction

In one embodiment, a portable device software restriction algorithm executed on a portable device processor modifies (and/or provides information related to) the ability of the portable device operator to use one or more specific portable device software components or applications while the portable device operator is operating the vehicle based on a risk assessment, legal restriction, or third party restriction. In one embodiment, the portable device software restriction algorithm restricts or limits the ability to use; prevents the ability to use; permits use only when criteria are met, prevents or limits the ability to use for a period of time; provides an indicator of one or more primary data sources or data used to determine the risk (such as an indication of the speed, indication of an insurance plan restriction (optional or mandatory), indication of legal restriction, or map indicating the boundary of the legal restriction, for example); suggests one or more actions to reduce or eliminate the restriction; and/or provides an indication of a potential restriction (such as an indicator that a future or current instance or operation of the software component or algorithm is restricted based on the current operator, vehicle, environmental, or third party conditions or restrictions).

In one embodiment, the portable device software restriction algorithm is a stand-alone algorithm that may be executed by one or more algorithms or devices. In another embodiment, the portable device function algorithm is integrated with one or more other algorithms, such as the risk assessment algorithm, the cognitive information algorithm, the cognitive analysis algorithm, the monitoring algorithm, the portable device function modification algorithm, or the vehicle operation algorithm, for example.

In one embodiment, the portable device software restriction algorithm is continuously executed when the portable device is turned on. In one embodiment, the software restriction algorithm may be running in the background when the portable device is powered on, when the device is in a stand-by mode, and/or when the portable device is being actively operated, for example). In another embodiment, the portable device software restriction algorithm begins execution of the restriction when the portable device operator enters or operates a vehicle with the portable device turned on. In a further embodiment, a third party or remote algorithm (such as an algorithm on a remote server or an algorithm on a vehicle processor in communication with the portable device) turns on or instructs the portable device to execute the portable device software restriction algorithm. In a further embodiment, the portable device software restriction algorithm is executed on a server remote from the vehicle and instructions to restrict the software component or application are sent to the portable device (directly or indirectly).

In one embodiment, the portable device software restriction algorithm comprises input in the form of historical information, current information, or predicted future information from one or more selected from the group: the vehicle operation performance algorithm; the cognitive information algorithm which generates cognitive information; the cognitive analysis algorithm which analyzes cognitive and optionally other information; the movement isolation algorithm; one or more sensors on the vehicle, portable device, and/or a remote device; one or more user interface components of the vehicle and/or portable device; and/or devices or servers external to the vehicle (such as servers providing data from speeding cameras, traffic violation reports, external map information, weather information, statistical or raw vehicle operation data from the current operator (such as historical vehicle operation performance for the operator), or statistical or raw vehicle operation data from other vehicle operators). In one embodiment, the restriction is determined by the operator or owner of the portable device or vehicle, a third party (such as a parent or guardian, a business supervisor, or insurance company) and may be configured on the portable device, controlled by a remote server (such as a third party server for an insurance company), or managed by the operator of the portable device and/or vehicle.

### Algorithms and Software

In one embodiment, two or more of the aforementioned algorithms are executed by a single algorithm which may be one of the aforementioned algorithms. For example, in one embodiment, the cognitive load algorithm, cognitive capacity algorithm, cognitive analysis algorithm may be integrated into a cognition algorithm which along with a vehicle operation algorithm is part of an insurance company software application installed on a cellular phone non-transitory computer-readable storage medium and executed by the cellular phone processor. Two or more algorithms may transmit, receive, and/or share instructions, input, or output from one or more other algorithms. In one embodiment, a software application installed on a portable device comprises one or more of the aforementioned algorithms integrated into the software application or in communication with the application software.

In one embodiment, one or more of the algorithm's instructions; the input information received by one or more algorithms, and/or the information output transmitted from one or more algorithms is updated autonomously, updated on demand, manually updated, updated by a remote server (such as a third party insurance company server), periodically updated, configured by the portable device operator, a second party (such as a cellular phone data service provider or the operating system software provider or update service, for example), or a third party (such as an insurance company provider).

In one embodiment, one or more of the aforementioned algorithms is continuously executed when the portable device is turned on. In one embodiment, one or more of the aforementioned algorithms may be running in the background when the portable device is powered on, when the device is in a stand-by mode, and/or when the portable device is being actively operated, for example). In another embodiment, one or more of the aforementioned algorithms begins execution of instructions when the portable device operator enters or operates a vehicle with the portable device turned on. In a further embodiment, a third party or remote algorithm (such as an algorithm on a remote server or an algorithm on a vehicle processor in communication with the portable device) turns on or instructs the portable device to execute one or more of the aforementioned algorithms. In a further embodiment, one or more of the aforementioned algorithms is executed on a server remote from the vehicle and instructions to execute one or more of the aforementioned algorithms are sent to the portable device (directly or indirectly).

In one embodiment, one or more of the aforementioned algorithms receives updated input information continuously, in real-time, on-demand, and/or when transmitted from a remote server. In another embodiment, one or more of the aforementioned algorithms measures or seeks updated information (such as an application software executing a cognitive load algorithm for vehicle operation substantially continuously to use updated information from one or more sensors (speed sensor, for example), user interface components (touchscreen use indicator), or third party servers, for example.

In one embodiment, A method of generating risk related information for insurance underwriting comprises: obtaining first information correlating to movement of a vehicle; obtaining second information different from the first information correlating to movement of a portable device relative to the vehicle during use of the portable device by an operator of the vehicle while operating the vehicle; correlating the first information with the second information to evaluate a vehicle operation performance by the operator of the vehicle; and generating risk related information associated with the operator of the vehicle based on the vehicle operation performance. In another embodiment, the first information and the second information are obtained from output information from one or more sensors within the portable device and the one or more sensors may comprise at least one accelerometer. In a further embodiment, the method further comprises executing a movement isolation algorithm on the output information from the one or more sensors using a processor to generate the first information and the second information. In one embodiment, the risk related information is a distracted driving score. In another embodiment, a method of generating risk related information for insurance underwriting comprises obtaining first information correlating to movement of a vehicle; obtaining second information different from the first information correlating to movement of a portable device relative to the vehicle during use of the portable device by a vehicle operator while operating the vehicle; obtaining third information correlating to the use of the portable device by the vehicle operator while operating the vehicle; correlating the first information, the second information, and the third information to evaluate a vehicle operation performance by the operator of the vehicle; and generating risk related information associated with the vehicle operator based on the vehicle operation performance. In one embodiment, the portable device comprises at least one processor and the use of the portable device comprises using one or more software applications or algorithms executed by the at least one processor. In another embodiment, the use of the portable device comprises using one or more functional features of the portable device. In a further embodiment, the vehicle operation performance provides information for insurance risk scoring, insurance pricing, insurance fraud identification, insurance claim analysis, accident fault determination, or generation of a risk assessment of the vehicle operator for insurance underwriting.

In one embodiment, a system for generating risk related information for insurance underwriting comprises: a portable device comprising at least one accelerometer and a non-transitory computer-readable storage medium comprising accelerometer information received from the at least one accelerometer; a first processor executing a movement isolation algorithm on the accelerometer information, the movement isolation algorithm extracting first information correlating to movement of a vehicle and second information correlating to movement of the portable device relative to the vehicle; a second processor executing a correlation algorithm, the correlation algorithm correlates the first information with the second information and generates vehicle operation performance information for a vehicle operator during use of the portable device while operating the vehicle; and a third processor executing a risk assessment algorithm on the vehicle operation performance information to generate a risk assessment of the vehicle operator for insurance underwriting. In one embodiment, a server remote from the portable device comprises the first processor. In a further embodiment, at least two of the first processor, the second processor, and the third processor are the same processor. In one embodiment, the portable device comprises at least two selected from the group: the first processor, the second processor, and the third processor. In another embodiment, the at least one accelerometer is calibrated for acceleration reading and orientation at a rate providing accuracy sufficient for isolating the first information and the second information during use of the portable device while operating the vehicle. In one embodiment, at least one accelerometer is calibrated for acceleration reading and orientation at a rate during the operation of the vehicle greater than or equal to one selected from the group: once per hour, once per minute, once per second, twice per second, ten times per second, and 100 times per second. In a further embodiment, the at least one accelerometer is calibrated after the portable device changes orientation during operation of the vehicle. In another embodiment, the second information comprises movement information of the portable device during two operational movement events of the vehicle, and the at least one accelerometer is calibrated for acceleration reading and orientation at a time between the two operational movement events. In a further embodiment, the portable device further comprises at least one gyroscope providing gyroscopic information and the at least one accelerometer may be calibrated based on the gyroscopic information after an orientation of the portable device changes during operation of the vehicle.

### Behavior Modification

In one embodiment, a method of generating a risk score, a cost of insurance, or a risk score and a cost of insurance for at least one individual includes directly or indirectly encouraging, inducing, or providing resources for modifying the behavior of the individual. In another embodiment, a system for behavior modification for at least one individual includes directly or indirectly encouraging, inducing, or providing resources for modifying the behavior of the individual based on cognitive information derived from information from one or more sensors. The behavior modification may be implemented by one or more methods selected from the group: displaying information such as behavior or performance status, comments, suggestions, encouragement, video, graphics, or a game on a device or vehicle display; providing the means or facilitating the means for an individual to perform physical and/or mental games, training, or cognitive enhancement; providing feedback or alerts to the individual; providing general comparative performance data or comparative data from other individuals connected socially with the individual; providing a training device, game device or other behavioral modification device with the system such as an application or game on a portable device that may also comprise one or more sensors for providing input information for determining cognitive information. In one embodiment, the behavior modification may include third party facilitation and tracking such as including discounted gym membership where individual physical activity may be tracked by the third party or through the portable device.

In one embodiment, the behavior modification occurs through one or more selected from the group: providing feedback information for conditioning; negative reinforcement; punishment; positive reinforcement; reward; cognitive enhancement (such as (directly or indirectly) engaging in cognitive enhancement physical and/or mental activities that could improve cognitive ability or decision-making capabilities); inducement; encouragement; providing resources to enable certain behaviors or providing specific physical and/or mental activities that remove or change negative predictive factors (or activities that result in the negative predictive factor) or increase or continue the use of positive predictive factors (or activities that result in positive predictive factors); exposure to possible loss consequences (such as showing or providing access to videos of individuals that have experienced a loss, informative media, or statistical information); training, games, or other physical and/or mental activities that improve judgment or perceptions skills (including depth perception, time perception, speed perception, risk recognition, danger recognition, risk exposure recognition, or alternative action recognition); increased exposure to safe methods, activities or equipment that improves safety or reduces risk (such as training videos or other media, testimonials in the form of video or other media, safety-related product information including product discounts or incentives, or statistical information); or exposure to information related to the behavior of others (such as safe activity of friends or family).

In one embodiment, the behavior modification includes one or more physical and/or mental exercises designed to change System 1 or System 2 performance. In one embodiment, physical and/or mental exercises are generated for the individual repeatedly to enhance the reflexive or System 1 responses. For example, an individual who instinctively accelerates when they see a yellow light may be trained to slow down through the use of a video game where the player is negatively impacted when they accelerate upon seeing a yellow light. In another embodiment, one or more mental and/or physical exercises are generated for the individual to improve System 2 performance. These exercises may include neuroplasticity exercises, mental exercises, brain exercises, auditory exercises, visual functioning exercises. Physical exercise may be also used in conjunction with mental exercises to improve System 2 cognitive performance. For example, the system may encourage or facilitate the individual to perform cardiovascular exercise multiple times per week and measure, track and display System 2 performance improvements and optionally the exercise performance information.

In one embodiment, the behavior modification is determined and/or executed using a behavior modification algorithm that is stored on a non-transitory computer readable medium on or in operable communication with the portable or wearable device, a remote computer or server (such as an insurer's computer or the insured's computer, for example), or an automobile or craft or device operatively connected thereto. The behavior modification algorithm may be executed by one or more processors on or in operable communication with the portable or wearable device, a remote computer or server (such as an insurer's computer or the insured's computer, for example), or an automobile or craft or device operatively connected thereto. In another embodiment, the behavior modification algorithm is incorporated into the decision-making process algorithm and/or a feedback algorithm.

Segmentation of the Individual into a Risk Group

In one embodiment a method of generating a risk score, a cost of insurance, or a risk score and a cost of insurance for at least one individual comprises segmenting the individual into a risk group or tier. The segmentation may use decision information, cognitive information, the initial underwriting profile, or one or more correlations between the risk-related decision-making processes and the decisions with the resulting decision outcomes for the individual.

In one embodiment, the individual is segmented into a risk group based on the use of one or more risk-related decision-making processes in one or more situations. In another embodiment, the individual is segmented into a risk group based on where they fall on a scale from risk-seeking to risk-averse based on one or more correlations between the risk-related decision-making processes used by the individual and the decisions with the resulting decision outcomes. In another embodiment, the individual is segmented according to one or more risk scores, risk scales, or risk-related categories.

In another embodiment, the individual is segmented into a group based on whether the person tends to be System 1 dominant (reflexive or automatic) or System 2 dominant (reflective, concentrating, or analytical) for their decision-making processes in risk-related situations. In one embodiment, the individual is classified or segmented into a risk group based on the measured or inferred preference, dominance, or relative proportion of System 1 decision-making processes to System 2 decision-making processes used in one or more risk-related situations. Other decision information such as individual characteristics (mental, physical, intellectual, etc.), cognitive information, contextual information, risk exposure information, or correlations may be used in combination with the measured or inferred relative use of System 1 decision-making processes compared to System 2 decision-making processes in risk-related situations to generate a risk score, a cost of insurance, or a risk score and a cost of insurance. For example, in one embodiment, an individual who uses System 2 decision-making processes more than System 1 decision-making processes in risk-related situations and has a relatively large cognitive capacity and/or intelligence may have a reduced risk and cost of automobile insurance relative an individual who uses more System 1 decision-making processes than System 2 decision-making processes in risk-related situations with other risk factors being similar. The analysis of the use of System 1 or System 2 decision-making processes may performed for different risk-related situations and the method of generating a risk score, a cost of insurance, or a risk score and a cost of insurance for the individual may incorporate weighting the level of risk associated with the use of System 1 or System 2 decision-making processes for different risk-related situations.

In another embodiment, the individual is segmented into a risk group based on the predictive model or the propensity model. In one embodiment, the individual is initially segmented into a risk group based on their initial baseline heuristics patterns. In a further embodiment, the individual is segmented into a risk group based on their cognitive information in their cognitive map. In another embodiment, the individual is segmented into a risk group based on one or more criteria, such as commonly known in the insurance industry.

### Types of Risk Evaluation or Insurance

In one embodiment a risk assessment, a risk score, an underwriting, or a cost of insurance includes correlating one or more risk-related decision-making processes and resulting decision outcomes for risk-related decisions made by at the least one individual related to the type of insurance or type of type of risk assessment. In one embodiment, the risk assessment, risk score, underwriting or cost of insurance is for one or more insurance products selected from the group: casualty insurance, automobile or craft insurance, life insurance, health or medical insurance, property insurance, liability insurance, financial instrument insurance, and law enforcement risk assessment or regulation. In one embodiment, decision information, cognitive information, initial underwriting profile, or one or more correlations between the risk-related decision-making processes and the decisions with the resulting decision outcomes for the individual is used to provide a plurality of insurance products (such as home insurance and automobile insurance, for example) or the information is shared between different underwriters providing different insurance products. In one embodiment, a risk assessment, a risk score, an underwriting, or a cost of insurance is determined using a risk assessment algorithm, risk score algorithm, an underwriting algorithm, or a cost of insurance algorithm, respectively, that may be incorporated into the decision-making process algorithm and is stored on a non-transitory computer readable medium and executed on one or more processors on one or more devices.

### Casualty Insurance

In one embodiment, the risk assessment, risk score, underwriting, or cost of insurance is for casualty insurance. As used herein, casualty insurance can insure against accidents that are not necessarily connected with any specific property and includes automobile or other vehicle insurance, workers compensation, crime insurance, political risk insurance, earthquake insurance, terrorism insurance, fidelity and surety insurance.

In this embodiment, contextual information and/or risk-related decision information can include telematics information such as provided by an on-board diagnostic (OBD) system data source in an automobile (which may optionally be transmitted using a communication device such as a cellphone to a remote processor); geographic information, sensor information, feature or application use from a portable device; external data sources such contextual postings on social networking websites; or other information known to be used in the casualty insurance or automobile insurance industry for determining a risk score or cost of insurance. Other risk-related decision information that can be used to determine a casualty risk assessment, a casualty risk score, underwriting, or a cost of casualty insurance includes cognitive information, risk exposure information, the use of one or more decision-making or judgment processes, risk-related decisions, decision outcomes, and correlations between risk-related decision-making processes or judgments and the decisions or judgments made by the at least one individual in different risk-related situations.

### Automobile or Craft Insurance

In one embodiment, the risk assessment, risk score, underwriting, or cost of insurance is for vehicle or craft insurance (such as land craft (automobile insurance, truck insurance, etc.) water craft (marine insurance), or air craft (aviation insurance)). In this embodiment, contextual information and/or risk-related decision information can include telematics information such as provided by an on-board diagnostic (OBD) system data source or data recorder in the vehicle or craft (which may optionally be transmitted using a communication device such as from a cellphone to a remote processor); geographic information, sensor information, feature or application use from a portable device; information obtained from external data sources such as contextual postings on social networking websites, or other information known to be used in the automobile insurance industry or other craft insurance industry for determining a risk score or cost of insurance. Other risk-related decision information that can be used to determine a risk assessment, a risk score, underwriting, or a cost of insurance for vehicle or craft operation includes cognitive information, risk exposure information, the use of one or more decision-making or judgment processes, risk-related decisions, decision outcomes, and correlations between risk-related decision-making processes or judgments and the decisions or judgments made by the at least one individual in different risk-related situations.

### Distracted Driving

In one embodiment the risk assessment, risk score, underwriting, or cost of insurance for vehicle or transportation insurance includes monitoring one or more data sources for physical or mental activities that are secondary or tertiary to a primary or goal state activity of operating a vehicle and using this contextual information to determine risk-seeking or risk-averse actions by the individual. In one embodiment, and one or more correlations between the risk-related decision-making processes and the decisions with the resulting decision for an individual under different cognitive loads is used to provide information for the risk assessment, risk score, underwriting, or cost for vehicle or transportation insurance. In another embodiment, the risk assessment is based at least in part on the general level of inattentiveness or distractibility of the individual while performing a primary or goal state activity or task that involves risk (e.g. driving a vehicle).

### Health or Medical Insurance

In one embodiment, the risk assessment, risk score, underwriting, or cost of insurance is for health or medical insurance. In this embodiment, contextual information and/or decision related information can include health related decisions, condition of health, physical and mental age and condition, physical or mental activities and other information known to be used in the health or medical insurance industry for determining a risk score or cost of health or medical insurance. In one embodiment, the contextual information and/or decision related information can be obtained through data sources such as portable or wearable devices, portable or wearable health monitoring devices, activity monitoring devices (such as a smart watch that tracks running information), and external data sources such contextual postings on social networking websites.

### Life Insurance

In one embodiment, the risk assessment, risk score, underwriting, or cost of insurance is for life insurance. In this embodiment, contextual information and/or decision related information can include health related decisions, condition of health, physical and mental age and condition, physical or mental activities, information on risk-related activities (such as skydiving, scuba diving, sports, or hazardous work conditions), geographic location, travel information, the level of risk associated with the individual from risk-seeking to risk-averse for one or more activities, or other information known to be used in the life insurance industry for determining a risk score or cost of life insurance. In one embodiment, the contextual information and/or decision related information can be obtained through data sources such as portable or wearable devices, portable or wearable health monitoring devices, activity monitoring devices (such as a smart watch that tracks running information), and external data sources such contextual postings on social networking websites.

### Property Insurance

In one embodiment, the risk assessment, risk score, underwriting, or cost of insurance is for property insurance such as homeowners insurance or renters insurance. In this embodiment, contextual information and/or decision related information can include activity information related to maintenance or upkeep of the property, risk-related activities performed at the property or with the property (such as home parties attended by risk-seeking individuals and business use of the home or property), home condition assessments, and information from external data sources such as aerial photographs indicating use of swimming pools.

In one embodiment, the contextual information and/or decision related information can obtained through data sources such as home automation devices, home networking devices, home security monitoring devices, and other sensing devices such as smoke detectors, electrical system monitors, vibration sensors, wireless sensor networks, or thermostats and HVAC control devices.

### Liability Insurance

In one embodiment, the risk assessment, risk score, underwriting, or cost of insurance is for liability insurance such as professional liability insurance, director and officer liability insurance, and media liability insurance, for example. In this embodiment, contextual information and/or decision related information can include information health related decisions, condition of health, physical and mental age and condition, physical or mental activities, information on risk-related activities, information on risk-related professional activities, geographic location, travel information, the level of risk associated with the individual from risk-seeking to risk-averse for one or more activities, associations with one or more individuals deemed to be risk-seeking or risk-averse, or other information known to be used in the liability insurance industry for determining a risk score or cost of liability insurance. In one embodiment, the contextual information and/or decision related information can be obtained through data sources such as portable or wearable devices, portable or wearable health monitoring devices, activity monitoring devices, and external data sources such ratings, reviews or information obtained from external websites or social networking websites.

### Financial Instrument Insurance

In one embodiment, the risk assessment, risk score, underwriting, or cost of insurance is for financial instrument insurance such as a loan or a securitized asset such as a mortgage backed security. In this embodiment, contextual information and/or decision related information can include credit score, financial information and decisions, bank account and credit card information, the level of risk associated with the individual from risk-seeking to risk-averse for one or more activities, associations with one or more individuals deemed to be risk-seeking or risk-averse, or other information known to be used in the financial instrument insurance industry for determining a risk score or cost of insurance for a financial instrument. In one embodiment, the contextual information and/or decision related information can be obtained through data sources such as portable or wearable devices, activity monitoring devices, and external data sources such ratings, reviews or information obtained from external websites or social networking websites.

### Law Enforcement Risk Assessment and Regulation

In one embodiment, the decision related information is used for risk assessment or regulation. For example, in one embodiment, a governmental security organization (such as the Department of Homeland Security) assesses the risk or danger associated with an individual by correlating the risk-related decision-making processes and the decisions with the resulting decision outcomes for the individual. A regulatory agency can use the risk-related information to reduce driving, reduce pollution, or improve safety, for example. In this embodiment, contextual information and/or decision related information can include geographic location, travel information, the level of risk associated with the individual from risk-seeking to risk-averse for one or more activities, or other information known to be used for risk assessment for security or regulatory agencies. In one embodiment, the contextual information and/or decision related information can be obtained through data sources such as portable or wearable devices, activity monitoring devices, and external data sources such contextual postings on social networking websites.

In one embodiment, a method of generating a risk score, a cost of insurance, or a risk score and a cost of insurance for at least one individual based at least in part on risk-related decision-making processes and resulting decision outcomes comprises: directly monitoring or inferring the risk-related decision-making processes and directly monitoring or inferring the resulting decision outcomes for decisions made by the at least one individual using data received from a plurality of sensors and a first processor executing a decision-making process algorithm; and generating the risk score, the cost of insurance, or the risk score and the cost of insurance for the at least one individual based at least in part on one or more correlations between the risk-related decision-making processes and the decisions with the resulting decision outcomes using a second processor executing a second algorithm. In one embodiment, the first processor and the second processor are the same processor and/or the second algorithm comprises the decision-making process algorithm. In this embodiment, the method may further comprise comprising building a cognitive map comprising cognitive information stored on a non-transitory computer-readable media, the cognitive information correlated to risk-related decision-making processes and the decisions made by the at least one individual in different risk-related situations. In one embodiment, the method of generating a risk score, a cost of insurance, or a risk score and a cost of insurance for at least one individual based at least in part on risk-related decision-making processes and resulting decision outcomes comprises building a plurality of cognitive maps comprising cognitive information stored on a non-transitory computer-readable media, the cognitive information correlated to risk-related decision-making processes and decisions made by a plurality of individuals in different risk-related situations.

In one embodiment, a method of generating a risk score, a cost of insurance, or a risk score and a cost of insurance for at least one individual based at least in part on risk-related decision-making processes and resulting decision outcomes comprises: generating one or more cognitive maps comprising cognitive information stored on a non-transitory computer-readable media, the cognitive information correlated to risk-related decision-making processes and decisions made by the at least one individual in different risk-related situations; and prospectively determining a probability of outcome for a risk-related situation using the one or more cognitive maps using a processor executing a propensity model algorithm that analyzes the cognitive information. In this embodiment, the propensity model algorithm may prospectively determine a probability of outcome for a risk-related situation by analyzing the one or more cognitive maps and identifying one or more patterns, relationships, degree of influence, or generalizations between one or more of the risk-related decision-making processes and one or more of the decisions.

In one embodiment, a method of generating a risk score, a cost of insurance, or a risk score and a cost of insurance for at least one individual based at least in part on risk-related decision-making processes and resulting decision outcomes comprises: directly monitoring or inferring the risk-related decision-making processes and directly monitoring the resulting decision outcomes for decisions made by the at least one individual during a first period of time using data received from a plurality of sensors and a first processor executing a decision-making process algorithm; and creating an initial underwriting profile for the at least one individual prior to the first period of time.

In one embodiment, a method of generating a risk score, a cost of insurance, or a risk score and a cost of insurance for at least one individual that relate to the risk associated with operation of a vehicle by the at least one individual is based at least in part on risk-related decision-making processes and resulting decision outcomes for decisions made by the at least one individual using data from one or more sensors analyzed by a decision making process algorithm executed on a first processor.

In one embodiment, a method of generating a risk score, a cost of insurance, or a risk score and a cost of insurance for at least one individual that relates to the risk associated with the performance of a first task by the at least one individual is based at least in part on risk-related decision-making processes and resulting decision outcomes for decisions made by the at least one individual and comprises analyzing data from one or more sensors using a decision making process algorithm executed on a first processor, and one or more of the decisions is associated with the performance of a second task different than the first task by the at least one individual. In this embodiment, the first task can include operation of a vehicle and the second task can include a task distracting from the operation of the vehicle.

In one embodiment, a method of generating a risk score, a cost of insurance, or a risk score and a cost of insurance for at least one individual based at least in part on risk-related decision-making processes and resulting decision outcomes comprises directly monitoring or inferring the risk-related decision-making processes and directly monitoring the resulting decision outcomes for decisions made by the at least one individual using data received from a plurality of sensors and a first processor executing a decision-making process algorithm, wherein at least one of the resulting decision outcomes is a negative decision outcome. In another embodiment, at least one of the resulting decision outcomes is a positive decision outcome.

In another embodiment, directly monitoring or inferring the risk-related decision-making processes and directly monitoring the resulting decision outcomes includes acquiring contextual data from one or more sensors or external data sources related to the decisions made by the at least one individual.

In one embodiment, a method of generating a risk score, a cost of insurance, or a risk score and a cost of insurance for at least one individual based at least in part on risk-related decision-making processes and resulting decision outcomes comprises directly monitoring or inferring the risk-related decision-making processes and directly monitoring the resulting decision outcomes for decisions made by the at least one individual using data received from a portable device, wearable device, or telematics device and a first processor executing a decision-making process algorithm.

In one embodiment, a method of generating a risk score, a cost of insurance, or a risk score and a cost of insurance for at least one individual based at least in part on risk-related decision-making processes and resulting decision outcomes comprises: directly monitoring or inferring the risk-related decision-making processes and directly monitoring the resulting decision outcomes for decisions made by the at least one individual using data from a plurality of sensors; and executing a decision-making process algorithm on a first processor that identifies one or more heuristic decision-making processes from the risk-related decision-making processes.

A method of determining a risk score, a cost of insurance, or a risk score and a cost of insurance based at least in part on monitoring, recording, and communicating data associated with risk-related decisions, the method comprising: monitoring or inferring a plurality of data elements associated with risk-related decision-making processes, decisions, and decision outcomes made by at least one individual using a first processor; and correlating one or more of the risk-related decision-making processes and decisions with one or more of the decision outcomes to produce a cost for the insurance using a second processor. In this embodiment, the first processor and the second processor may be the same processor. In this embodiment, the method may further comprise building a cognitive map comprising cognitive information correlated to risk-related decision-making processes and decisions made by the at least one individual in different risk-related situations. In another embodiment, the method may comprise building a plurality of cognitive maps comprising cognitive information represented in one or more data sets, one or more arrays of data, one or more databases, or other collection of data stored on a non-transitory computer-readable media for a plurality of individuals, the cognitive information comprising risk-related decision-making processes and decisions made by the plurality of individuals in different risk-related situations.

In one embodiment, a method of monitoring data representative of risk-related decisions made by at least one individual comprises: extracting from one or more data sources data elements associated with risk-related decision-making processes, decisions, and decision outcomes for decisions made by the at least one individual; correlating one or more of the risk-related decision-making processes and the decisions with one or more of the decision outcomes to produce one or more correlations that can be used to produce a risk score or cost for insuring the at least one individual using a first processor executing a decision-making process algorithm on the one or more data elements. In this embodiment, the method may further comprise building a cognitive map comprising data elements correlated to risk-related decision-making processes and decisions made by the at least one individual in different risk-related situations. In another embodiment, a method of monitoring data representative of risk-related decisions made by at least one individual comprises building a plurality of cognitive maps comprising one or more data sets, one or more arrays of data, one or more databases, or other collection of data stored on a non-transitory computer-readable media representing risk-related decision-making processes and decisions made by a plurality of individuals in different risk-related situations.

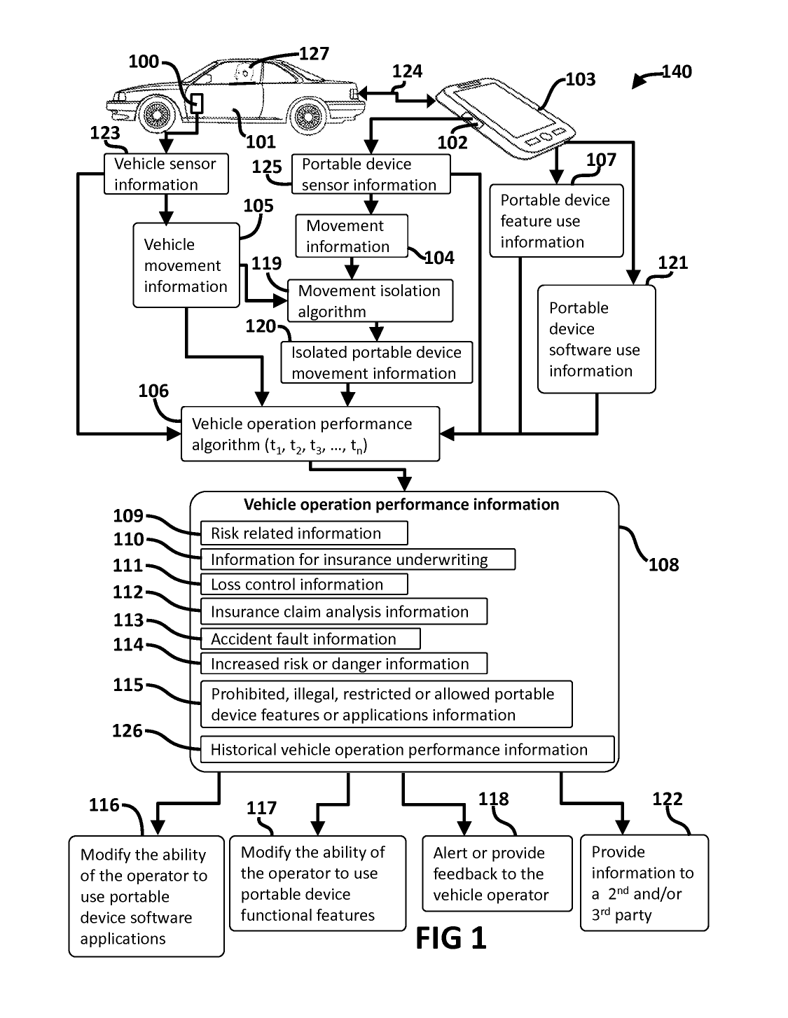

FIG. 1 is a data flow diagram view of one embodiment of a vehicle operation performance analysis system 140 for a vehicle operator 127 operating a portable device 103 while operating a vehicle 101. The portable device 103 is shown exterior to the vehicle 101 in FIG. 1 for clarity; however, the portable device is typically used by the operator 127 within the vehicle 101. In this embodiment, vehicle sensor information 123 from a sensor 100 of a vehicle 101 can provide vehicle movement information 105 as input to the vehicle operation performance algorithm 106. A sensor 102 of a portable device 103 (such as a smartphone) can provide portable device sensor information 125 as input directly to the vehicle operation performance algorithm 106. The portable device 103 may also send and/or receive 124 information from the vehicle 101 (such as through a wireless Bluetooth™ connection to the OBD system, for example). The portable device sensor information 125 can include movement information 104 (such as spatial and/or temporal movement information from one or more accelerometers, gyroscopes, compasses, gyroscopes, etc.) that is input into a movement isolation algorithm 119. The movement isolation algorithm 119 processes the movement information 104 from the portable device 103 (and optionally vehicle movement information 105 from the vehicle 101) to generate isolated portable device movement information 120 for specific times or events (t₁, t₂, t₃, . . . , tₙ) that is transferred as input to the vehicle operation performance algorithm 106. The vehicle operation performance algorithm 106 can also receive portable device sensor information 125, portable device feature use information 107, and/or portable device software use information 121 from the portable device 103 as input. The vehicle operation performance algorithm 106 processes the input to generate vehicle operation performance information 108. The vehicle operation performance information 108 can include one or more information types selected from the group: risk related information 109; information for insurance underwriting 110; loss control information 111; insurance claim analysis information 112; accident fault information 113; increased risk or danger information 114; prohibited, illegal, restricted or allowed portable device features or applications information 115; and historical vehicle operation performance information 126 of any of the aforementioned types of vehicle operation performance information 108.

In one embodiment, the vehicle operation performance information 108 is used to perform one or more of the functions selected from the group; modify the ability of the vehicle operator 127 to use portable device software applications 116; modify the ability of the vehicle operator 127 to use portable device functional features 117; alert or provide feedback 118 to the vehicle operator 127; and provide information to a second and/or third party 122.

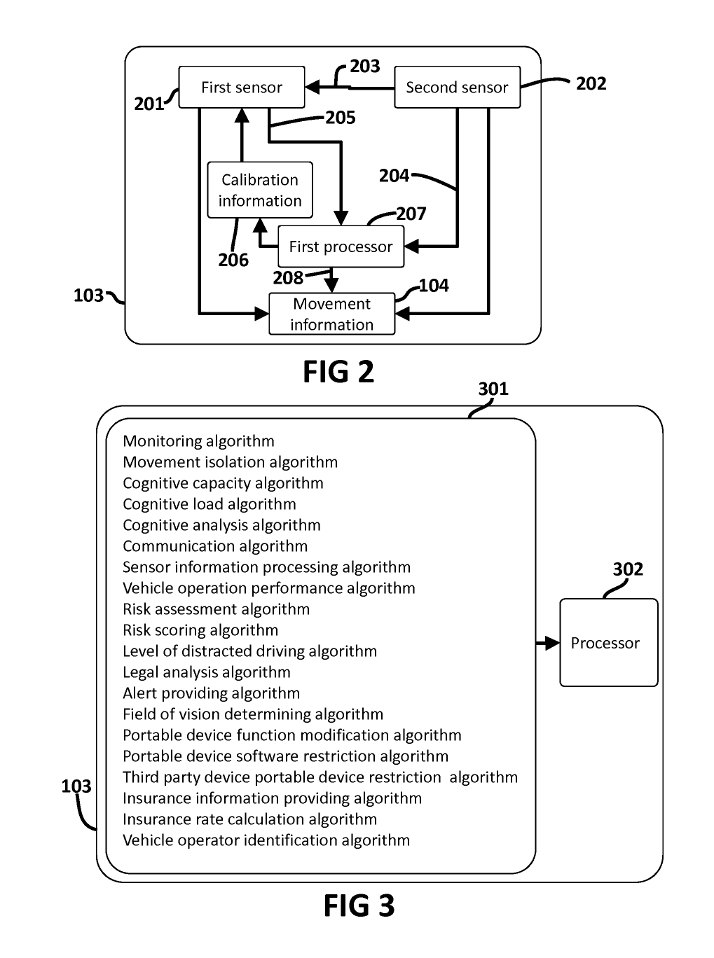

FIG. 2 is a data flow diagram view of one embodiment of a method of calibrating a first sensor 201 (such as an accelerometer) to generate movement information 104 in a portable device 103. In this embodiment, the first sensor 201 can provide a first measurement reading 205 to a first processor 207 on the portable device 103. The first processor 207 can also receive input 204 from a second sensor 202 (such as a gyroscope) to calibrate the reading 205 from the first sensor 201. The first processor 207 can send calibration information 206 to the first sensor 201 (in embodiments where the calibration adjustment is performed by the first sensor 201), or the first processor 207 can perform the calibration or adjustment and output 208 the movement information 104. The second sensor 202 may send a measurement reading 203 to the first sensor to provide for the calibration of the first sensor 201. The first sensor 201 may directly output movement information 104 or movement information 208 may be generated by the first processor 207. The movement information 104 may also comprise information from the second sensor 202 (or external sensors or devices, not shown).

In one embodiment, a vehicle 101, portable device 103, or device external to the vehicle and portable device may comprise one or more of the first sensor 201, second sensor 202, and first processor 207. In one embodiment, a single device, component, computer chip, or device package comprises one or more of the first sensor 201, second sensor 202, and first processor 207.

FIG. 3 is a diagram of one embodiment of a portable device 103 comprising a processor 302 that can load and execute one or more algorithms stored on a non-transitory computer-readable storage medium 301. In this embodiment, the processor 302 can load and execute one or more algorithms from the non-transitory computer-readable storage medium 301 selected from the group: monitoring algorithm, movement isolation algorithm, cognitive capacity algorithm, cognitive load algorithm, cognitive analysis algorithm, communication algorithm, sensor information processing algorithm, vehicle operation performance algorithm, risk assessment algorithm, risk scoring algorithm, level of distracted driving algorithm, legal analysis algorithm, alert providing algorithm, field of vision determining algorithm, portable device function modification algorithm, portable device software restriction algorithm, third party device portable device restriction algorithm, insurance information providing algorithm, insurance rate calculation algorithm, and vehicle operator identification algorithm.

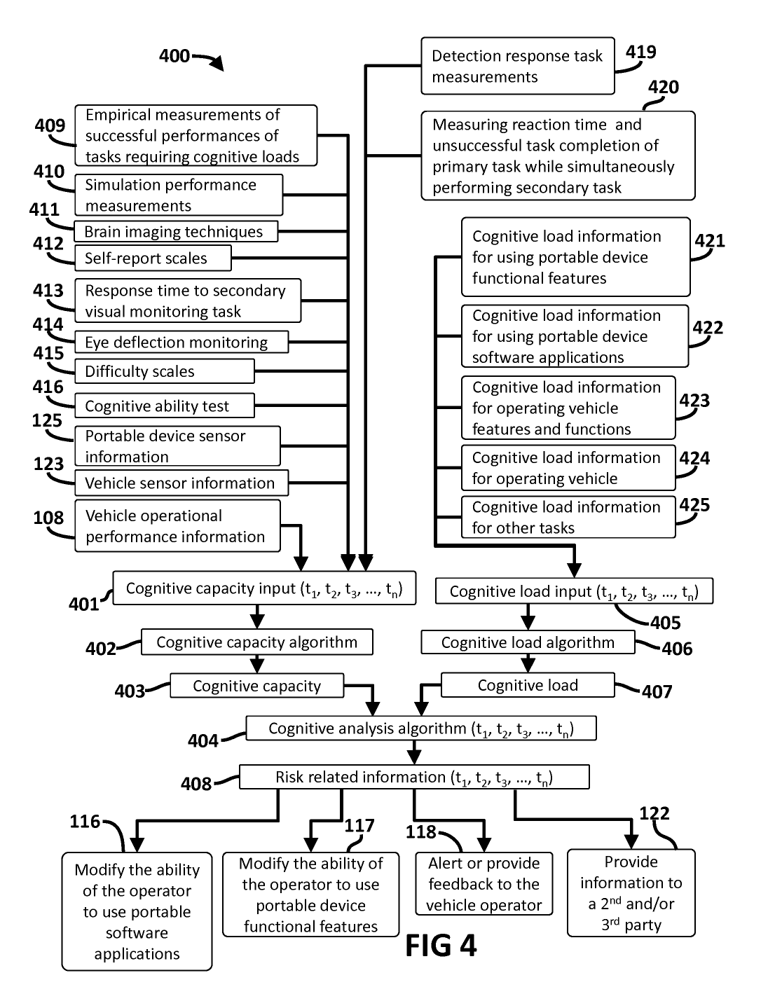

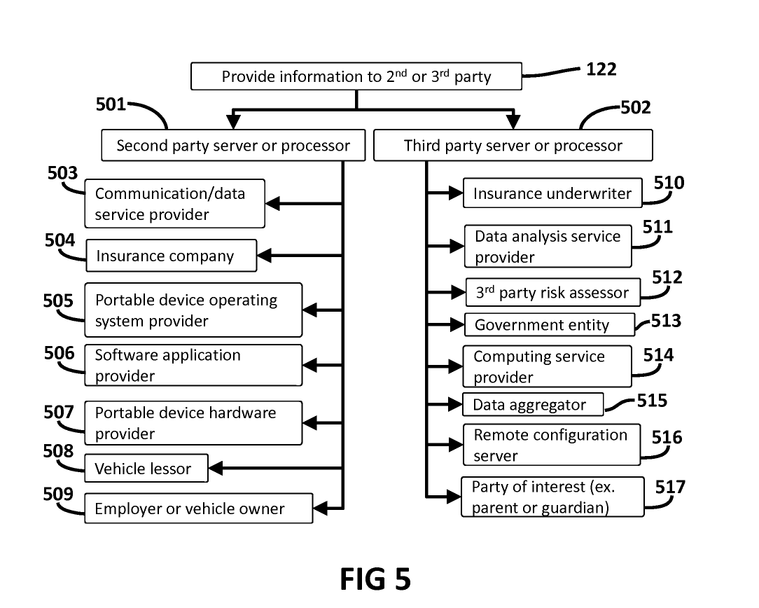

FIG. 4 is a flow diagram of one embodiment of a method 400 of generating risk related information 408 for an operator of a vehicle using a cognitive analysis algorithm 404. In this embodiment, the cognitive analysis algorithm 404 evaluates the cognitive capacity 403, and the cognitive load 407 of the vehicle operator generated using a cognitive capacity algorithm 402 and cognitive load algorithm 406, respectively. The cognitive capacity algorithm 402 can receive cognitive capacity input 401 at one or more times or events (such as t₁, t₂, t₃, . . . , tₙ for example). The cognitive capacity input 401 can include input from one or more selected from the group: empirical measurements of successful performances of tasks requiring cognitive loads 409; simulation performance measurements 410; brain imaging techniques 411; self-report scales 412; response time to secondary visual monitoring task 413; eye deflection monitoring 414; difficulty scales 415; cognitive ability test 416; portable device sensor information 125; vehicle sensor information 123; vehicle operational performance information (including historical information) 108; detection response task measurements 419; and measuring reaction time and unsuccessful task completion of primary task while simultaneously performing secondary task 420.

The cognitive load algorithm 406 can receive cognitive load input 405 at one or more times or events (such as t₁, t₂, t₃, . . . , tₙ for example). The cognitive load input 405 can include input from one or more selected from the group: cognitive load information for using portable device functional features 421; cognitive load information for using portable device software applications 422; cognitive load information for operating vehicle features and functions 423; cognitive load information for operating vehicle 424; and cognitive load information for other tasks 425. As a result of the analysis performed by the cognitive analysis algorithm 404, the portable device or vehicle may respond by performing one or more of the functions selected from the group; modify the ability of the vehicle operator to use portable device software applications 116; modify the ability of the vehicle operator to use portable device functional features 117; alert or provide feedback to the vehicle operator 118; and provide information to a 2nd and/or 3rd party 122.

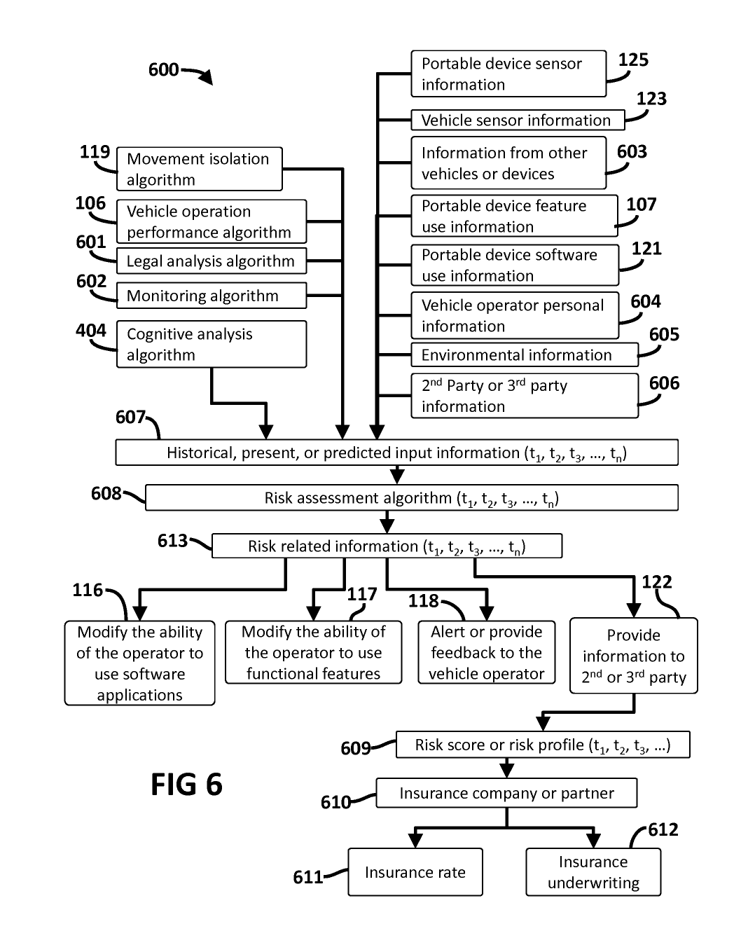

FIG. 5 is a data flow diagram of one embodiment of a system for transferring information to a second party or third party 122 (such as vehicle operation performance information 108 (see FIG. 1) or risk related information 408 and 613 (see FIGS. 4 and 6, respectively). In this embodiment, the information can be transferred to a second party server or processor 501. The second party server or processor 501 may be in communication one or more second parties selected from the group: communication/data service provider 503; insurance company 504; portable device operating system provider 505; software application provider 506; portable device hardware provider 507; vehicle lessor 508; and employer or vehicle owner 509. In addition or alternatively, the information provided to the second or third party 122 can be transferred to a third party server or processor 501. The third party server or processor 502 may be in communication one or more second parties selected from the group: insurance underwriter 510; data analysis service provider 511; 3rd party risk assessor 512; government entity 513 (such as the local police department); computing service provider 514 (such as a cloud computing service provider); data aggregator 515; remote configuration server 516; and party of interest 517 (such as a parent or guardian of the vehicle operator).

FIG. 6 is a flow diagram of one embodiment of a method 600 of generating risk related information 613 for an operator of a vehicle using a risk assessment algorithm 608. In this embodiment, the risk assessment algorithm 608 evaluates the historical, present, and/or predicted input information 607 for one or more times or events (such as t₁, t₂, t₃, . . . , tₙ, for example). The historical, present, and/or predicted input information 607 for the risk assessment algorithm 608 can include the output from one or more algorithms selected from the group: movement isolation algorithm 119; vehicle operation performance algorithm 106; legal analysis algorithm 601; monitoring algorithm 602; and cognitive analysis algorithm 404. Additionally, the historical, present, and/or predicted input information 607 for the risk assessment algorithm 608 can include information selected from one or more of the group: portable device sensor information 125; vehicle sensor information 123; information from other vehicles or devices 603; portable device feature use information 107; portable device software use information 121; vehicle operator personal information 604; environmental information 605; and second party and/or third party information 606.

As a result of the analysis performed by the risk assessment algorithm 608, the portable device or vehicle may respond by performing one or more of the functions selected from the group; modify the ability of the vehicle operator to use portable device software applications 116; modify the ability of the vehicle operator to use portable device functional features 117; alert or provide feedback to the vehicle operator 118; and provide information to a second and/or third party 122. In one embodiment, the risk related information 613 is provided to a second party 122 in the form of a risk score or risk profile (such as a risk profile with multiple time-indexed risk scores or with multiple time-indexed risk related information sets, for example). In this embodiment, the risk related information 613 (in the form of a risk score or risk profile 609) is provided to a second party 122 who is an insurance company or insurance company partner 610 and the risk related information 613 is use to help generate an insurance rate 611 or help in the process of insurance underwriting 612.

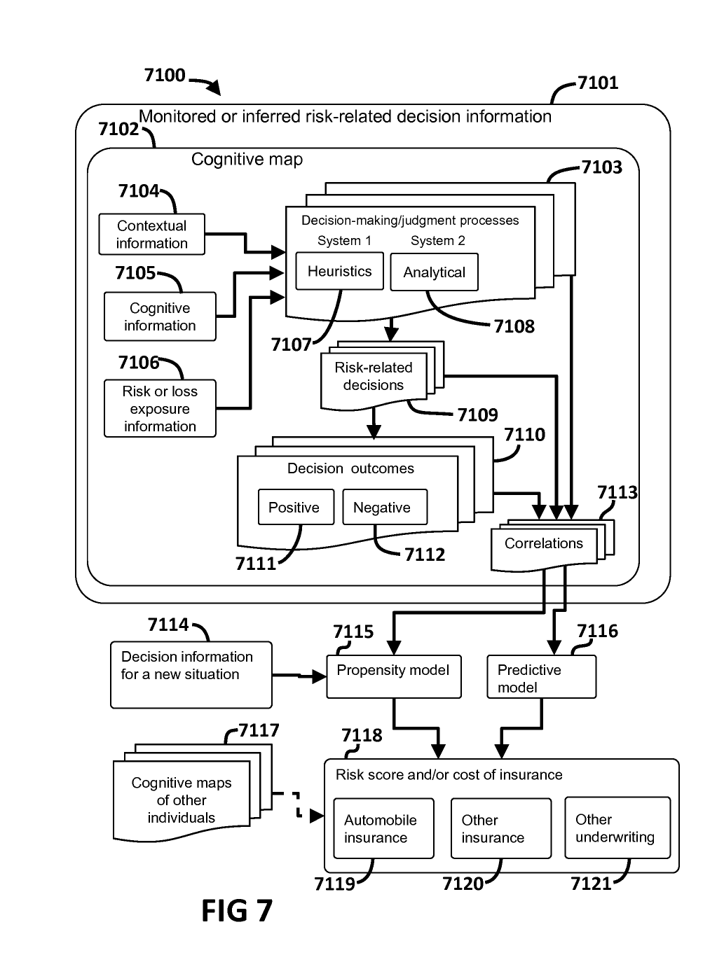

FIG. 7 is an information flow diagram view of one embodiment of a method 7100 of determining a risk assessment, risk score, underwriting, or cost of insurance 7118 for an individual. In one embodiment, the risk assessment, risk score, underwriting, or cost of insurance 7118 for an individual is for automobile insurance 7119, other insurance 7120, or other underwriting 7121. In this embodiment, risk-related decision information 7101 is monitored or inferred and can comprise the cognitive map 7102 for an individual. The risk-related decision information may include contextual information 7104, cognitive information 7105, or risk or loss exposure information 7106 that is used for one or more risk-related decision-making or judgment processes 7103 for one or more risk-related decisions 7109 in one or more risk-related situations. The one or more risk-related decision-making or judgment processes 7103 can include System 1 decision-making processes 7107 (such as reflexive or heuristics) or System 2 decision-making processes 7108 (such as analytical or reflective). The contextual information 7104, cognitive information 7105, and/or risk or loss exposure information 7106 along with the decision outcomes 7110 of the one or more risk-related decision-making or judgment processes 7103 can be used to measure, infer or otherwise determine the use of one or more specific System 1 decision-making processes 7107 or System 2 decision-making processes 7108 used by the individual in one or more risk-related situations to make one or more risk-related decisions 7109. The decision outcomes 7110 of the risk-related decisions 7109 may be positive decision outcomes 7111 or negative decision outcomes 7112. One or more correlations 7113 between the one or more risk-related decision-making or judgment processes 7103 and the decisions 7109 with the resulting decision outcomes 7110 may be used in a propensity model 7115 or a predictive model 7116 to generate the risk assessment, risk score, underwriting, or cost of insurance 7118. The cognitive map 7102 for the individual may include contextual information 7104, cognitive information 7105, risk or loss exposure information 7106, one or more risk-related decision-making or judgment processes 7103, one or more risk-related decisions 7109, and one or more correlations 7113 between the one or more risk-related decision-making or judgment processes 7103 and the decisions 7109 with the resulting decision outcomes 7110 for one or more risk-related situations.

In one embodiment, the propensity model 7115 uses one or more risk-related decision-making or judgment processes 7103 (such as System 1 decision-making processes 7107 or heuristics), the individual's cognitive map 7102, one or more correlations 7113, and decision information for a new situation 7114 to determine a propensity for the individual to be risk-seeking or risk-averse for the new situation. The propensity model 7115 may determine the probability of the individual to use one or more risk-related decision-making processes 7103 and/or make risk-related decisions 7109 that result in negative decision outcomes 7112 or positive decision outcomes 7111 for a situation. This probability can be used to generate the risk assessment, risk score, underwriting, or cost of insurance 7118.

In another embodiment, the predictive model 7116 predicts risk outcomes based on a retrospective analysis of the one or more risk-related decision-making or judgment processes 7103 used in one or more risk-related situations with the corresponding contextual information 7104, cognitive information 7105, and/or risk or loss exposure information 7106 along with the decision outcomes 7110. The predicted risk outcomes or other factors from the predictive model 7116 can be used to generate the risk assessment, risk score, underwriting, or cost of insurance 7118.

In another embodiment, the method 7100 of determining a risk assessment, risk score, underwriting, or cost of insurance 7118 for an individual optionally includes using information from one or more cognitive maps of other individuals 7117.

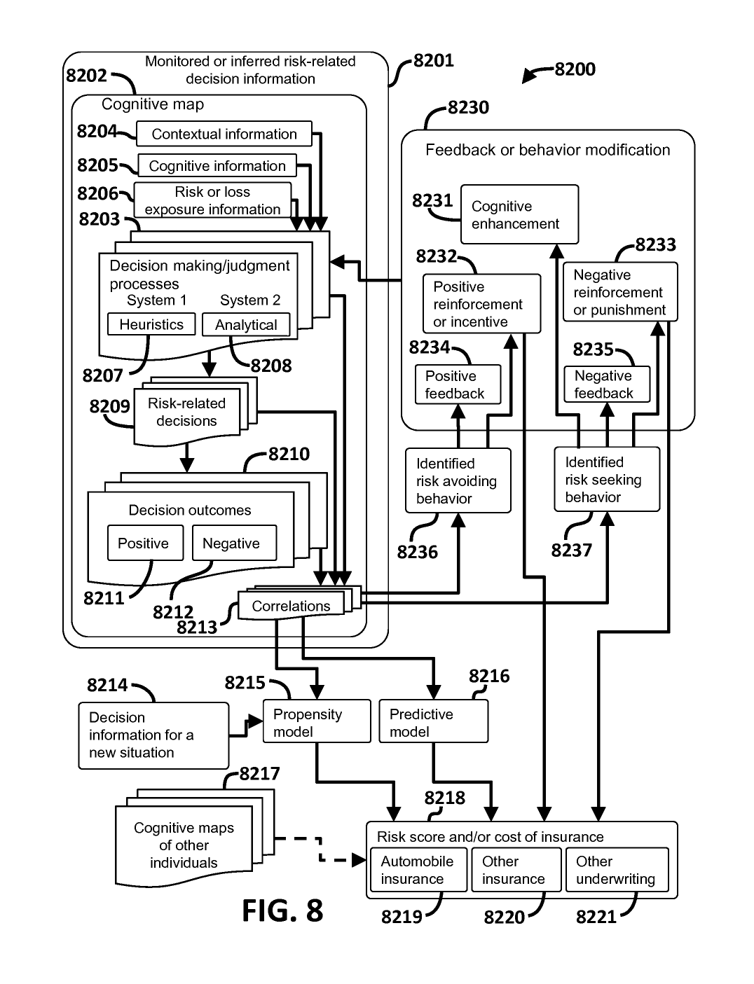

FIG. 8 is an information flow diagram view of one embodiment of a method 8200 of determining a risk assessment, risk score, underwriting, or cost of insurance 8218 for an individual and providing feedback or behavior modification 8230 information, methods, or activities for the individual. In one embodiment, the risk assessment, risk score, underwriting, or cost of insurance 8218 for an individual is for automobile insurance 8219, other insurance 8220, or other underwriting 8221. In this embodiment, risk-related decision information 8201 is monitored or inferred and can comprise the cognitive map 8202 for an individual. The risk-related decision information may include contextual information 8204, cognitive information 8205, or risk or loss exposure information 8206 that is used for one or more risk-related decision-making or judgment processes 8203 for one or more risk-related decisions 8209. The one or more risk-related decision-making or judgment processes 8203 can include System 1 decision-making processes 8207 (such as reflexive or heuristics) or System 2 decision-making processes 8208 (such as analytical or reflective). The contextual information 8204, cognitive information 8105, and/or risk or loss exposure information 8206 along with the decision outcomes 8210 of the one or more risk-related decision-making or judgment processes 8203 can be used to measure, infer or otherwise determine the use of one or more specific System 1 decision-making processes 8207 or System 2 decision-making processes 8208 used by the individual in one or more risk-related situations to make one or more risk-related decisions 8209. The decision outcomes 8210 of the risk-related decisions 8209 may be positive decision outcomes 8211 or negative decision outcomes 8212. One or more correlations 8213 between the one or more risk-related decision-making or judgment processes 8203 and the decisions 8209 with the resulting decision outcomes 8210 may be used in a propensity model 8215 or a predictive model 8216 to generate the risk assessment, risk score, underwriting, or cost of insurance 8218. The cognitive map for the individual may include contextual information 8204, cognitive information 8205, risk exposure information 8206, one or more risk-related decision-making or judgment processes 8203, one or more risk-related decisions 8209, and one or more correlations 8213 between the one or more risk-related decision-making or judgment processes 8203 and the decisions 8209 with the resulting decision outcomes 8210 for one or more risk-related situations.

In one embodiment, the propensity model 8215 uses one or more risk-related decision-making or judgment processes 8203 (such as System 1 decision-making processes 8207 or heuristics), the individual's cognitive map 8202, one or more correlations 8213, and decision information for a new situation 8214 to determine a propensity for the individual to be risk-seeking or risk-averse for the new situation. The propensity model 8215 may determine the probability of the individual to use one or more risk-related decision-making processes 8203 and/or make risk-related decisions 8209 that result in negative decision outcomes 8212 or positive decision outcomes 8211 for a situation. This probability can be used to generate the risk assessment, risk score, underwriting, or cost of insurance 8218.

In another embodiment, the predictive model 8216 predicts risk outcomes based on a retrospective analysis of the one or more risk-related decision-making or judgment processes 8203 used in one or more risk-related situations with the corresponding contextual information 204, cognitive information 8205, and/or risk exposure information 8206 along with the decision outcomes 8210. The predicted risk outcomes or other factors from the predictive model 8216 can be used to generate the risk assessment, risk score, underwriting, or cost of insurance 8218.

In another embodiment, the method 8200 of determining a risk assessment, risk score, underwriting, or cost of insurance 8218 for an individual optionally includes using information from one or more cognitive maps of other individuals 8217.

The one or more correlations 8213 between the one or more risk-related decision-making or judgment processes 8203 and the decisions 8209 with the resulting decision outcomes 8210 may be used to determine identified risk avoiding behavior 8236 and/or to determine identified risk seeking behavior 8237. The identified risk avoiding behavior 8236 can be used to provide positive feedback 8234 and/or generate positive reinforcement or incentive 8232 (such as a discount on an insurance rate, for example) that may directly, or indirectly through behavior modification, affect or reduce the risk score and/or cost of insurance 8218. For example, a reduction in the rate of automobile insurance (positive reinforcement or incentive 8232) for identified risk avoiding behavior 8236 can incentivize and modify the behavior of the individual in one or more risk-related situations by influencing one or more risk-related decision-making processes 8203 in one or more situations such that the individual makes more (or different) risk-related decisions 8209 resulting in more positive decision outcomes 8211 or fewer negative decision outcomes 8212, thus modifying the behavior of the individual to be more risk avoiding or less risk-seeking.

The identified risk seeking behavior 8237 can be used to provide negative feedback 8235; generate negative reinforcement or punishment 8233 (such as a penalty, loss of discount, or price increase for an insurance rate, for example); and/or provide cognitive enhancement techniques or activities 8231 that may directly, or indirectly through behavior modification, affect or reduce the risk score and/or cost of insurance 8218. For example, an increase in the rate of automobile insurance (negative reinforcement or punishment 8233) for identified risk seeking behavior 8237 can motivate and modify the behavior of the individual by influencing the use of one or more risk-related decision-making processes 8203 in one or more risk-related situations such that the individual makes more (or different) risk-related decisions 8209 resulting in more positive decision outcomes 8211 or fewer negative decision outcomes 8212, thus modifying the behavior of the individual to be more risk avoiding or less risk-seeking.

In one embodiment, the feedback or behavior modification includes one or more cognitive enhancement 8231 techniques or activities that can improve cognitive ability or decision-making capabilities for the individual, thereby influencing the use of one or more risk-related decision-making processes 8203 in one or more risk-related situations such that the individual makes more (or different) risk-related decisions 8209 resulting in more positive decision outcomes 8211 or fewer negative decision outcomes 8212.

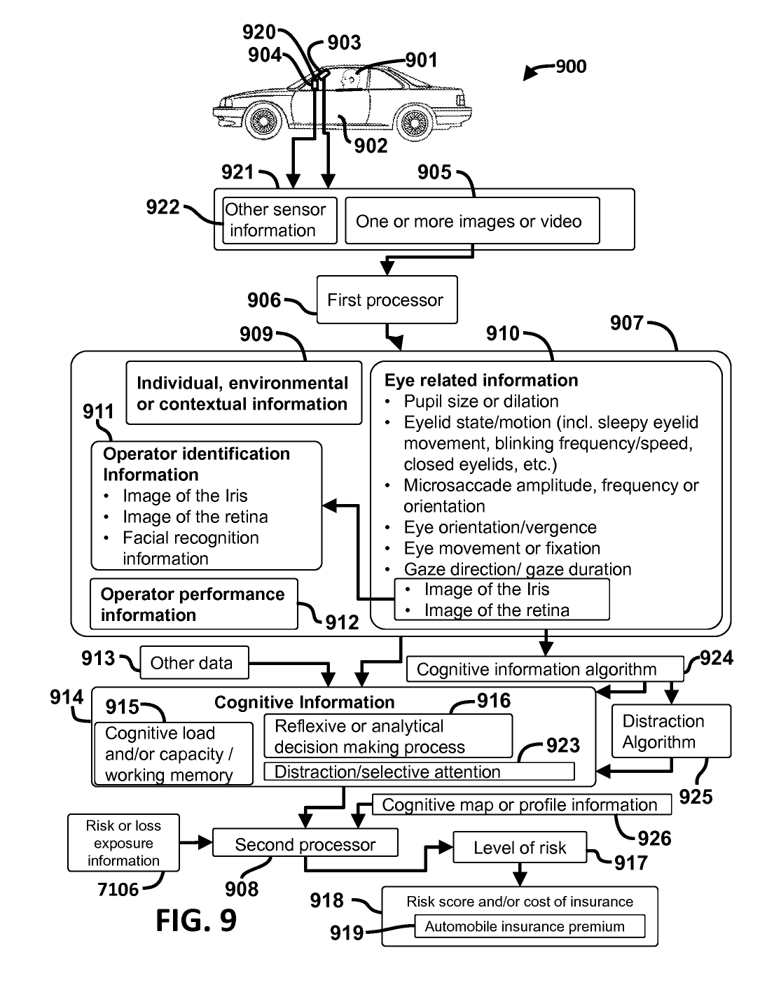

FIG. 9 is an information flow diagram view of one embodiment of a system 900 for determining a level of risk 917 associated with an individual 901 for underwriting purposes comprising one or more sensors 920 (such as a vehicle mounted camera 904 or a camera in a portable device 903) mounted to the vehicle 902 capturing sensor information 921 (such as one or more images or video 905 or other sensor information 922) and a processor 906 analyzing the sensor information 921 to determine first information 907. The first information 907 determined by the processor 906 can include, for example, operator identification information 911, environmental or contextual information 909, operator performance information 912, or eye related information 910. The eye related information 910 may include one or more selected from the group: pupil size or dilation, eyelid state/motion (incl. sleepy eyelid movement, blinking frequency or speed, closed eyelids, etc.), microsaccade amplitude, frequency or orientation, eye orientation, eye movement or fixation, gaze direction, details of the iris, and details of the retina. The details of the iris or retina may be used to provide operator identification information 911.

In one embodiment, the first information 907 determined from the sensor information 921 by the first processor 906 (such as eye related information 910 and/or other individual, environmental or contextual information 909) is used to determine cognitive information 914 (such as cognitive load and or cognitive capacity 915, the use of reflexive or analytical decision making processes 916 by the vehicle operator 901, or distraction/selective attention cognitive information 923) solely or in combination with other information 913 (such as heart rate information or circadian rhythm information). The eye related information 910 or other first information 907 (such as non-eye related first information, not shown) may be processed by a cognitive information algorithm 924 and optionally a distraction algorithm 925 to generate the cognitive information 914. The distraction algorithm 925 may be used to generate distraction or selective attention cognitive information 923 for the individual 901. The cognitive information 914 is processed by a second processor 908 (such as by implementing a cognitive analysis algorithm on the second processor 908) along with risk or loss exposure information 7106 and optionally cognitive map or profile information 926 to determine a level of risk 917 which may be used to determine a risk score and/or cost of insurance 918, such as an automobile insurance premium 919, for example.

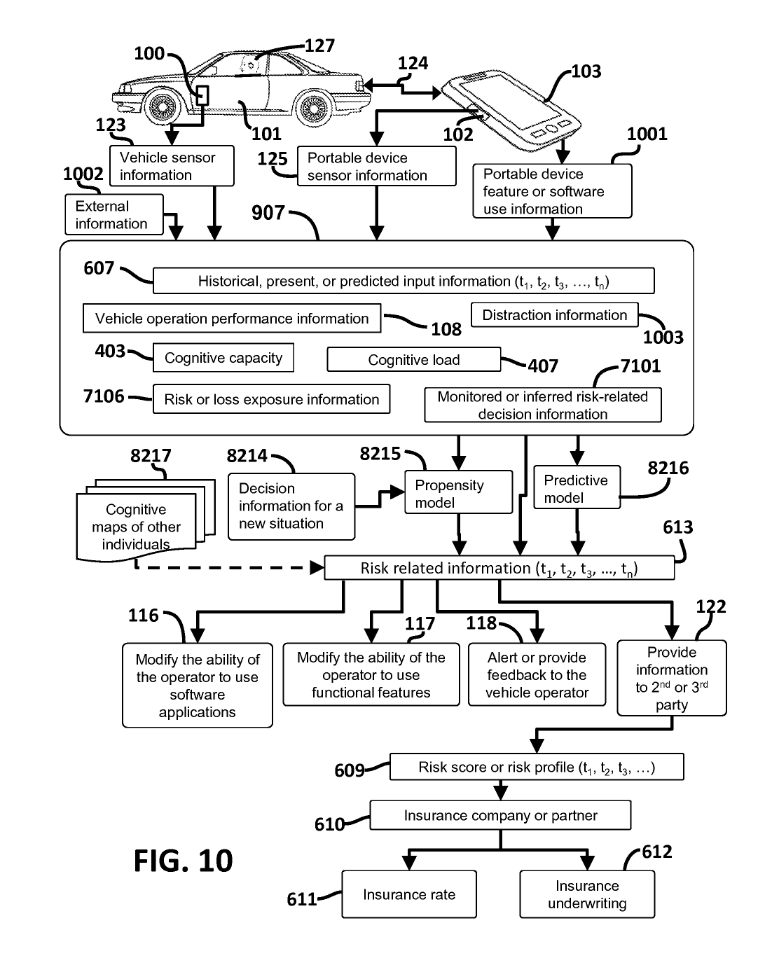

FIG. 10 is an information flow diagram view of one embodiment of a system 900 for determining risk related information 613 to modify the individual's ability to use portable device software applications 116; modify the ability of the individual to use portable device functional features 117; alert or provide feedback 118 to the individual; or provide information to a second and/or third party 122 and optionally be used to generate a risk score, to generate an insurance rate 611, or for insurance underwriting 612 purposes. The system 900 may use one or more methods or devices described in FIGS. 1-9, such as the vehicle operation performance analysis system 140, the method 400 of generating risk related information 408 for an operator of a vehicle, the method 600 of generating risk related information 613 for an operator of a vehicle using a risk assessment algorithm 608, a method 7100 of determining a risk assessment, risk score, underwriting, or cost of insurance 7118 for an individual, a method 8200 of determining a risk assessment, risk score, underwriting, or cost of insurance 8218, and a system 900 for determining a level of risk 917 associated with an individual. The first information 907 may be derived from and/or include one or more selected from the group: vehicle sensor information 123, portable device sensor information 125, portable device feature or software use information 1001, and other external information 1002. The first information may further include one or more selected from the group: historical, present, or predicted input information 607, vehicle operation performance information 108, cognitive capacity information 403, cognitive load information 407, distraction information 1003, risk or loss exposure information 7106, and monitored or inferred risk-related decision information 7101. The first information may be analyzed by one or more algorithms (such as one or more of the algorithms referenced in FIG. 3) on one or more processors to generate risk related information 613 and may include the use of one or more selected from the group: cognitive maps of other individuals 8217, decision information for a new situation 8214, a propensity model 8215, and a predictive model 8216. The risk related information may be processed to provide one or more of the following functions: modify the individual's ability to use portable device software applications 116; modify the ability of the individual to use portable device functional features 117; alert or provide feedback 118 to the individual; and provide information to a second and/or third party 122 and optionally be used to generate a risk score, to generate an insurance rate 611, or for insurance underwriting 612 purposes.

### EQUIVALENTS

Those skilled in the art will recognize, or be able to ascertain using no more than routine experimentation, numerous equivalents to the specific procedures described herein. Such equivalents are considered to be within the scope of the invention. Various substitutions, alterations, and modifications may be made to the invention without departing from the spirit and scope of the invention. Other aspects, advantages, and modifications are within the scope of the invention. This application is intended to cover any adaptations or variations of the specific embodiments discussed herein. Therefore, it is intended that this disclosure be limited only by the claims and the equivalents thereof.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

What is claimed is:

1. A system for determining underwriting risk, risk score, or price of insurance using cognitive information, the system comprising:
a. a sensor providing input information to a first processor, the input information including information related to properties of an individual while the individual is performing a physical or mental activity;
b. the first processor analyzing at least the input information and generating first cognitive information for the individual; and
c. a second processor analyzing at least the first cognitive information and generating a level of risk or price of insurance associated with the individual.

2. The system of claim 1 wherein the properties of the individual include facial information, skin information, or heart rate information for the individual.

3. The system of claim 1 wherein the properties of the individual include properties of one or more eyes of the individual.

4. The system of claim 1 further comprising a non-transitory computer-readable storage medium containing baseline cognitive information for the individual, wherein the second processor analyzes at least the first cognitive information relative to the baseline cognitive information.

5. The system of claim 4 wherein the sensor provides baseline input information to the first processor, and the first processor generates the baseline cognitive information using the baseline input information.

6. The system of claim 4 wherein the baseline cognitive information is determined at least in part from a questionnaire, a computer based test, or from historical input information from the sensor.

7. The system of claim 4 wherein the baseline cognitive information includes cognitive capacity information for the individual.

8. The system of claim 7 wherein the first cognitive information is related to a cognitive load for the individual when performing the physical or mental activity.

9. The system of claim 1 wherein the sensor is a camera.

10. The system of claim 1 wherein the first processor is the same as the second processor.

11. The system of claim 1 wherein the first cognitive information is related to a use of a reflexive decision making process or analytical decision making process when performing the physical or mental activity.

12. The system of claim 1 wherein the first cognitive information is related to a level of selective attention devoted to a primary activity or primary task and a secondary activity or secondary task.

13. The system of claim 1 wherein the underwriting, the risk score, or the price of insurance is based at least in part on the level of risk generated by the second processor.

14. The system of claim 1 wherein the input information includes information related to properties of the individual while the individual is operating an automobile and the sensor provides information related to properties of one or more eyes of the individual operating the automobile while distracted.

15. The system of claim 1 wherein the properties of the individual include properties of one or more eyes of the individual, the properties of one or more eyes includes pupil size, eyelid motion or state, blinking frequency or speed, eye orientation, gaze direction, gaze duration, vergence information, iris information, retina information, or microsaccade amplitude, frequency, or direction.

16. The system of claim 1, wherein the first cognitive information is related to attention or cognitive focus of the individual while performing the physical or mental activity.

17. The system of claim 1, wherein the second processor analyzes at least the first cognitive information and produces an attention score that is directly related to an amount of selective attention the individual is devoting to performing the physical or mental activity.

18. A non-transitory computer-readable storage medium including instructions that, when accessed by a processing device, cause the processing device to perform operations comprising:
a. storing first cognitive information for an individual determined at least in part from information related to properties of the individual, the properties derived from one or more sensors while the individual is performing a physical or mental activity; and
b. determining a level of risk associated with the individual for underwriting purposes using the first cognitive information.

19. The non-transitory computer readable storage medium of claim 18 wherein the operation determining a level of risk associated with the individual includes analyzing the first cognitive information relative to baseline cognitive information for the individual.

20. The non-transitory computer readable storage medium of claim 18 wherein the instructions further cause the processing device to perform operations comprising underwriting the individual, generating a risk score, generating a cost of insurance, or generating a risk score and a cost of insurance that is based at least in part on the level of risk.

21. The non-transitory computer readable storage medium of claim 18 wherein the first cognitive information is related to a cognitive load for the individual when performing the physical or mental activity.

22. The non-transitory computer readable storage medium of claim 18 wherein the first cognitive information is related to a use of a reflexive decision making process or an analytical decision making process by the individual when performing the physical or mental activity.

23. A system for determining a level of risk associated with an individual for underwriting purposes, the system comprising: a device including at least one sensor, one or more processors, and one or more non-transitory computer-readable storage mediums operatively connected and collectively comprising instructions, said instructions direct the one or more processors to:
a. process input information from the sensor while the individual is performing a physical or mental activity;
b. generate information related to properties of the individual;
c. process the information related to properties of the individual and generate first cognitive information for the individual; and
d. generate the level of risk associated with the individual performing a primary or goal state activity using the first cognitive information and store the level of risk on the one or more non-transitory computer-readable storage mediums.

24. The system of claim 23 wherein the instructions further direct the one or more processors to generate a risk score, a cost of insurance, an underwriting analysis, or a risk score and a cost of insurance for the individual based at least in part on the level of risk.

25. The system of claim 23 wherein the instruction directing the one or more processors to generate the level of risk associated with the individual is based at least in part on the first cognitive information analyzed relative to baseline cognitive information for the individual.

26. The system of claim 25 wherein the first cognitive information is related to a cognitive load for the individual when performing the physical or mental activity.

27. The system of claim 23 wherein the first cognitive information is related to a use of a reflexive decision making process or an analytical decision making process by the individual when performing the physical or mental activity.

28. The system of claim 23 wherein the physical or mental activity includes operating a vehicle.

29. A method for determining underwriting risk, risk score, or price of insurance using cognitive information, the method comprising:
a. obtaining information from a sensor related to properties of an individual while the individual is performing a physical or mental activity;
b. generating first cognitive information for the individual by analyzing at least the information from the sensor related to properties of the individual; and
c. generating a level of risk or price of insurance associated with the individual using at least the first cognitive information.

30. The method of claim 29 wherein obtaining information from a sensor related to properties of an individual includes obtaining facial information, skin information, or heart rate information for an individual.
